(19) United States
(12) Patent Application Publication
(10) Pub. No.: US 2026/0360055 A1
(43) Pub. Date: Nov. 12, 2026

(54) VIRTUAL SPACE CONTENT STREAMING SYSTEM, VIRTUAL SPACE CONTENT STREAMING PROGRAM, AND VIRTUAL SPACE CONTENT STREAMING METHOD

(71) Applicant: COVER CORPORATION, Tokyo (JP)

(72) Inventor: Takaya KANAGAKI, Tokyo (JP)

(21) Appl. No.: 19/489,466

(22) PCT Filed: Mar. 12, 2024
(86) PCT No.: PCT/JP2024/009650

§ 371 Date: Jul. 17, 2026

(30) Foreign Application Priority Data
Jun. 22, 2023 (JP) 2023-102732

(51) Int. Cl. G06T 13/00; G06T 11/00

(52) U.S. Cl. CPC G06T 13/00; G06T 11/00

(57) ABSTRACT

A virtual pace content streaming system allow more viewers to participate in a virtual space. The virtual space content streaming system includes a viewer user device capable of displaying visuals of virtual space content and assigned to each viewer user, and a server computer connected to the viewer user device, wherein when the viewer user device displays viewer-avatar-viewpoint visuals, which are viewpoint visuals of the virtual space corresponding to the viewer avatar, the viewer user device generates the viewer-avatar-viewpoint visuals based on virtual space data of the virtual space transmitted from the server computer.

### TECHNICAL FIELD

The present invention relates to a virtual space content streaming system, a virtual space content streaming program, and a virtual space content streaming method, for streaming virtual space content created in a virtual space.

### BACKGROUND ART

Conventionally, there is known a streaming system that generates animations of a character object (avatar) of a streaming user (performer) who moves in a virtual space in conjunction with motions of the streaming user (performer), to live-stream video content including the generated animations, in a server computer connected to viewer user devices via a computer network. This streaming system also allows viewer users who view the video to participate as audiences in the virtual space where an avatar of the streaming user (performer) is participating, according to requests from the viewer users (see, for example, Patent Document 1).

### PRIOR ART DOCUMENT

### Patent Document

Patent Document 1: JP2012-120098A

### SUMMARY OF THE INVENTION

### Technical Problem

However, in Patent Document 1, video content including animations is generated in a server computer, and therefore, when there are a large number of participating viewer users, the server computer runs out of the processing power, causing problems in streaming the video content. Thus, there is a problem that the system cannot allow a large number of viewer users to participate.

The present invention has been achieved by focusing on such problems and aims to provide a virtual space content streaming system, a virtual space content streaming program, and a virtual space content streaming method, that allow a larger number of viewer users to participate.

### Solution to Problem

In order to solve the foregoing problems, a virtual space content streaming system in accordance with claim 1 relates to a virtual space content streaming system for streaming virtual space content (e.g., virtual live) created in a virtual space (e.g., virtual live venue), comprising: a viewer user device (e.g., viewer device 300) capable of displaying visuals of the virtual space content (e.g., smartphone P, computer PC) and available to a viewer user who is allowed to operate a viewer avatar in the virtual space in which the virtual space content is created; and a server computer (e.g., streaming server computer) connected to the viewer user device via a communication network (e.g., the Internet) and capable of executing at least processing related to the virtual space (e.g., virtual space update processing, virtual space update data generation processing) and processing related to the streaming of the virtual space content (e.g., virtual space update data streaming processing, generated audio streaming processing), wherein there are a plurality of viewer users, and the viewer user device is assigned to each viewer user (e.g., a part where viewer devices 300a-c are assigned to viewer users A-C, as shown in FIG. 1), and when displaying viewer-avatar-viewpoint visuals which are viewpoint visuals of the virtual space corresponding to the viewer avatar, each viewer user device generates the viewer-avatar-viewpoint visuals based on virtual space data (e.g., virtual space update data) of the virtual space, transmitted from the server computer. In accordance with this feature, generation of viewer-avatar-viewpoint visuals, requiring large processing load, is executed on the viewer user device side, and therefore it is possible to allow participation of a larger number of viewer users.

In a virtual space content streaming system in accordance with claim 2, the virtual space content allows a performer user to participate as a performer avatar (e.g., performer avatar 1) in the virtual space. In accordance with this feature, the performer user participates as a performer avatar, and therefore it is possible to make the virtual space content more interesting.

In a virtual space content streaming system in accordance with claim 3, the virtual space content features a performer avatar giving a performance (e.g., singing and dancing) in the virtual space. In accordance with this feature, the performer avatar performs a performance, and therefore it is possible to make the virtual space content more interesting.

In a virtual space content streaming system in accordance with claim 4, the virtual space data includes performer-avatar-intended motion data for generating the motion of the performer avatar (e.g., a part where the virtual space update data includes data of motions, such as dancing, of the performer avatar 1). In accordance with this feature, motions of the performer avatar can be reflected accurately in the viewer-avatar-viewpoint visuals, and therefore it is possible to make the virtual space content more interesting.

In a virtual space content streaming system in accordance with claim 5, the viewer user device is capable of, when generating a motion of the performer avatar based on the performer-avatar-intended motion data, generating the motion of the performer avatar in a plurality of generation modes having different processing loads for the generation (e.g., a part where viewer-avatar-viewpoint visuals of a high-definition performer motion and a low-definition performer motion can be generated, as shown in Variant example 2-1 in FIG. 29). In accordance with this feature, generation modes can be changed, and therefore it is possible to generate viewer-avatar-viewpoint visuals corresponding to a situation of motions of a performer avatar and deal with differences in, for example, processing capabilities of viewer user devices.

In a virtual space content streaming system in accordance with claim 6, the server computer can generate common viewpoint visuals commonly displayed on each of the viewer user devices, rather than viewpoint visuals corresponding to each viewer avatar, and stream the common viewpoint visuals to the viewer user devices (e.g., a part where the streaming server computer 100 generates virtual-camera-viewpoint visuals to stream to viewer devices 300 at periods, such as pre-start explanation period, opening performance period, and flying performance period, when only the virtual-camera-viewpoint visuals can be viewed, as shown in FIG. 25). In accordance with this feature, it is possible to avoid processing load of overall system being increased in vague as a result of duplicate processing being executed in the viewer user devices.

In a virtual space content streaming system in accordance with claim 7, the viewer user device generates and displays the common viewpoint visuals during a specific period when the viewer user device is allowed to select and display either the viewer avatar viewpoint visuals or the common viewpoint visuals (e.g., a part where virtual-camera-viewpoint visuals are generated on the viewer device 300 side for periods, such as MC talk periods, and performance period excluding the flying performance period in Embodiment 2, when both the viewer-user-viewpoint visuals and the virtual-camera-viewpoint visuals can be viewed, as shown in FIG. 26). In accordance with this feature, it is possible to avoid problems, such as interruption of visuals, when viewpoint visuals are switched.

In a virtual space content streaming system in accordance with claim 8, the viewer user device generates and displays the common viewpoint visuals during a special period when the processing load on the server computer is high (e.g., a part where the virtual-camera-viewpoint visuals are generated on the viewer device 300 side at costume changing performance period and illusionary clone performance period in Embodiment 2, requiring large processing load on the streaming server computer 100). In accordance with this feature, it is possible to avoid the processing load on the server computer being temporarily extremely large.

In a virtual space content streaming system in accordance with claim 9, the server computer transmits in advance pre-start data (e.g., pre-start data including virtual space data, performer avatar data, and viewer avatar data) including basic data of the virtual space and basic data of avatars participating in the virtual space to each viewer user device before a start of the virtual space content (e.g., a part where the streaming server computer 100 streams pre-start data during pre-start data download period). In accordance with this feature, it is possible to avoid a problem that viewer-avatar-viewpoint visuals are not displayed well at the start of the virtual space content.

In a virtual space content streaming system in accordance with claim 10, the server computer transmits to the viewer user device whose receipt completion of the pre-start data has not been confirmed common viewpoint visuals to be commonly displayed on each viewer user device without transmitting the virtual space data (e.g., a part where only the virtual-camera-viewpoint visuals can be displayed during all periods of the virtual live on viewer devices 300 that have not completed download of the pre-start data at pre-start data check timing by streaming virtual-camera-viewpoint visuals generated by the streaming server computer 100). In accordance with this feature, it is possible to avoid the processing load on the server computer becoming excessively large as a result of transmission of data, such as basic data, after the start of the virtual space content, and avoid a situation where the viewer user cannot view the virtual space content.

In a virtual space content streaming system in accordance with claim 11, the server computer includes a first viewer user device (e.g., viewer device 300a of viewer user A in Variant example 2-2) and a second viewer user device (e.g., viewer device 300 b of viewer user B in Variant example 2-2) as the viewer user devices, virtual space data different from that of the first viewer user device can be transmitted to the second viewer user device (e.g., a part where virtual space update data A including information on special motion A transmitted to the viewer device 300a and virtual space update data B that does not include information on special motion A transmitted to the viewer device 300b are different). In accordance with this feature, it is possible to make virtual space data more flexible and generate different viewer-avatar-viewpoint visuals in the first viewer user device and the second viewer user device.

In a virtual space content streaming system in accordance with claim 12, the second viewer user device is capable of generating visuals of a second viewer avatar performing a motion (e.g., special motion in Variant example 2-2) different from a motion of a first viewer avatar of a first viewer user using the first viewer user device, based on virtual space data different from the virtual space data transmitted to the first viewer user device. In accordance with this feature, visuals of the second viewer avatar that performs a motion different from the motion of the first viewer avatar can be displayed on the second viewer user device, and therefore it is possible to make the second viewer user more interesting with respect to the virtual space content.

A virtual space content streaming program in accordance with claim 13 relates to a virtual space content streaming program (e.g., a program for operation relating to transmission of virtual space update data in the streaming server computer 100, and a program for operation relating to generation of viewer-avatar-viewpoint visuals in the viewer device 300) for streaming virtual space content (e.g., virtual live) created in a virtual space (e.g., virtual live venue) via a network (e.g., the Internet) using at least a server computer (e.g., streaming server computer 100), wherein avatars (e.g., viewer avatar) capable of participating in the virtual space in which the virtual space content is created include a viewer avatar that perform a motion in the virtual space by operating on a viewer user device (e.g., viewer device 300) that can be used by a viewer user and is connected to the server computer via the network, there are a plurality of viewer users, and the viewer user device is assigned to each viewer user (e.g., a part where viewer devices 300a-c are assigned to viewer users A-C, as shown in FIG. 1), and the virtual space content streaming program includes a step of generating (e.g., viewer-viewpoint visuals generation processing), when displaying viewer-avatar-viewpoint visuals, which are viewpoint visuals of the virtual space corresponding to the viewer avatar, in each of the viewer user devices, the viewer-avatar-viewpoint visuals based on virtual space data (e.g., virtual space update data) of the virtual space transmitted from the server computer. In accordance with this feature, generation of viewer-avatar-viewpoint visuals requiring large processing load is executed on the viewer user device side, and therefore it is possible to make more viewer users participate.

A virtual space content streaming method in accordance with claim 14 relates to a virtual space content streaming method for streaming virtual space content (e.g., virtual live) created in a virtual space (e.g., virtual live venue) via a network (e.g., the Internet) using at least a server computer (e.g., streaming server computer 100), wherein avatars (e.g., viewer avatar) capable of participating in the virtual space in which the virtual space content is created include a viewer avatar that perform a motion in the virtual space by operating on a viewer user device (e.g., viewer device 300) that can be used by a viewer user and is connected to the server computer via the network, there are a plurality of viewer users, and the viewer user device is assigned to each viewer user (e.g., a part where viewer devices 300a-c are assigned to viewer users A-C, as shown in FIG. 1), and the virtual space content streaming method includes a step of generating (e.g., viewer-viewpoint visuals generation processing), when displaying viewer-avatar-viewpoint visuals, which are viewpoint visuals of the virtual space corresponding to the viewer avatar, in each of the viewer user devices, the viewer-avatar-viewpoint visuals based on virtual space data (e.g., virtual space update data) of the virtual space transmitted from the server computer. In accordance with this feature, generation of viewer-avatar-viewpoint visuals requiring large processing load is executed on the viewer user device side, and therefore it is possible to make more viewer users participate.

The subject matter of the present invention may include only essential elements recited in the claims, but may include elements other than the essential elements.

### BRIEF DESCRIPTION OF THE DRAWINGS

FIG. 1 shows a block diagram illustrating a system configuration example of a virtual space content streaming system according to Embodiment 1 of the present invention.

FIG. 2 shows a diagram illustrating a configuration example of a streaming server computer in a virtual space content streaming system according to Embodiment 1 of the present invention.

FIG. 3 shows a diagram illustrating various data stored in a storage device of the streaming server computer according to Embodiment 1 of the present invention.

FIG. 4 shows a diagram illustrating a configuration example of a performer device in the virtual space content streaming system according to Embodiment 1 of the present invention.

FIG. 5 shows a diagram illustrating a configuration example of a viewer device in the virtual space content streaming system according to Embodiment 1 of the present invention.

FIG. 6 shows a diagram illustrating a configuration example of an administrator device in the virtual space content streaming system according to Embodiment 1 of the present invention.

FIG. 7 shows a diagram illustrating a structure example of event data in the virtual space content streaming system according to Embodiment 1 of the present invention.

FIG. 8 shows a diagram illustrating a structure example of performer user data in the virtual space content streaming system according to Embodiment 1 of the present invention.

FIG. 9 shows a diagram illustrating a structure example of viewer user data in the virtual space content streaming system according to Embodiment 1 of the present invention.

FIG. 10 shows a diagram illustrating data exchanged between respective devices and a server computer constituting the virtual space content streaming system according to Embodiment 1 of the present invention.

FIG. 11 shows a schematic view illustrating facilities in a studio for use by a performer user in the virtual space content streaming system according to Embodiment 1 of the present invention.

FIG. 12 shows a diagram illustrating a virtual live venue, which is in a virtual space, used in the virtual space content streaming system according to Embodiment 1 of the present invention.

FIG. 13 shows a diagram illustrating display examples on a viewer device constituting the virtual space content streaming system according to Embodiment 1 of the present invention.

FIG. 14 shows a diagram illustrating display examples on a viewer device constituting the virtual space content streaming system according to Embodiment 1 of the present invention.

FIG. 15 shows a diagram illustrating display examples on a performer device constituting the virtual space content streaming system according to Embodiment 1 of the present invention.

FIG. 16 shows a diagram illustrating display examples resulted from a zooming-related operation on a viewer device constituting the virtual space content streaming system according to Embodiment 1 of the present invention.

FIG. 17 shows a diagram illustrating display examples resulted from a zooming-related operation on a viewer device constituting the virtual space content streaming system according to Embodiment 1 of the present invention.

FIG. 18 shows a diagram illustrating display examples on a viewer device constituting the virtual space content streaming system according to Embodiment 1 of the present invention.

FIG. 19 shows a diagram illustrating display examples during a flying performance period on a viewer device constituting the virtual space content streaming system according to Embodiment 1 of the present invention.

FIG. 20 shows a flow chart illustrating an example of viewer-intended viewpoint visuals control processing executed in a viewer device constituting the virtual space content streaming system according to Embodiment 1 of the present invention.

FIG. 21 shows a diagram illustrating details of a virtual live streamed by a virtual space content streaming system according to Embodiment 2 of the present invention.

FIG. 22 shows a diagram illustrating data exchanged between the streaming server computer and the viewer device constituting the virtual space content streaming system according to Embodiment 2 of the present invention.

FIG. 23 shows a table of participating users used in the streaming server computer constituting the virtual space content streaming system according to Embodiment 2 of the present invention.

FIG. 24 shows a diagram illustrating data exchanged between the streaming server computer and the viewer device constituting the virtual space content streaming system according to Embodiment 2 of the present invention.

FIG. 25 shows a diagram illustrating data exchanged between the streaming server computer and the viewer device constituting the virtual space content streaming system according to Embodiment 2 of the present invention.

FIG. 26 shows a diagram illustrating data exchanged between the streaming server computer and the viewer device constituting the virtual space content streaming system according to Embodiment 2 of the present invention.

FIG. 27 shows a diagram illustrating relationships between types of period and a generating entity of virtual-camera-viewpoint visuals in the virtual space content streaming system according to Embodiment 2 of the present invention.

FIG. 28 shows a diagram illustrating generation situations of virtual-camera-viewpoint visuals and viewer-viewpoint visuals in the streaming server computer and the viewer device constituting the virtual space content streaming system according to Embodiment 2 of the present invention.

FIG. 29 shows a flow chart illustrating viewer-viewpoint visuals generation processing in a variant example according to Embodiment 2 of the present invention.

FIG. 30 shows details of virtual space update data transmitted from the streaming server computer in the variant example according to Embodiment 2 of the present invention.

FIG. 31 shows a diagram illustrating details of a virtual live streamed by a virtual space content streaming system according to Embodiment 3 of the present invention.

(A) and (B) in FIG. 32 show modes of motions of viewer users in a virtual live in Embodiment 3 of the present invention.

(A) in FIG. 33 shows a diagram illustrating data transmitted from the streaming server computer constituting the virtual space content streaming system according to Embodiment 3 of the present invention to the viewer device. (B) in FIG. 33 shows a diagram illustrating differences among the viewer users in a virtual live.

(A) in FIG. 34 shows a table of participating users used in the streaming server computer constituting the virtual space content streaming system according to Embodiment 3 of the present invention. (B) in FIG. 34 shows data of a music list stored in the streaming server computer.

FIG. 35 shows a diagram illustrating situations of transmission of information by the streaming server computer during the respective periods of the virtual live according to Embodiment 3 of the present invention.

FIG. 36 shows a diagram illustrating data exchanged between the streaming server computer and the viewer device constituting the virtual space content streaming system according to Embodiment 3 of the present invention.

FIG. 37 shows a flow chart illustrating details of slow motion entity determination processing executed in the streaming server computer constituting the virtual space content streaming system according to Embodiment 3 of the present invention.

FIG. 38 shows a diagram illustrating data exchanged between the streaming server computer and the viewer device constituting the virtual space content streaming system according to Embodiment 3 of the present invention.

(A) in FIG. 39 shows a flow chart illustrating details of viewer-viewpoint visuals generation processing 1 executed in a viewer device constituting the virtual space content streaming system according to Embodiment 3 of the present invention. (B) in FIG. 39 shows a flow chart illustrating details of viewer-viewpoint visuals generation processing 2.

(A) and (B) in FIG. 40 show display examples of viewer-viewpoint visuals of a virtual live, on a viewer device constituting the virtual space content streaming system according to Embodiment 3 of the present invention.

(A) and (B) in FIG. 41 show display examples of viewer-viewpoint visuals of a virtual live, on a viewer device constituting the virtual space content streaming system according to Embodiment 3 of the present invention.

FIG. 42 shows a diagram illustrating a virtual live venue in a variant example according to the present invention.

FIG. 43 shows a participation position selection screen for selecting a position to participate in a virtual live venue in the variant example.

(A) in FIG. 44 shows a diagram illustrating a range in which a viewer user can move in a variant example according to the present invention. (B) in FIG. 44 shows a display example on the viewer device in the variant example.

FIG. 45 shows a diagram illustrating a situation where motions of the viewer avatar are adjusted in a variant example according to the present invention.

FIG. 46 shows a diagram illustrating relationships between periods of the virtual live, and periods of performing content and non-performing content, in a variant example according to the present invention.

FIG. 47 shows a diagram illustrating relationships between periods of the virtual live and motions that the viewer avatar can perform in a variant example according to the present invention.

FIG. 48 shows a diagram illustrating data exchanged between the streaming server computer and the viewer device in a variant example according to the present invention.

### DETAILED DESCRIPTION OF THE INVENTION

Embodiments of a virtual space content streaming system according to the present invention will be described now with reference to the drawings. It should be noted that redundant explanations will be omitted by assigning the same reference symbol to the same or similar elements that appear in multiple drawings. It may be preferable if the virtual space content streaming program according to the present invention is a program used by the entire system constituted by a server computer described below and the respective devices, constituting the virtual space content streaming system. Alternatively, it may be preferable if the virtual space content streaming program is a program that is executed only in a part of devices, such as a server computer or the respective devices, constituting the virtual space content streaming system. The respective types of processing described below are all executed by programs stored in devices in which the processing is executed.

### Embodiment 1

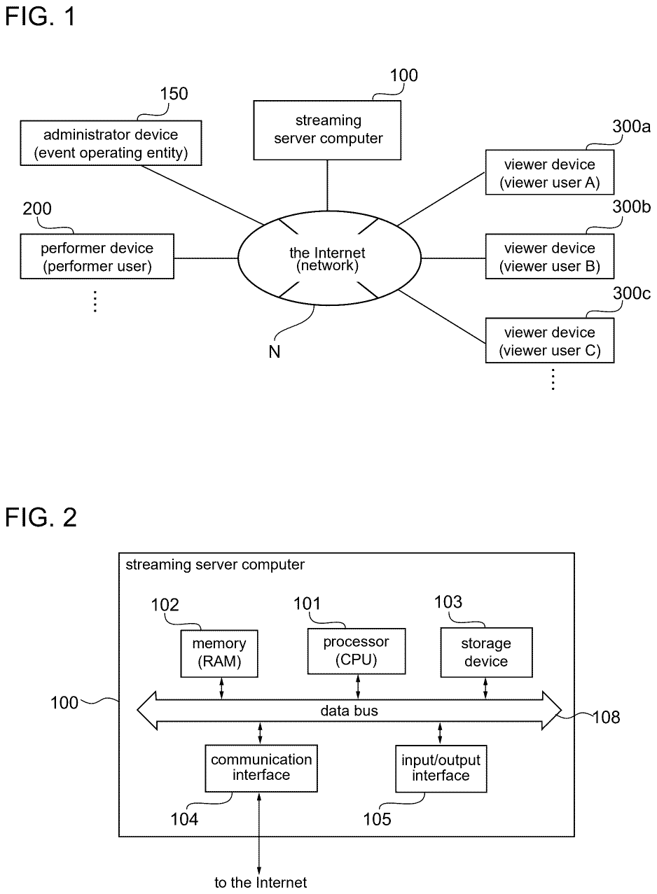

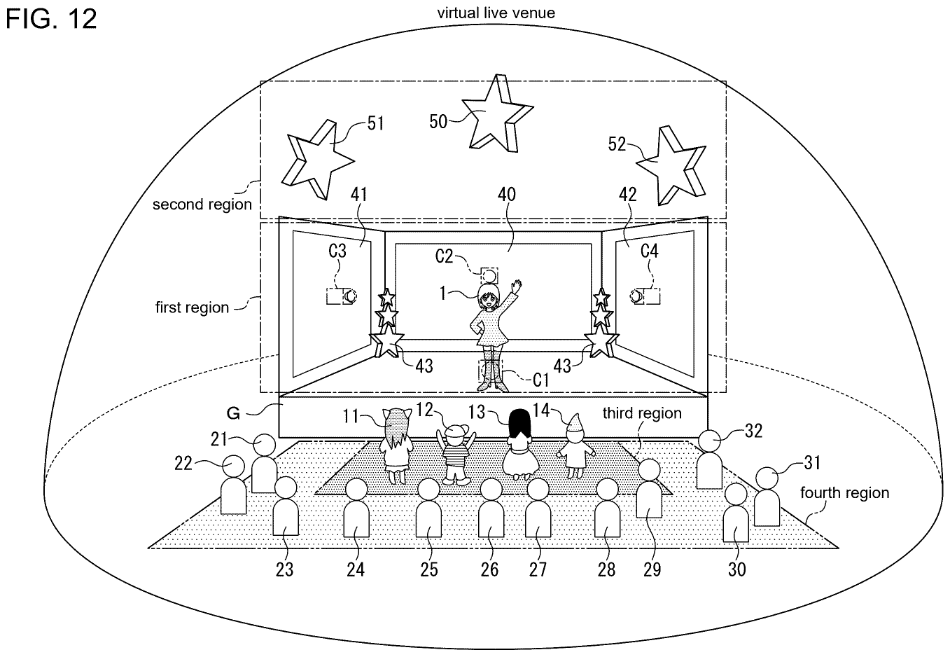

FIG. 1 shows a block diagram illustrating a system configuration example of a virtual space content streaming system in accordance with Embodiment 1 of the present invention. In the system according to Embodiment 1 shown in FIG. 1, a virtual live is streamed as virtual space content in which a performer avatar 1 corresponding to a performer user performs a live event in a virtual live venue shown in FIG. 12. The term, “streaming” or “stream” herein indicates transmission to a plurality of entities and has the same meaning as “transmission”.

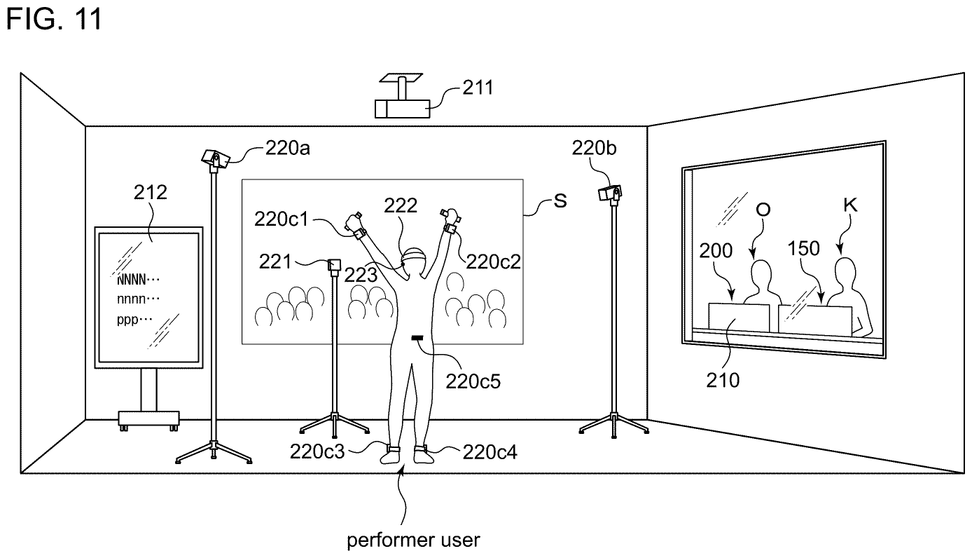

As shown in FIG. 1, the virtual space content streaming system according to Embodiment 1 is mainly constituted by: a streaming server computer 100 capable of executing various processes related to the virtual live venue, which is in a virtual space, shown in FIG. 11, and various processes related to the streaming of the virtual live; an administrator device 150 used for administering the streaming of the virtual live by an event administrator M of an event operating entity who operates and administers the virtual live event; a performer device 200 for use by a performer user; and a viewer device 300 that can be used by a viewer user who is virtually participating in and viewing the virtual live, wherein the streaming server computer 100, the administrator device 150, the performer device 200, and the viewer device 300 are connected to each other via the Internet N, which is an open computer network, to allow data communication.

In Embodiment 1, an example is given of a form in which the administrator device 150 and the performer device 200 are connected to the streaming server computer 100 via the Internet N but the present invention is not limited to this. For example, it may be preferable if, when the studio shown in FIG. 11 is a studio operated by an event operating entity who provides the studio to a performer user, and the streaming server computer 100 is located in this studio, the administrator device 150 or the performer device 200 may be locally connected to the streaming server computer 100 for data communication, or may be connected for communication via a local region network (LAN) within the studio facility.

As shown in FIG. 1, there are a plurality of viewer users, such as viewer user A, viewer user B, and viewer user C, and examples of the viewer device 300 include a viewer device 300a, a viewer device 300b, and a viewer device 300c, which can be used by individual viewer user A, viewer user B, viewer user C. Typically, there are a plurality of viewer users, but the number may be one, or four or more. The number may be determined appropriately depending on factors such as the virtual live venue, which is in a virtual space. Hereinafter, viewer user A, viewer user B, viewer user C, and so on, may be collectively referred to as a “viewer user”, and viewer device 300a, viewer device 300b, viewer device 300c, and so on, may be collectively referred to as a “viewer device” 300.

In Embodiment 1, an example is given of a form in which there is one performer user but the present invention is not limited to this. It may be preferable if the virtual live is a collaborative event in which a plurality of performer users, each usually acting as a sole performer, virtually participate, or is a group event in which a group of a plurality of members, who usually perform a performance together, virtually participate. Thus, when a plurality of performers jointly perform a performance, a performer device 200a, a performer device 200b, a performer device 200c, and so on, may be provided for each performer user, or if a group of a plurality of members performs a performance, one performer device 200 may be shared by a plurality of members.

Although FIG. 1 illustrates the streaming server computer 100 as a single unit, the present invention is not limited to this. It may be preferable if the streaming server computer 100 is configured with a plurality of server computers, such as a first server computer that mainly performs virtual space processing and a second server computer that mainly performs streaming processing, or if the streaming server computer 100 is configured by a cloud server or the like, such that the number of server computers can be changed appropriately depending on the scale of the event, and the number of participating viewer users, among others.

Similarly, the administrator device 150 is illustrated as a single unit in FIG. 1 but the present invention is not limited to this. Of course, there may be a plurality of administrator devices 150 depending on the number of performer users and viewer users virtually participating in the live.

### Streaming Server Computer

FIG. 2 shows a diagram illustrating the configuration of the streaming server computer 100 used in Embodiment 1. The streaming server computer 100 used in Embodiment 1 is, as described above, a typical server computer, with relatively excellent processing power, that is installed in a studio operated by an event operating entity. As shown in FIG. 2, the streaming server computer 100 includes: a processor (CPU) 101 connected to a data bus 108; a memory (RAM) 102; a storage device 103 such as a hard disk drive; a communication interface (I/F) 104 capable of communicating bidirectionally using TCP/IP protocol via the Internet, which is an open computer network; and an input/output interface (I/F) 105 to which, for example, an inputting device such as a keyboard can be connected.

In Embodiment 1, an input/output interface (I/F) 105 is provided to enable a local operation. However, if a remote operation is possible via the communication interface (I/F) 104, the input/output interface (I/F) 105 need not be provided.

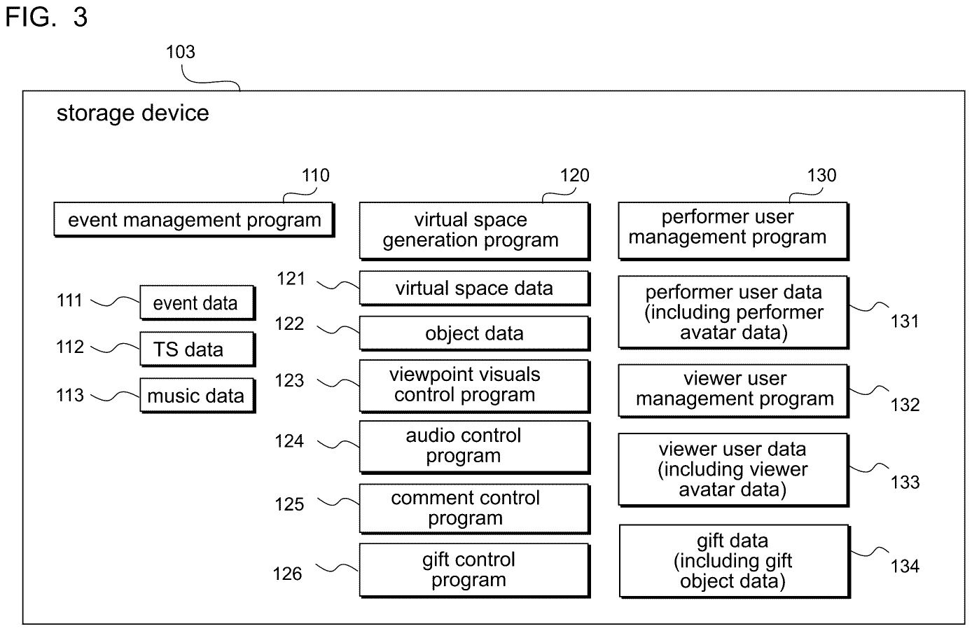

In the storage device 103 of the streaming server computer 100, various data and programs are stored as shown in FIG. 3 in addition to an operation system (server OS) (not illustrated) for providing server functions. Specifically, the storage device 103 mainly stores: an event management program 110 for providing an event administering function of administering live events; a virtual space generation program 120 for providing a virtual space of a virtual live venue, which is in a virtual space; a performer user management program 130 for providing a performer user administering function of administering the performer user; and a viewer user management program 132 for providing a viewer user administering function of administering the viewer user.

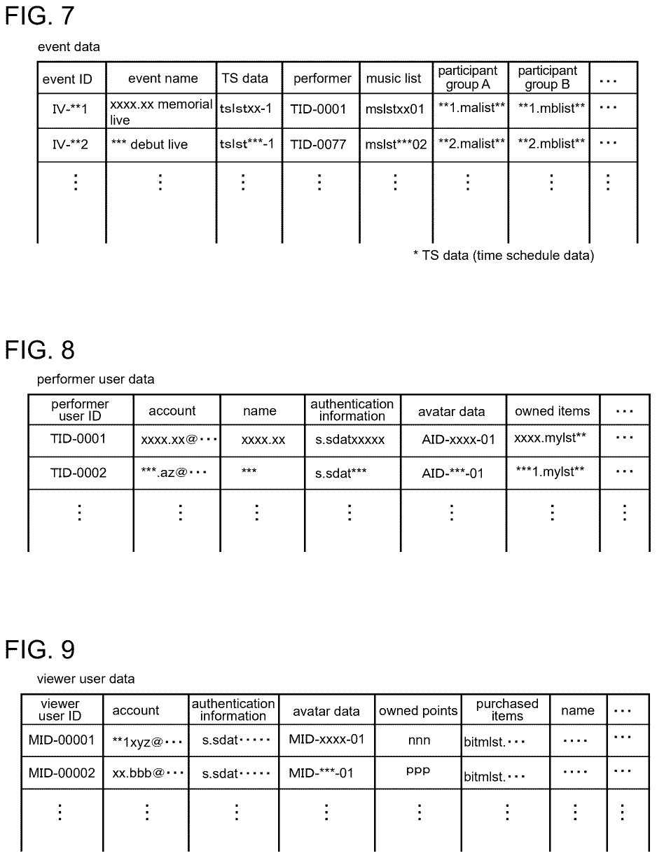

The event management program 110 is a program for administering a virtual live, which is an event held at a virtual live venue (see FIG. 12), in conjunction with the administrator device 150. The event management program 110 is capable of administering the progress of the virtual live event by using event data 111 (see FIG. 7), time schedule data (TS data) 112, and music data 113 stored in the storage device 103, together with the event management program 110.

An example of the event data 111 used in Embodiment 1 is shown in FIG. 7. Examples of information included in the event data 111 include, in association with an event ID uniquely assigned to the event: an event name; a file name of the time schedule (TS) data; a performer ID uniquely assigned to a performer user, who is a performer; a file name of a music list; a file name of a participating viewer list in which information of a special viewer user who has been allowed virtual participation is registered, in a third region of the virtual audience region described below; and a file name of the participating viewer list in which information of a viewer user who has reserved virtual participation is registered, in a fourth region of the virtual audience region described below.

The time schedule data (TS data) 112 is data in which an order of progression of the virtual live to be held and a program of songs or the like are described in chronological order, and is managed such that the virtual live event progresses based on the time schedule described in the time schedule data (TS data) 112. The time schedule data (TS data) 112 and the event data 111, among others, can be modified, updated, or appended by the event administrator M manipulating the administrator device 150.

The music data 113 is data on the music playing part (so-called “karaoke part”) of the respective song sung by the performer user, and is played by the audio control program 124 described below by means of the event management program 110 based on the time schedule data (TS data) 112 and transmitted to the performer device 200 or the viewer device 300 (see FIG. 11).

The virtual space generation program 120 is a program for providing a virtual live venue, which is in a virtual space, shown in FIG. 12, and has a function of providing a virtual live venue in which performer avatars and viewer avatars are virtually participating, using: virtual space data 121 describing a structure of the virtual live venue, or the like, which is stored in the storage device 103 together with the virtual space generation program 120; object data 122 for arranging within the virtual space various objects (including virtually-arranged objects 43, which are star decorations, on the stage and virtual aerial objects 50-52, which are star objects in the sky) on the virtual live venue; and performer avatar data included in performer user data 131 described below and viewer avatar data included in viewer user data 133.

The viewpoint visuals control program 123, as shown in FIG. 12, is a program for providing a function of generating visuals from viewpoint of virtual cameras C1-C4 virtually installed on the virtual live venue and an aerial-moving virtual camera (not illustrated), and also provides a function of displaying on the viewer device 300, in conjunction with the viewer device 300, visuals from the respective viewpoints of the viewer avatars 11-14 virtually participating in a third region of the virtual live venue and viewer avatars 21-32 virtually participating in a fourth region. The virtual camera C2 is a virtual camera installed for having visuals from the viewpoint of the performer avatar 1 that is on the stage on the virtual live venue. The visuals from viewpoint of the virtual camera C2 are projected onto a screen S, installed on the studio, by a projector 211 described below connected to the performer device 200 in conjunction with the performer device 200.

The audio control program 124 is a program for controlling the audio (including music) streamed in the virtual live event, and specifically, provides a function of playing music data 113, and a function of streaming to the administrator device 150 and the viewer device 300 audio produced by the performer user by synthesizing with the playing music.

The comment control program 125, in conjunction with a viewer comment control program stored in the viewer device 300 described below, provides a function of displaying various comments entered by the respective viewer users on the viewer device 300 during a virtual live event in chronological order on the performer device 200 and the viewer device 300.

The gift control program 126 is a program for carrying out control related to gifts given from the viewer users to the performer users, in conjunction with a viewer program stored in the viewer device 300 described below, and specifically provides functions such as a function of causing the viewer user to purchase a gift based on information on a unit price for purchase set for various gifts stored in gift data 134, a processing function (including processing for the performance rendition or the like when giving the gift) for the viewer user to give a gift purchased using gift object data included in the gift data 134 to the performer user, and a processing function of changing an owner of a gift given from the viewer user to the performer user.

The performer user management program 130, together with the performer user management program 130, provides an information administering function, and an authentication function, among others, for the performer user based on performer user data 131 shown in FIG. 8 stored in the storage device 103.

An example of the performer user data 131 used in Embodiment 1 is shown in FIG. 8. The performer user data 131 includes, in correspondence with a performer user ID uniquely assigned to the performer user, various information, such as those relating to: an account of the performer user (email address); name; authentication information; a file name of the avatar data for the avatar used in the virtual space; and a file name of an item list in which owned items are registered. Although not shown in FIG. 8, information on virtual value, such as points, owned by the respective performer users may be included in the performer user data 131.

Performer users can be authenticated by, for example, matching the performer user ID, account, and authentication information, and items (gifts) that the performer user has come to own as a result of being given to them by the viewers can be identified from the item list.

The viewer user management program 132 provides functions such as information administering function and an authentication function for viewer users based on viewer user data 133 shown in FIG. 9, stored in the storage device 103 together with this program.

FIG. 9 shows an example of the viewer user data 133 used in Embodiment 1. The viewer user data 133 includes, in correspondence with a viewer user ID uniquely assigned to the viewer user, various information, such as an account of the viewer user (email address), authentication information, a file name of avatar data of an avatar to be used in the virtual space, owned points which are the number of points that can be used in the virtual space, a file name of an item list in which items (gifts) purchased using the points are registered, and personal information such as name, date of birth, and telephone number. Although not shown in FIG. 9, nickname (comment name) to be displayed together with a comment is also included in the viewer user data 133, and the nickname (comment name) is displayed together with the comment. Points can be increased by purchasing them from a particular operating company, for example.

### Performer Device

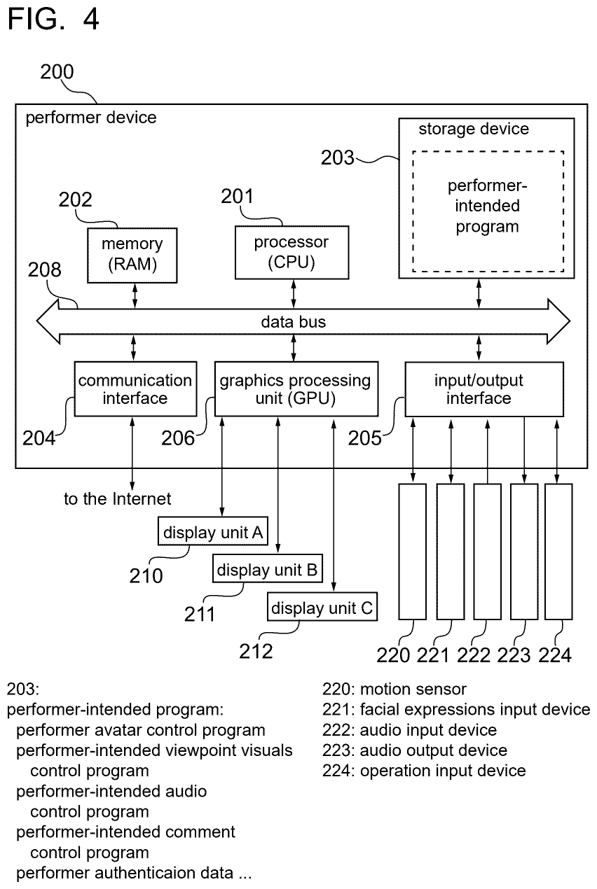

FIG. 4 shows a diagram illustrating a configuration example of the performer device 200 in the virtual space content streaming system according to Embodiment 1. In Embodiment 1, as shown in FIG. 11, the performer device 200 is installed in a control room adjacent to the studio where the performer user performs the performing motions, and uses a typical computer with relatively excellent processing power. As shown in FIG. 4, the performer device 200 includes: a processor (CPU) 201; a memory (RAM) 202; a storage device 203 such as a hard disk drive; a communication interface (I/F) 204 capable of communicating bidirectionally using TCP/IP protocol via the Internet, which is an open computer network; an image processing unit 206 including a graphics processing unit (GPU) to which display units A210-C212 are connected; and an input/output interface (I/F) 205 to which various input/output devices are connected. These devices are connected to a data bus 208.

The input/output interface (I/F) 205 serves as an input device and is connected to devices such as a motion sensor 220 including a plurality of attaching sensors 220c1-220c5 (see FIG. 11) worn by the performer user on the left and right limbs and waist, a facial expressions input device 221 constituted by an imaging camera for inputting facial expressions of the performer, an audio input device 222 constituted by a sound-collecting microphone worn on the head of the performer user, and an operation input device 224, such as a keyboard or touch panel, that can be manipulated by an assisting operator O who assists the performer user. A controller that allows the performer user to perform various operations by holding the controller may be installed as an input device to allow the performer to perform various operations alone without involving the assisting operator O.

In Embodiment 1, an assisting operator O assists the operations during the performance in order for the performer user to perform performance motions (including musical motions such as singing and dancing) in accordance with a music. However, it is also possible to omit such an assisting operator O by, for example, having a plurality of assisting operators O, or registering the operation details in advance in the performer device 200, for example, in a sequence program.

An audio output device 223, which serves as an output device, and includes, for example, high-performance earphones (in-ear monitors) worn by a performer user, and a speaker arranged in the control room, is connected to the input/output interface (I/F) 205. Thereby, the sound of the playing music transmitted from the streaming server computer 100 is output to the performer user via the high-performance earphones (in-ear monitors), and the musical audio is output from the speaker along with the performer's voice, allowing an assisting operator O or the like to check the situation of the music, including the voice generated by the performer user, in the control room.

In Embodiment 1, high-performance earphones (in-ear monitors) are used to avoid the inconvenience caused by audio of the playing music being input from the sound collection microphone worn by the performer user, but the present invention is not limited to this. The musical audio may be output from speakers in the studio or the like, as long as the inconvenience caused by the input of the musical audio can be avoided.

In Embodiment 1, the sound collecting microphones are worn by the performer users, but the sound collecting microphones may be installed on the floor, the wall, or the ceiling in the studio.

The motion sensor 220 used in the performer device 200 in accordance with Embodiment 1 will be described now. Any type of motion sensor can be used as the motion sensor 220 as long as it can appropriately detect (measure) the body motions (motions) of the performer user. In Embodiment 1, a plurality of attaching sensors 220c1-220c5, which are worn by the performer user on the body, are used in order to detect the motions of the performer more accurately and in a shorter cycle. The motion sensor 220 may be of a type, such as LiDER, which uses laser light or the like, that does not require the performer to attach any equipment.

In Embodiment 1, in order to reduce the burden on the motions of the performer user caused by wearable sensors or the like when performing performance motions, particularly the burden on the motions of the head of the performer user, the motions of the head of the performer user are detected by image recognition that uses visuals captured by the imaging camera that constitutes the facial expressions input device 221, and five attaching sensors 220c1-220c5 are used for motions other than those of the head. However, for example, an attaching sensor may also be installed on the head of the performer user, or a larger number (seven or more) of attaching sensors may be worn for detecting more detailed motions, as described below.

As shown in FIG. 11, the attaching sensors 220c1-220c5 detect their own positions and orientations in conjunction with base station devices 220a and 220b installed in a studio room separated from the adjacent control room by a glass window.

The base station 220a and the base station 220b may use a multi-axis laser emitter, for example. The base station 220a emits a flashing light for synchronization and then irradiates and scans a laser light, for example, around a vertical axis. The base station 220b irradiates and scans a laser beam, for example, about a horizontal axis.

Each of the attaching sensors 220c1-220c5 may include a plurality of optical sensors for detecting the incidence of blinking light and laser light from the base station 220a and the base station 220b.

Each of the wearable sensors 220c1-220c5 is capable of detecting its own position and orientation based on the time difference between the incidence timing of the flashing light and the incidence timing of the laser light, the light reception time at the respective optical sensors, the incidence angle of the laser light detected by the respective optical sensors, and other information as necessary. For example, ViveTracker available from HTC CORPORATION, or a base station can be suitably used for the wearable sensors.

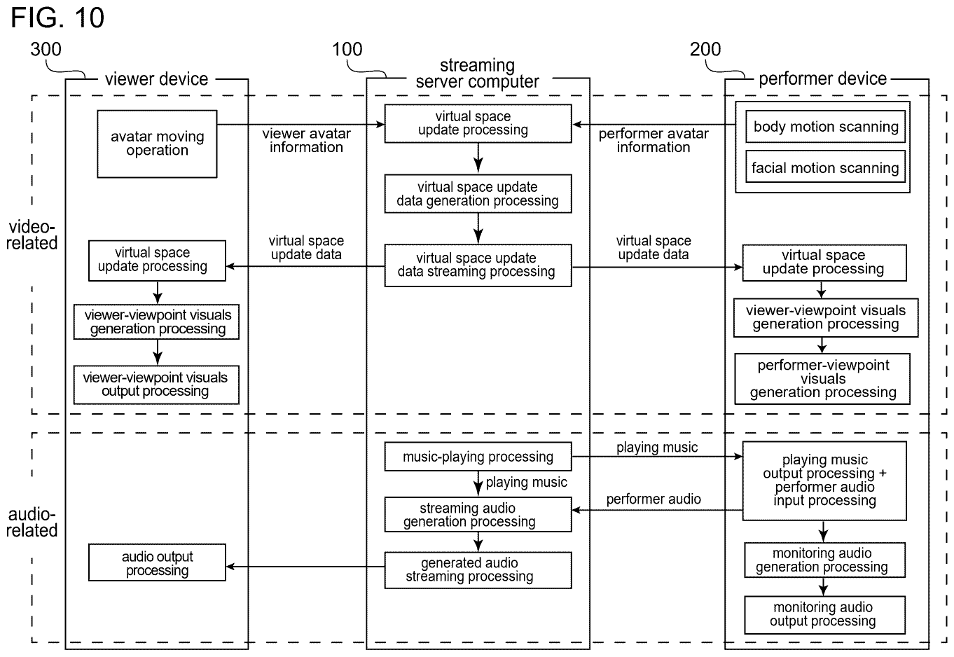

The base station 220a and the base station 220b emit blinking light and perform laser light scanning at regular intervals, and therefore the detection information of the respective attaching sensors 220c1-220c5 is updated at each interval. Then, the detection information indicating the position and orientation of each motion sensor calculated in each of the attaching sensors 220c1-220c5 is input to the performer device 200 via near field communication, and is transmitted to the streaming server computer 100 as performer avatar information together with facial motion information (see FIG. 10).

In Embodiment 1, an example is shown in which two base stations, base station 220a and base station 220b, are used but the present invention is not limited to this. The number of base station devices may be three or more.

The motion sensor 220 may be configured such that each of a plurality of motion sensors worn by the performer user is equipped with a large number of infrared LEDs or visible light LEDs to detect the light from the LEDs with an infrared camera installed on the floor or the wall of the studio, allowing to detect the position and orientation of each of the motion sensors.

Further, in order to reduce the burden on the performer user, the motion sensor 220 may use a motion sensor that uses a reflective marker, which has a lighter weight than the attaching sensors 220c1-220c5, instead of the attaching sensors 220c1-220c5. That is, the motion sensor may be of a type that detects the motion of the performer user by capturing visuals of reflective markers attached to various parts of the body of the performer user with adhesive tape or the like to generate visuals data, and processing the visuals data, allowing to detect the position and orientation of the reflective markers. In this case, a cameraman may be positioned in the studio for capturing visuals of the motion of the performer user, and by capturing visuals of the performer user, the motion of the performer user is captured from a direction suitable for detection, allowing the motion of the performer user to be detected well.

The motion sensor 220 may be of a type that detects the motion of the performer user by using a suit including an inertial sensor, such as a suit with a built-in inertial sensor for MVN motion capture system available from Xsens.com, and analyzing sensor signals output from the inertial sensor.

Any facial expressions input device 221 can be used as long as it can appropriately detect the motion of the head, including the face, of the performer user. In Embodiment 1, specifically, the facial expressions input device is configured by an imaging camera (digital camera) arranged such that it can continuously capture visuals of the head, including the face, of the performer user. The motion of the head and face of the performer (facial expression) user captured by the imaging camera is detected by image recognition. Information on the detected facial motion, which is the detected motions of the head and face (facial expression), is transmitted to the streaming server computer 100 as performer avatar information together with body motion information, as shown in FIG. 10.

The facial expressions input device 221 is not limited to an imaging camera (digital camera) used in Embodiment 1. For example, the facial expressions input device 221 may be a 3D camera capable of detecting the depth of the face of a person, or a mobile device, such as a smartphone, equipped with a LiDER device. In this case, the mobile device may be attached to the performer user.

As described above, the performer device 200 according to Embodiment 1 includes three display units A210-C212. As shown in FIG. 11, the display unit A210 is, for example, an LCD monitor installed in the control room, the display unit B211 is a projector for projecting visuals onto a screen S installed in the studio, and the display unit C212 is a large vertical display installed adjacent to the screen S in the studio.

The display unit A210, which is arranged in the control room of the studio, displays, for example, visuals from each of the viewpoints of the virtual cameras C1-C4, visuals from viewpoint of an aerial-moving virtual camera during the flying performance period described below, details of the comments, and a message inputting window into which an assisting operator O inputs messages to the performer user.

Meanwhile, the screen S projected from a projector, which is a display unit B211, installed in the studio, displays, for example, visuals including avatars of viewers who are virtually participating in the live in the third and fourth regions, as shown in FIG. 15. Such visuals are visuals from viewpoint of a virtual camera C2 (see FIG. 12), corresponding to the viewpoint of the performer. Thereby, the performer user can check the situation of the viewer users who are virtually participating in the virtual live through the visuals.

Comments from viewer users, as well as comments and messages entered by the assisting operator O, among others, are displayed on the display unit C212 installed in the studio, allowing the performer user to check the comments from the viewer users and messages from the assisting operator O even during the performance.

In addition to an operating system (OS) for operating a computer, which is a performer device 200, the storage device 203 stores a performer program for providing, when executed by a processor (CPU) 201 or the like, in conjunction with the streaming server computer 100, various functions, including a motion control function of the performer avatar 1, corresponding to the performer avatar, in the virtual live, which is virtual space content.

As shown in FIG. 4, the performer program includes a performer avatar control program, a performer-viewpoint visuals control program, a performer audio control program, a performer comment control program, and performer authentication data, among others.

The performer avatar control program is a program that mainly provides the function of scanning the body motion of the performer user using the motion sensor 220 and scanning the facial motion (facial expression) of the performer user using the facial expressions input device 221, and generating performer avatar information for moving the performer avatar for transmitting it to the streaming server computer 100.

The performer-intended viewpoint visuals control program is a program for providing a function of generating and outputting visuals from viewpoint of the virtual camera C2, corresponding to the performer viewpoint, based on the virtual space update data streamed from the streaming server computer 100.

The performer audio control program is a program for providing the function of outputting the playback sound of a music based on the playback music data streamed from the streaming server computer 100 via the audio output device 223, and converting the audio input from the audio input device 222 into data for transmitting it to the streaming server computer 100 as performer audio data, thereby generating and outputting monitor audio constituted by the playback sound of the music and the performer audio.

The performer comment control program is a program for providing a function of displaying, for example, the respective comments from viewer users, streamed from the streaming server computer 100.

The performer authentication data is data for authenticating the identity of the performer user in a communication connection with the streaming server computer 100.

The performer avatar control program includes, for example, a motion parameter generation program capable of generating parameter information for the positions and rotation angles of the bones that constitute rig data (also referred to as “skeleton data”) indicating the skeleton of the performer avatar, included in the performer avatar data, as well as an image recognition processing program for performing image recognition of the position of the head and facial expression of the performer user from visuals captured by an imaging camera.

In Embodiment 1, the performer device 200 has a form in which a computer which serves as the performer device 200 and which is installed in a studio operated by an event operating entity is used jointly by a plurality of performer users, and when holding a live event, and each performer user can use the computer as the performer device 200 of the performer user by entering performer authentication data. However, the present invention is not limited to this. For example, the performer device 200 can be a computer used only by a performer user who owns it as in a case where a performer user appears in a virtual live from one's home or the like and the performer device 200 is a dedicated computer used only by the performer user who has installed it on one's home. In such as case, it is not necessary to store performer authentication data.

Accordingly, by having a performer user or the like use the performer device 200 that constitutes the virtual space content streaming system according to Embodiment 1, the performer user can cause the performer avatar 1 arranged on the virtual stage G in the virtual live venue to move in conjunction with the motion of the performer user, and can reflect one's facial expressions in the facial expressions of the performer avatar 1. Moreover, the performer user can stream one's voice as voice of the performer avatar 1 to viewers via the streaming server computer 100.

### Viewer Device

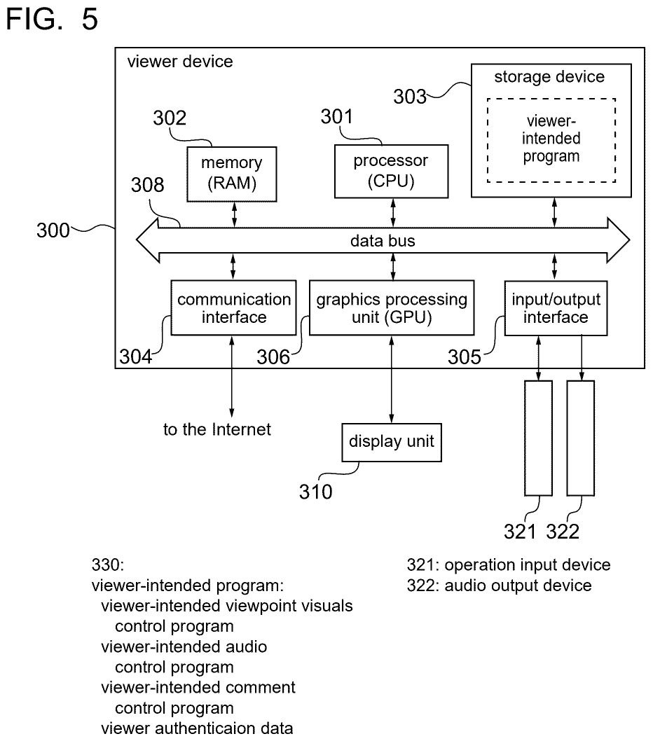

FIG. 5 shows a diagram illustrating a configuration example of the viewer device 300 in the virtual space content streaming system according to Embodiment 1. In Embodiment 1, the viewer device 300 is a smartphone P carried by the viewer user or a typical desktop computer (PC) installed in, for example, the viewer user's home. As shown in FIG. 5, the viewer device 300 includes: a processor (CPU) 301 connected to a data bus 308; a memory (RAM) 302; a storage device 303 such as a hard disk drive or a non-volatile memory; a communication interface (I/F) 304 capable of communicating bidirectionally using TCP/IP protocol via the Internet, which is an open computer network; an image processing unit 306 including a graphics processing unit (GPU) to which a display unit 310 is connected; and an input/output interface (I/F) 305 to which various input/output devices are connected.

As described below, the display unit 310 is capable of displaying viewpoint visuals generated based on virtual space data of a virtual live venue, which is in a virtual space, updated by virtual space update data (see FIG. 10) streamed from the streaming server computer 100, and flying viewpoint visuals streamed from the streaming server computer 100 during the flying performance period described below, using a viewer-intended viewpoint visuals control program included in the viewer program stored in storage device 303. If the viewer device 300 is a smartphone P, the display unit 310 corresponds to a display unit of the smartphone P, and if the viewer device 300 is a typical computer (PC), the display unit 310 corresponds to a stationary display unit that constitutes the computer (PC). These display units are not limited to those that display planar visuals (2D images), but may also be a display unit, such as a head-mounted display (HMD) which can be worn by a viewer, capable of displaying stereoscopic visuals (3D images) by displaying right-eye and left-eye visuals.

The input/output interface (I/F) 305 is connected to: an operation input device 321, which serves as an input device and which is constituted by one or more devices that allow the viewer to perform various operations; and an audio output device 322, such as earphones or speakers, that can output, for example, live audio, streamed from the streaming server computer 100.

Of course, the audio output device 322 need not be a separate device, but may be integrated with a display unit 310 as in the head mounted display (HMD) described above.

The operation input device 321 may be any device that allows the viewer to perform various operations, such as moving operations including an operation of the viewer moving the viewer avatar, zooming-related operations, operations related to comments, operations related to gifts or the like. For example, the operation input device 321 is constituted by at least one of a transparent touch panel formed on the display surface of a smartphone, a keyboard constituting a computer, and a game controller.

In Embodiment 1, as described below and as shown in FIG. 12, the virtual audience region in the virtual live venue has regions of: a third region near the virtual stage G in which only viewer users who have been specially allowed by the performer user can virtually participate; and a fourth region which is arranged around the third region and in which general viewer users can virtually participate. Viewer users who virtually participate in the fourth region may be viewer users who perform operations by having an operation input device 321 such as a touch panel, a keyboard, or a game controller, as described above. However, viewer users who virtually participate in the third region are viewer users who can move their viewer avatars precisely with their motions, similarly to the performer users, by having, for example, an MVN motion capture suit equipped with the above-described inertial sensor, as an operation input device 321.

However, even if the viewer user is a viewer user who are allowed to virtually participate in the third region, such a viewer user cannot change the facial expressions of the viewer avatar, but the present invention is not limited to this. The facial expressions of the viewer avatars may be changed, even at a level different from the level of change made by the performer user, by the viewer user using a camera functionality of a smartphone or a camera connected to a computer to have the facial expressions of the viewer user recognized, as described above, for example.

Various input/output devices connected to the input/output interfaces (I/F) 305 may be a built-in device or may be an external device. When it is an external device, it may be connected in either a wired or wireless manner.

The storage device 303 stores a viewer program as a viewing app, in addition to an operating system (OS) for operating a smartphone or a computer, which services as a viewer device 300. The viewer program, when executed by a processor (CPU) 301 or the like, provides various functions, including a live viewing function for the viewer users in a virtual live, which is virtual space content, in conjunction with the streaming server computer 100.

As shown in FIG. 5, the viewer program includes: a viewer-intended viewpoint visuals control program for providing a function of generating the respective viewpoint visuals in a virtual live to be displayed on the display unit 310; a viewer audio control program for providing a function of outputting from the audio output device 322 live audio based on live audio (data) of the virtual live streamed from the streaming server computer 100; a viewer comment control program for displaying comments based on comment data streamed from the streaming server computer 100 and providing functions related to comments such as a function of transmitting a comment entered by the viewer to the streaming server computer 100; and viewer authentication data for authenticating that the viewer user is the person in question in a communication connection with the streaming server computer 100.

Although not shown in FIG. 5, in addition to the above-described programs, there are a gift control program for performing control or the like related to gifts, and a region specifying program for reserving a region (position) in which a viewer avatar virtually participates in the virtual live venue in advance before the start of a live event, as shown in Variant example 3-1 (see FIGS. 42 and 43), but other programs besides the above may also be included.

In Embodiment 1, the comments entered by viewers are short messages in text format, but are not limited to such short messages in text format and may be, for example, messages in still image format, messages in video format, or electronic messages in any other format. Comments are displayed on the display unit 310 superimposed on the viewpoint visuals.

Accordingly, by using the viewer device 300 that constitutes the virtual space content streaming system according to Embodiment 1, a viewer user can move and operate the viewer avatar that is virtually participating in the virtual live venue, and can change the viewpoint visuals displayed on the display unit 310 by changing the viewpoint of the viewer avatar, and can change the zooming state (viewpoint state) as well, allowing the viewer avatar to be operated to cheer on the performer avatar 1.

A viewer avatar virtually participating in the third region can only move within the third region and cannot move to the fourth region. Meanwhile, a viewer avatar that is virtually participating in the fourth region can only move within the fourth region and cannot move to the third region. However, the present invention is not limited to this, and there may be a configuration where a viewer avatar that has virtually participated in the third region can move to the fourth region. Furthermore, since a viewer avatar cannot move onto the virtual stage G or the like naturally, the visibility of the performer avatar 1 is not obstructed by a viewer avatar that has moved onto the virtual stage G.

By displaying viewpoint visuals on the display units 310 and outputting live audio, users can enjoy a virtual live with the feeling that one is actually present at the virtual live venue.

Although detailed explanation is omitted, the comment function provided by the viewer comment control program allows viewers to enjoy the virtual live while checking comments entered by themselves and other viewer users, and the gift function provided by the gift control program allows viewers to liven up the virtual live by gifting items they own to the performer avatar 1.

### Administrator Device

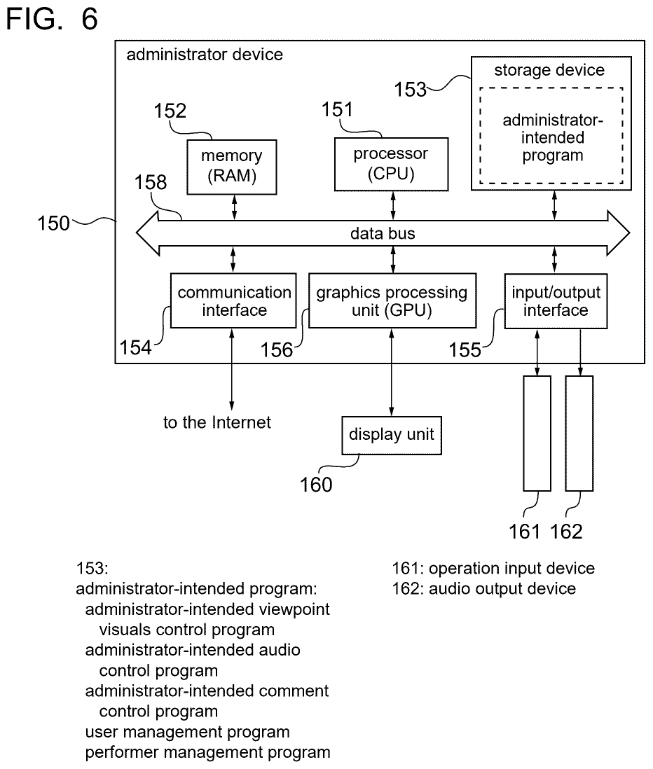

FIG. 6 shows a diagram illustrating a configuration example of the administrator device 150 in the virtual space content streaming system according to Embodiment 1. In Embodiment 1, the administrator device 150 uses a typical computer installed in a control room adjacent to the studio, together with the performer device 200, and as shown in FIG. 6, includes: a processor (CPU) 151 connected to a data bus 158; a memory (RAM) 152; a storage device 153 such as a hard disk drive; a communication interface (I/F) 154 capable of communicating bidirectionally using TCP/IP protocol via the Internet, which is an open computer network; an image processing unit 156 including a graphics processing unit (GPU) to which a display unit 160 is connected; and an input/output interface (I/F) 155 to which various input/output devices are connected.

As described below, by means of the administrator-intended viewpoint visuals control program included in the administrator-intended program stored in the storage device 153, the display unit 160 is capable of individually displaying visuals from viewpoint of the respective virtual cameras C1-C4 described below and the aerial-moving virtual camera during the flying performance period, the viewpoint visuals being generated based on virtual space data of the virtual live venue, which is in a virtual space, the virtual space data being updated by virtual space update data (see FIG. 10) streamed from the streaming server computer 100. The display unit 150 is also capable of displaying comments based on comment data streamed from the streaming server computer 100. The display unit 150 is constituted by one or more stationary display units.

The input/output interface (I/F) 155 is connected to an operation input device 161 which serves as an input device and which is constituted by one or more devices that enable the event administrator M to perform various operations, and an audio output device 162, such as earphones, headphones, or speakers, which can output live audio or the like, streamed from the streaming server computer 100.

The operation input device 161 can be of any type of device that allows the event administrator M to perform various operations, such as input and settings, related to the virtual live event, and may be constituted by at least one of, for example, a keyboard constituting a computer, a transparent touch panel formed on the surface of a display unit, and a viewpoint switching controller.

The various input/output devices connected to the input/output interface (I/F) 155 may be connected in either a wired or wireless manner.

In addition to an operating system (OS) for operating a computer, which is an administrator device 150, the storage device 153 stores an administrator-intended program for providing, when executed by a processor (CPU) 151 or the like, various functions including a streaming administering function of administering the streaming of a virtual live, which is virtual space content, in conjunction with the streaming server computer 100.

As shown in FIG. 6, the administrator-intended program includes, for example, an administrator-intended viewpoint visuals control program, an administrator-intended audio control program, an administrator-intended comment control program, a viewer management program, and a performer management program.

The administrator-intended viewpoint visuals control program is a program for providing a function of generating visuals from viewpoint of the respective virtual cameras to be displayed on the display unit 160, as well as a function of changing a viewpoint or switching between the viewpoints.

The administrator-intended audio control program is a program for providing a function of outputting live audio from the audio output device 162 based on the virtual live audio data streamed from the streaming server computer 100.

The administrator-intended comment control program is a program that displays comments based on comment data streamed from the streaming server computer 100, and provides comment-related functions, such as prohibiting comments from being streamed, and prohibiting comments from selected viewers to prevent them from being streamed.

The viewer management program is a program for administering viewer users who virtually participate in a virtual live, and the performer management program is a program for administering performer users who virtually participate in a virtual live.

Although not shown in FIG. 6, there are an authentication program for authenticating the identity of the administrator, who is an operator, and a scheduling program for editing the time schedule, music order, or the like of the virtual live, but other programs may also be included.

Accordingly, by having the event administrator M manipulate the administrator device 150 which constitutes the virtual space content streaming system according to Embodiment 1, it is possible to perform various settings for carrying out the event, such as settings relating to performance program items and order of music, settings related to performance renditions, the time schedule, and the trajectory or the like of the aerial-moving virtual camera during the flying performance period. The virtual live can be managed based on the settings thus configured.

### Virtual Live Venue

FIG. 12 shows a virtual live venue, which is in a virtual space, used in Embodiment 1. As shown in FIG. 12, the virtual live venue is in a virtual space which, similar to a live venue in real space, includes a virtual stage G where a performer user appears as a performer avatar 1, and a virtual audience region where viewer users virtually participate as viewer avatars.

As shown in FIG. 12, the virtual stage G has a trapezoidal floor surface with a relatively large area, and the performer avatar 1 can move around on the virtual stage G similarly to a live venue in real space. As shown in FIG. 12, virtual stage walls, which are constituted by three parts, a central part, a right part, and a left part, are formed on a side of the virtual stage G facing the virtual audience area, and virtual display areas 40, 41, 42 are provided on front surfaces on the virtual stage wall such that images for performance renditions and videos are virtually displayed on the virtual display areas 40, 41, 42.

Virtually-arranged objects 43 representing the stars, related to the performer user, are arranged between two virtual display areas among the virtual display areas 40, 41, 42, and virtual aerial objects 50-52, representing large stars, are arranged in a second region which is a region on the virtual stage G and which is located above a first region surrounded by the virtual stage walls, as shown in FIG. 12. The virtual aerial objects 50-52 are capable of moving within the second region.

A virtual audience region, where a viewer user can virtually participate in the virtual live venue as a viewer avatar, is provided in front of the virtual stage G. As shown in FIG. 12, the virtual audience region includes: a third region, which is a special region near the center of the virtual stage G on which the performer avatar 1 appears; and a fourth region, which is formed to surround the third region and is at a greater distance from the center of the virtual stage G than the third region.

In the third region, special viewer users who are allowed to participate virtually can participate virtually up to a predetermined upper limit. In Embodiment 1, as shown in FIG. 12, there are viewer avatars 11-14 corresponding to four viewer users, who have met a predetermined virtual participation record condition and have been allowed to participate virtually by the performer user, for example.

In the fourth region, there are viewer avatars 21-32 of general viewer users who have reserved virtual participation before the start of the virtual live. In FIG. 12, the viewer avatars 21-32 are shown in a simplified manner for the sake of simplicity, but are similar avatars to the viewer avatars 11-14.

The respective viewer avatars 11-14 arranged in the third region can be moved within the third region by the viewer user manipulating the viewer device, and the respective viewer avatars 21-32 arranged in the fourth region can be moved within the fourth region by the viewer user manipulating the viewer device as well.

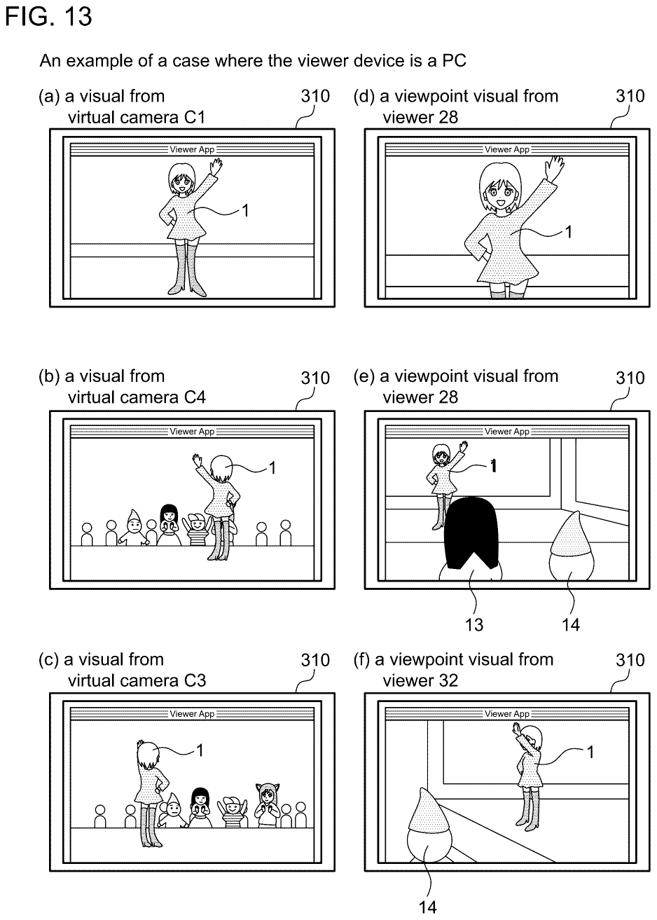

As shown in FIG. 12, four virtual cameras C1-C4 are virtually arranged (installed) in the virtual live venue. The virtual camera C1 is a virtual camera virtually arranged in front of the performer avatar 1 so as to face the performer avatar 1, and visuals from viewpoint of the virtual camera C1 are viewpoint visuals viewed from a position near the front of the performer avatar 1, as shown in (a) in FIG. 13.

The virtual camera C2 is a camera virtually arranged (installed) on the head of the performer avatar 1, and visuals from viewpoint of the virtual camera C2 are performer-viewpoint visuals viewed from the performer avatar 1 toward the virtual audience region, as shown in FIG. 15.

The virtual camera C3 is a virtual camera virtually arranged on the virtual display area 41 diagonally behind the performer avatar 1, and visuals from viewpoint of the virtual camera C3 are viewpoint visuals as viewed the virtual audience region from diagonally behind the performer avatar 1, as shown in (c) in FIG. 13.

The virtual camera C4 is a virtual camera virtually arranged on the virtual display area 42 diagonally behind the performer avatar 1, and visuals from viewpoint of the virtual camera C4 are viewpoint visuals as viewed the virtual audience region from diagonally behind the performer avatar 1, as shown in (b) in FIG. 13.

In Embodiment 1, in addition to the virtual cameras C1-C4 fixedly arranged (installed), an aerial-moving virtual camera (not illustrated) is virtually positioned so as to be movable in the air within the virtual space of the virtual live venue. The aerial trajectories along which the virtual cameras move in the air, as well as the viewpoint directions (angles) at the respective positions on the aerial trajectories, are preset by the administrator device 150. During the flying performance period described below, the performer avatar 1 virtually flies so that the aerial trajectory of the aerial-moving virtual camera is followed, thereby generating visuals from viewpoint of the virtually-flying performer avatar 1 captured by the aerial-moving virtual camera.

In Embodiment 1, as shown in FIG. 12, an example is given in which four virtual cameras C1-C4 are virtually arranged as fixedly arranged (installed) virtual cameras, but the present invention is not limited to this. The number of the fixedly arranged (installed) virtual cameras may be five or more, or conversely, without arranging a fixedly arranged (installed) virtual camera, only viewpoint visuals viewed from the viewpoints corresponding to the respective avatars virtually participating in the virtual live venue may be displayed on the performer device 200 or the viewer device 300.

In Embodiment 1, an example is given in which there is one aerial-moving virtual camera, but the present invention is not limited to this. It may also be possible to have a configuration in which there are a plurality of aerial-moving virtual cameras, or conversely, a configuration in which no aerial-moving virtual camera is virtually arranged.

### Studio

FIG. 11 shows a diagram illustrating the studio used in Embodiment 1. As mentioned above, there is a control room which is arranged adjacent to the studio and which is separated from the studio by a glass window. In the control room, an assisting operator O performs, for example, operation of the performer device 200 installed in the control room, while the performer user performs the respective motions, corresponding to singing, within the studio. Base station devices 220a and 220b are mounted on a stand around a performer user who is wearing wearable sensors 220c1-220c5, and an imaging camera constituting the facial expressions input device 221 is mounted on the stand in a position approximately in front of the performer user.

A screen S is installed in the studio on a wall facing the performer user. A projector (display unit B211) mounted on the ceiling of the studio projects visuals from viewpoint of the virtual camera C2 onto the screen S, such that visuals from viewpoint of the performer avatar 1 towards the virtual audience region are displayed on the screen S, as shown in FIG. 15. This allows the performer user to proceed with the live while continuously keeping track of the situations (reactions of the viewers to the live) of the viewer avatars virtually participating in the virtual audience region.

A large vertical display unit, which serves as a display unit C212, is arranged to the side of the screen S, and displays, for example, comments from the viewers and messages that the assisting operator O intends to convey to the performer user. The display unit C212 may be configured to display information (performer assisting information), such as lyrics of a song sung by the performers during the live, or lines to be spoken by the performer.

### Operation of Virtual Space Content Streaming System

FIG. 10 shows a diagram illustrating the operation of the virtual space content streaming system according to Embodiment 1, specifically, the flow of streaming of video and audio of a virtual live.

First, the video system will be described now. As described above, the streaming server computer 100 is capable of providing a virtual space of a virtual live venue based on the virtual space generation program 120 and, for example, avatar data of the performer user and viewer users. With respect to the motions or the like of the respective avatars of the performer user and viewer users, motions of the performer user is reflected in the motions of the performer avatar 1, and the motions (manipulations) of the viewer users are reflected in the motions of the viewer avatars, by updating the virtual space data describing the situations of the virtual space using performer avatar information transmitted from the performer device 200 and viewer avatar information transmitted from the viewer device 300.

Although not shown in FIG. 10, virtual space data of the virtual live venue is streamed from the streaming server computer 100 and stored in advance in the performer device 200 and the viewer device 300 in preparation of connecting to the streaming server computer 100 for virtually participating in the virtual live. As described below, the virtual space data stored in advance in this manner is sequentially updated by virtual space update data that is continuously streamed from the streaming server computer 100, allowing the latest situation of the virtual live venue to be determined in the performer device 200 and the viewer device 300.

Specifically, the motions and facial expressions of the performer user in the studio are scanned at predetermined time intervals by the functions of body motion scanning and face motion scanning of the performer avatar control program described above, thereby performer avatar information is generated and transmitted to the streaming server computer 100.

Meanwhile, the viewer users who are allowed to virtually participate in the third region use motion sensors, as in the performer, and therefore are scanned at predetermined intervals by the functions of the body motion scanning and face motion scanning, thereby viewer avatar information is generated and transmitted to the streaming server computer 100.

A viewer user who is allowed to virtually participate in the fourth region can cause the viewer avatar to perform corresponding motions by using a touch panel, a keyboard, or a controller of the viewer device 300 to perform various operations, such as a moving operation, an operation for changing the viewpoint direction, an operation for changing the viewpoint situation (zooming), an operation for raising hands, an operation for clapping hands, and an operation for jumping. Among the operations, viewer avatar information is generated based on operations related to motions of the viewer avatar to be transmitted to the streaming server computer 100.

The viewer user who is virtually participating in the third region can also perform various operations such as moving, changing the viewpoint situations (zooming), raising a hand, clapping hands, and jumping, using a controller, etc. In this case, menu items corresponding to the motions are displayed, and it is possible to select menu items corresponding to the respective motions using a controller, etc.

Accordingly, in the viewer device 300, avatar motion operation processing is executed in which operations corresponding to the motions to be performed by the viewer avatar are accepted. The avatar motion operation processing includes processing such as displaying and deleting menu items corresponding to the above-described respective motions.

Based on the performer avatar information thus transmitted from the performer device 200 and the viewer avatar information transmitted from the viewer device 300, the streaming server computer 100 executes virtual space update processing for updating virtual space data, thereby reflecting the motions (manipulations) of the performer user and the viewer user in the respective avatars virtually participating in the virtual live venue.

Then, after executing virtual space update data generation processing for generating virtual space update data based on pre-update virtual space data and post-update virtual space data, the generated virtual space update data is streamed to the performer device 200 and the viewer device 300.

As shown in FIG. 10, at the performer device 200 and the viewer devices 300 to which the virtual space update data has been streamed, the pre-stored virtual space data is updated based on the streamed virtual space update data, and performer-viewpoint visuals generation processing and viewer-viewpoint visuals generation processing which use the updated virtual space data are executed, thereby generating performer-viewpoint visuals and viewer-viewpoint visuals based on the updated virtual space data, and the generated performer-viewpoint visuals and viewer-viewpoint visuals are displayed on the performer device 200 and the viewer devices 300 (viewer-viewpoint visuals output processing).

Thus, in Embodiment 1, the visuals from viewpoint of each viewer user who is virtually participating in the virtual live venue through a viewer avatar are generated and displayed on the viewer device 300 side of the viewer user, and therefore it is possible to avoid a situation in which the processing load on the streaming server computer 100 becomes significantly large as a result of the viewer-avatar-viewpoint visuals of each viewer user being generated on the streaming server computer 100. Such a situation would result in many viewer users being unable to participate in the virtual live. It is also possible to avoid a situation in which streaming becomes difficult due to an increased processing load.

In Embodiment 1, viewpoint visuals are generated and displayed on the display unit 310 of the viewer device 300 of a viewer user corresponding to the viewer avatar 13 that is virtually participating in the third region near the performer avatar 1 on the virtual stage G, in which viewpoint visuals viewed substantially from the front of the performer avatar 1 are displayed large, as shown in (d) in FIG. 13, the viewpoint visuals being viewpoint visuals viewed from a viewer avatar 13 near the performer avatar 1. Meanwhile, visuals from viewpoint of a viewer avatar 28 that is positioned far from the performer avatar 1 on the virtual stage G are generated and displayed on the display unit 310 of the viewer device 300 of a viewer user corresponding to the viewer avatar 28 that is virtually participating in the fourth region far from the performer avatar 1, for example, at a position behind a viewer avatar 13, wherein the visuals of substantially the front side of the performer avatar 1 are displayed relatively small over the viewer avatar 13 and a viewer avatar 14 that are virtually participating in the third region, as shown in (e) in FIG. 13.

The display unit 310 of the viewer device 300 of a viewer user corresponding to a viewer avatar 32 that is virtually participating at a position near the edge of the virtual stage G in the fourth region, which is U-shaped when viewed from above, displays viewpoint visuals as viewed from the viewer avatar 32 positioned diagonally forward of the performer avatar 1, as shown in (f) in FIG. 13, in which the performer avatar 1 appears relatively small over a viewer avatar 14 that is virtually participating in the third region.

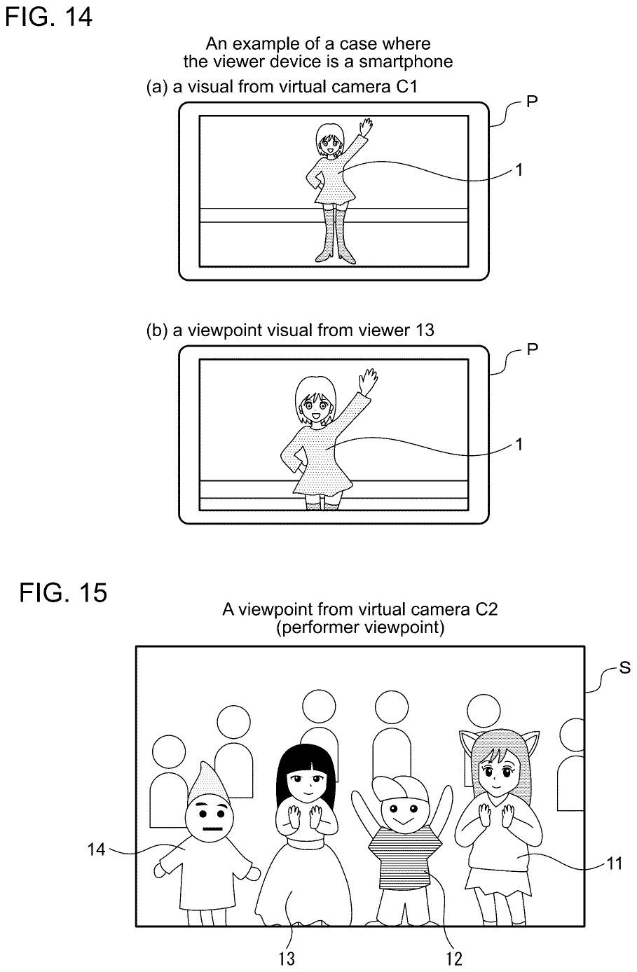

All of the display examples shown in (a) to (f) in FIG. 13 indicate cases where the viewer devices 300 are stationary computers (PC) and the display units 310 are stationary display units. However, for example, if a viewer device 300 is a smartphone P, a tablet device, or the like, the visuals from viewpoint of the virtual camera C1 are displayed as shown in (a) in FIG. 14, and if the viewer device 300 is a viewer device 300 of the viewer avatar 13, the viewpoint visuals are displayed as shown in (b) in FIG. 14.

The audio system will be described now. In the streaming server computer 100, music data 113 is played back by the audio control program 124 based on time schedule data (TS data) 112, and transmitted to the performer device 200 as playing music (data) (music playing processing).

In the performer device 200, the musical audio from the playing music (data) transmitted from the streaming server computer 100 is output to the performer user through high-performance earphones (in-ear monitors) worn by the performer user (playing music output processing), and when the performer user sings along with the playing music thus output, the performer audio input from a sound collection microphone (audio input device 222) is converted to data to be transmitted to the streaming server computer 100 as performer audio (data).

The streaming server computer 100 generates streaming audio (data) from the performer audio resulted from the performer audio (data) received from the performer device 200 and the playing music played by the music playing processing described above (streaming audio generation processing), and streams the generated streaming audio (data) to the viewer device 300 (generated audio streaming processing).

At the viewer device 300, the streaming audio resulted from the streaming audio (data) streamed from the streaming server computer 100 is output from an audio output device 322, such as earphones or a speaker, allowing the viewer to hear the live audio as if the performer avatar 1 were singing in the virtual live venue.

As described above, in the performer device 200, the performer audio (data) is transmitted to the streaming server computer 100, and as shown in FIG. 10, monitor audio generation processing and monitor audio output processing are executed, such that the musical audio of the playing music and the performer audio are output from a speaker arranged in the control room, allowing the assisting operator O or the like to check the situation of the singing of the performer user or the like in the control room.

### Viewer-Intended Viewpoint Visuals Control Processing

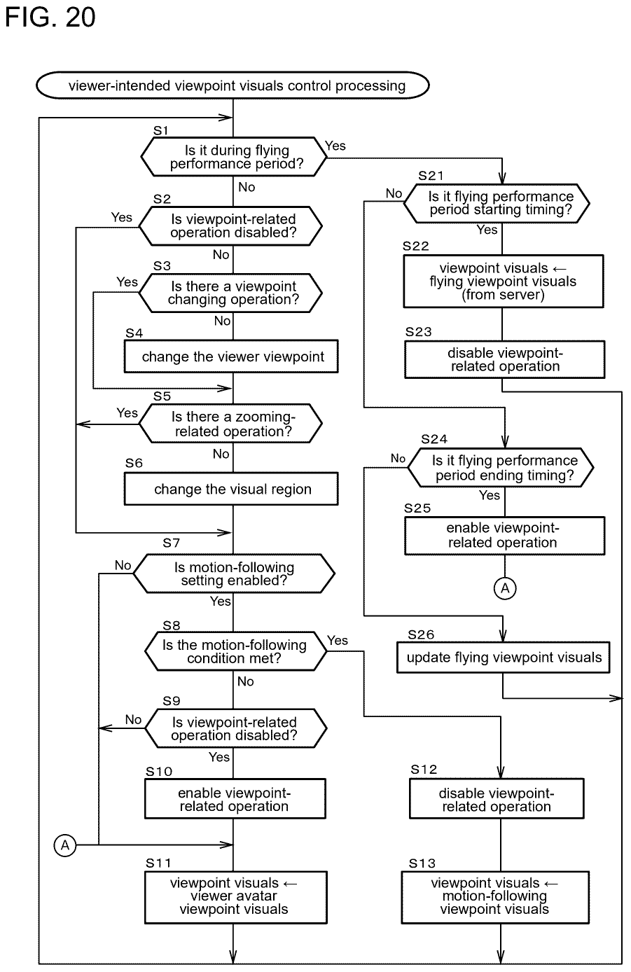

Viewer-intended viewpoint visuals control processing executed in the viewer device 300 based on the viewer-intended viewpoint visuals control program included in the viewer-intended program will be described with reference to FIG. 20.

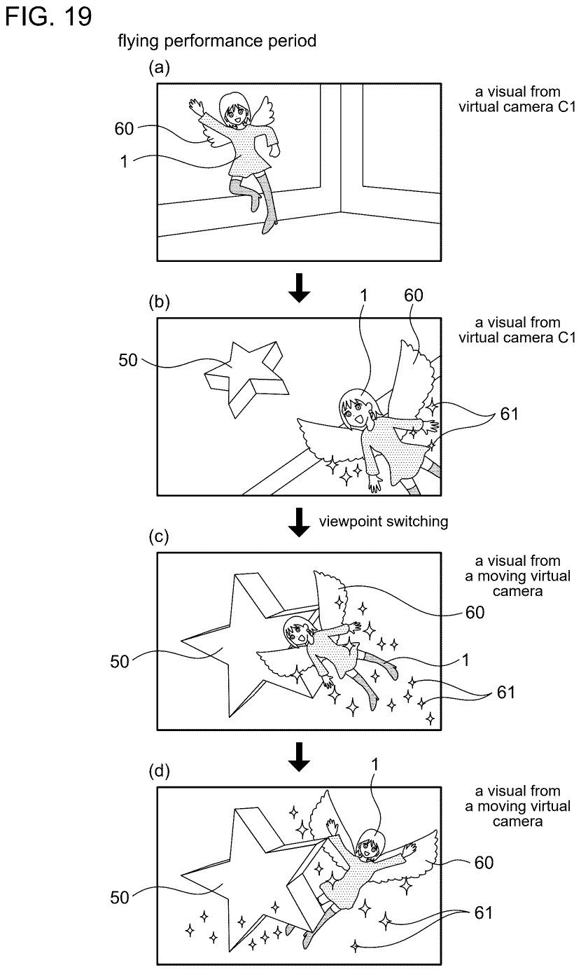

In the viewer-intended viewpoint visuals control processing, the process first determines whether or not the performer avatar 1 is in a flying performance period in which the performer avatar 1 is virtually flying as shown in FIG. 19 (step S1). Whether or not the flying performance period is in progress can be determined by performance rendition situation data, from the streaming server computer 100, indicating that the flying performance period is in progress. When entering into a flying performance period, the streaming server computer 100 transmits performance situation data indicating that a flying performance period is in progress to the viewer device 300 based on time schedule data.

If the flying performance period is in progress (Y in step S1), the process proceeds to step S21. If the flying performance period is not in progress (N in step S1), the process determines whether or not viewpoint-related operations including a viewpoint moving operation (including changes in viewpoint as a result of a moving operation or a motion operation of an avatar) and zooming-related operations are disabled (step S2).

If the viewpoint-related operation is disabled (Y in step S2), the process proceeds to step S7. If the viewpoint-related operation is not disabled (N in step S2), the process determines whether or not there is an operation, such as a moving operation or a motion operation, for changing the viewpoint of the avatar (step S3). If there is such an operation (Y in step S3), the process changes the viewer-viewpoint according to the operation. If there is no such operation (N in step S3), the process proceeds to step S5, where the process determines whether or not there is a zooming-related operation (step S5).

If there is a zooming-related operation (Y in step S5), the process changes the visual region displayed on the display unit 310 to a visual region corresponding to the operation. If there is no zooming-related operation (N in step S5), the process determines whether or not a motion-following setting is enabled (step S7).

In the motion-following setting, the viewer user can arbitrarily perform settings on the viewer device 300, for example, before the start of a live or during the live, depending on the type of device one uses for operation and the level of proficiency in operation. Specifically, such settings are performed on cases, such as a case where the user is not familiar with the operation of the operation input device 321 such as a touch panel, a keyboard, or a game controller to be used, a case where the user is not familiar with changing the viewpoint by the moving operation or the motion operation of the avatar, or a case where, as described below, the user is unable to change the viewpoint properly in response to the move or motion of the performer avatar 1 such as cases where the performer avatar 1 cannot be displayed appropriately as a result of a small motion of the performer avatar 1 because the virtual participation position of the viewer avatar is far from the performer avatar 1 and the display is zoomed in.

If the motion-following setting is disabled (N in step S7), the process proceeds to step S11. If the motion-following setting is enabled (Y in step S7), the process further determines whether or not a motion-following condition is met (step S8).

In Embodiment 1, a motion-following condition is a condition that almost certainly results in the performer avatar 1 no longer being displayed well on the display unit 310. Specifically, when the head (or may be the face) of the performer avatar 1 is within a predetermined range around the display area of the display unit 310, the process determines that the motion-following condition is met because there is an extremely high possibility that the performer avatar 1 is not displayed properly as a result of the head (face) moving outside the display area with the move or motion of the performer avatar 1.

Accordingly, in Embodiment 1, the occurrence of the head (face) of the performer avatar 1 disappearing from the display area is significantly reduced by determining that the motion-following condition is met before the head (face) of the performer avatar 1 disappears from the display area, but the present invention is not limited to this. Such a motion-following condition may be based on the head (face) moving outside the display area, or other conditions may be used as the motion-following condition. That is, any condition can be used as the motion-following condition as long as it is possible to prevent the performer avatar 1 from being no longer displayed well in the display area.

If the motion-following condition is met (Y in step S8), the viewpoint-related operation is disabled (step S12). Thereafter, the viewpoint is automatically changed to a motion-following viewpoint in which the head (face) of the performer avatar 1 is within a condition non-fulfillment range surrounded by a predetermined range around the display area, in the viewpoint visuals displayed on the display area of the display unit 310, and the viewpoint visuals viewed from the motion-following viewpoint are displayed on the display area of the display unit 310 (step S13).

Meanwhile, if the motion-following condition is not met (N in step S8), the process further determines whether or not the viewpoint-related operation is disabled (step S9). If the viewpoint-related operation is disabled (Y in step S9), the disabled viewpoint-related operation is enabled (step S10) and then the process proceeds to step S11. If the viewpoint-related operation is not disabled (N in step S9), the process proceeds to step S11 without going through step S10.

In step S11, as a result of the motion-following setting being disabled or the motion-following condition being not met, the visuals from viewpoint of the viewer avatar are continuously displayed on the display area of the display unit 310 (step S11).

As mentioned above, if the flying performance period in which the performer avatar 1 is virtually flying has begun during the live, the process determines Yes in step S1 to proceed to step S21, where the process determines whether or not it is the start timing of the flying performance period (step S21).

If it is the start timing of the flying performance period (Y in step S21), the process displays the flying viewpoint visuals streamed from the streaming server computer 100 (step S22) instead of the visuals or the motion-following visuals from viewpoint of the viewer avatar displayed on the display area of the display unit 310 before the start of the flying performance period. Then, the viewpoint-related operation is disabled (step S23) and the process returns to step S1.

In Embodiment 1, the same flying viewpoint visuals are displayed on viewer devices 300 for all the viewer users during the flying performance period. Therefore, the flying viewpoint visuals, which impose a large rendering load when rendering the viewpoint visuals because such performance involves an aerial move, can be displayed well even on viewer devices 300 with low processing capabilities. This is accomplished by generating the flying viewpoint visuals on the streaming server computer 100 side to be streamed to the viewer devices 300, instead of generating the flying viewpoint visuals on the side of the respective viewer devices 300 as is the case with viewer-avatar-viewpoint visuals that are different for each viewer user. However, the present invention is not limited to this. Such flying viewpoint visuals may be generated on the respective viewer devices 300 side, as in the viewer-avatar-viewpoint visuals.

Meanwhile, if it is not the start timing of the flying performance period (N in step S21), the process further determines whether it is the end timing of the flying performance period (step S24).

Whether or not it is the end timing of the flying performance period may be determined based on data indicating the end included in the flying viewpoint visuals data transmitted from the streaming server computer 100, or may be determined based on the aforementioned performance situation data that is different from the flying viewpoint visuals.

If it is not the end timing of the flying performance period (N in step S24), that is, if it is during the flying performance period, the process proceeds to step S26, where the flying viewpoint visuals are updated. Then, the process returns to step 1. Meanwhile, if it is the end timing of the flying performance period (Y in step S24), the viewpoint-related operation is enabled (step S25). Then, the process proceeds to step S11, where the visuals from viewpoint of the viewer avatar are displayed on the display area of display unit 310 instead of the flying viewpoint visuals that have been displayed on the display area of the display unit 310 during the flying performance period. Then, the process returns to step S1.

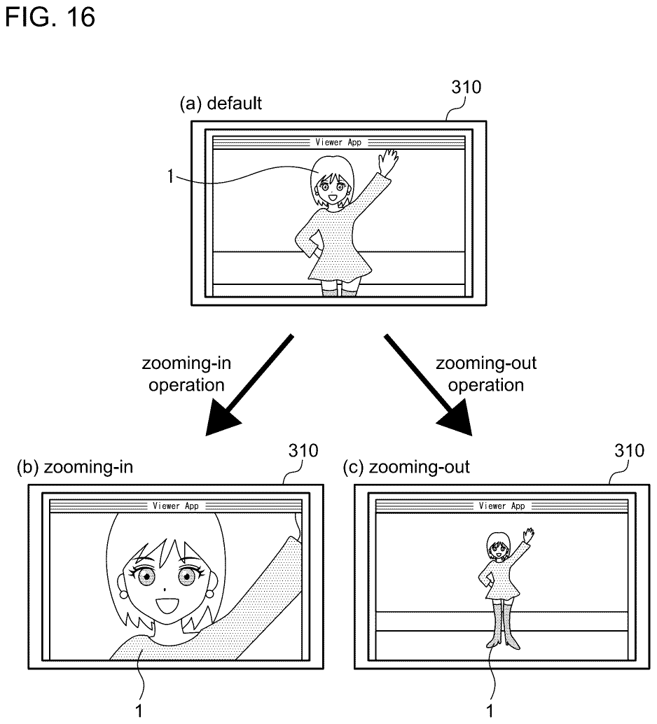

The respective viewpoint visuals displayed on the viewer device 300 in Embodiment 1 as a result of the viewer-intended viewpoint visuals control processing shown in FIG. 20 being executed in the viewer device 300 will be described with reference to FIGS. 16-19.

FIG. 16 shows a diagram illustrating the display details of the display unit 310 when a zooming-related operation is performed on the viewer device 300 according to Embodiment 1. In the default state where no zooming-related operation is performed, viewpoint visuals of a visual region centered on the upper body of the performer avatar 1 are displayed, as shown in (a) in FIG. 16. In the default state, when the viewer user performs a zooming-in operation, for example, by touching a “+” indication (not illustrated) if the viewer device 300 is a smartphone P, or by operating a “+” key on the keyboard if the viewer device 300 is a computer (PC), viewpoint visuals of the visual region centered on the head (face) of the performer avatar 1 are displayed, as shown in (b) in FIG. 16, for example.

Meanwhile, when the viewer user performs a zooming-out operation, for example, by touching a “−” indication (not illustrated) if the viewer device 300 is a smartphone P, or by operating a “−” key on the keyboard if the viewer device 300 is a computer (PC), viewpoint visuals of the visual region including the entire body of the performer avatar 1 are displayed, as shown in (c) in FIG. 16, for example.

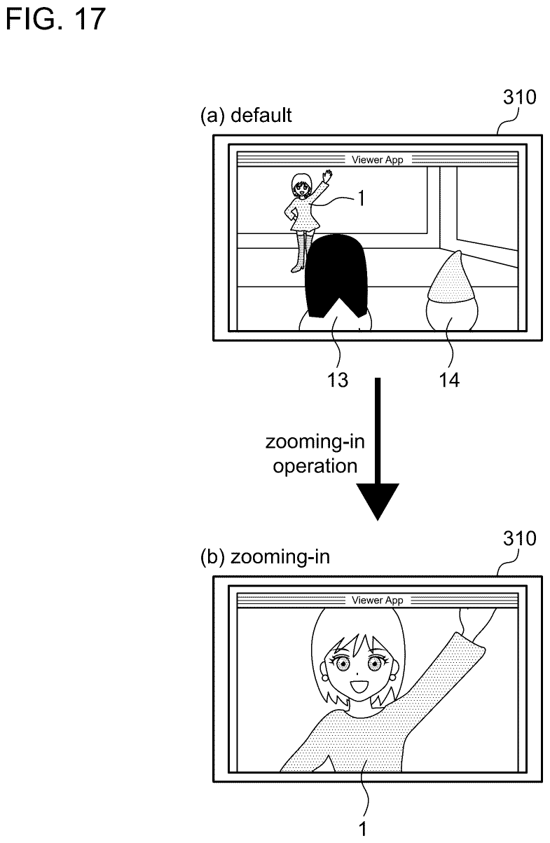

In FIG. 16, the explanation is given using the visuals from viewpoint of a virtual camera C1 rather than visuals from viewpoint of the viewer avatar in order to make the zooming functionality easier to understand. However, as shown in FIG. 17, zooming-in and zooming-out can also be performed on the viewpoint of the viewer avatar similarly.

In the viewer-intended viewpoint visuals control processing of FIG. 20, although not described in detail, for example, when a performer avatar 1 appears on the virtual stage G for the first time, the viewpoint of the viewer avatar is not directed toward the performer avatar 1 when the live begins. Accordingly, there is a possibility that the appearing performer avatar 1 will not be displayed on the viewer device 300 for a long period of time. Therefore, it may be configured such that the period when the performer avatar 1 first appears or the like may be set as an appearance performance period or the like, and during this performance period, the respective viewer users may be allowed to display the viewpoint visuals on the viewer device 300 by being automatically switched to the visuals from viewpoint of the virtual camera C1 or the like, instead of the visuals from viewpoint of the viewer avatar, and to perform zooming-in or the like on such visuals from viewpoint of the virtual camera C1.

FIG. 17 shows, as an example of the visuals from viewpoint of the viewer avatar, visuals from viewpoint of a viewer avatar 28 virtually participating in the fourth region. As shown in FIG. 17, the visuals from viewpoint of the viewer avatar 28 include heads of the viewer avatar 13 and the viewer avatar 14 that are virtually participating in the third region, and are visuals showing the performer avatar 1 over the heads of the viewer avatar 13 and the viewer avatar 14.

Therefore, the viewer user of the viewer avatar 28 can enjoy the live by, for example, performing a zooming-in operation to change the visual region to a visual region where the upper body of the performer avatar 1 is displayed primarily, as shown in (b) in FIG. 17, thereby preventing the viewer avatar 13 and the viewer avatar 14 from being displayed.

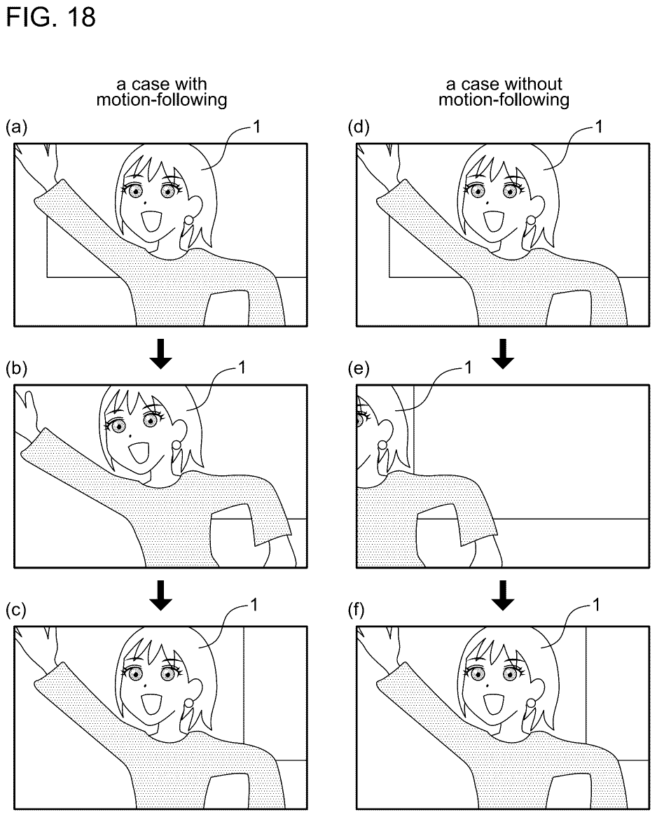

However, in the zoomed-in state as shown in (b) in FIG. 17, for example, as the live progresses and the performer avatar 1 begins to move and make large motion, there are cases where the performer avatar 1 cannot be displayed properly as shown in (d) to (f) in FIG. 18 if the viewer user is unable to properly change the viewpoint of the viewer avatar 28 in accordance with the motion of the performer avatar 1. Therefore, there are cases where the viewers cannot concentrate on the live by paying attention to adjusting the viewpoints, making it unable to enjoy the live greatly.

However, in Embodiment 1, when the viewer user enables the motion-following setting as described above, the motion-following condition is met by the head of the performer avatar 1 entering within a predetermined region surrounding the display area, such that the viewpoint is automatically changed to the motion-following viewpoint, and the visuals from the motion-following viewpoint are displayed, as shown in (a) to (c) in FIG. 18. Therefore, the viewer user does not need to pay attention to the operation of the viewpoint, making it possible to concentrate on the live and enjoy the live greatly.

Then, as the live progresses and the flying performance period begins, the viewpoint visuals are automatically changed from the visuals from viewpoint of the individual viewer avatars to flying viewpoint visuals as viewed from an aerial-moving virtual camera, as shown in FIG. 19, without any operation by the viewer user.

Specifically, visuals are displayed in which objects of wings grow larger on the back of the performer avatar 1 before the performer avatar 1 begins a virtual flying motion. Then, the viewpoint of the viewer avatar also moves in a similar manner as the performer avatar 1 looks up at a virtual aerial star object 50 virtually arranged in the second region of the virtual live venue. At this time, a light effect 61 appears around the performer avatar 1.

Thereafter, when the performer avatar 1 begins a virtual flying motion, the viewpoint visuals displayed on the display unit 310 automatically switch from visuals from viewpoint of the viewer avatar up to (b) in FIG. 19 to flying visuals from viewpoint of an aerial-moving virtual camera, as shown in (c) in FIG. 19.

During the flying performance period, the aerial-moving virtual camera moves through the air within the second region based on a predetermined aerial trajectory as described above, and the flying viewpoint visuals viewed from the aerial-moving virtual camera are displayed on the display unit 310 as shown in (d) in FIG. 19.

### Variation Example of Embodiment 1

In Embodiment 1 described above, a general motion (first motion) is a motion of the performer avatar 1 standing without moving on the virtual stage G, a special motion (second motion) is a motion of the performer avatar 1 performing a virtual flying performance, and a specific motion (third motion) is a motion of the performer avatar 1 moving rapidly sideways. However, the present invention is not limited to this. The motions may be motions corresponding to the content to be streamed. For example, it may be preferable if the general motion (first motion) is a motion (normal motion) that the performer avatar performs for the longest period of time in the streamed content, the special motion (second motion) is a motion that is performed in a special period that is the shortest period of time in the streamed content or a motion that is performed least frequently, and the specific motion (third motion) may be a motion that is performed for a shorter period of time than the general motion (first motion) but a longer period of time than the special motion, or a motion that is performed less frequently than the general motion (first motion) but more frequently than the special motion. There may be cases where the special motion (second motion) includes a specific motion (third motion).

In Embodiment 1 described above, an example is given of a form having both a function of switching the viewpoint to a viewpoint corresponding to a special motion (second motion) and a following function of following a specific motion (third motion), but the present invention is not limited to this. The virtual space content streaming system may have only one of said functions.

In Embodiment 1 described above, an example is given of a form in which the viewpoint of the viewer user is changed and followed in accordance with the motion of the performer avatar, but the present invention is not limited to this. For example, it may be preferable if the change and following of the viewpoint are performed in accordance with specific performance renditions such as smoke or fireworks (pillars of fire), which are performance rendition devices on the virtual stage G, special lighting, deformation of the virtual stage G, etc.

### Embodiment 2

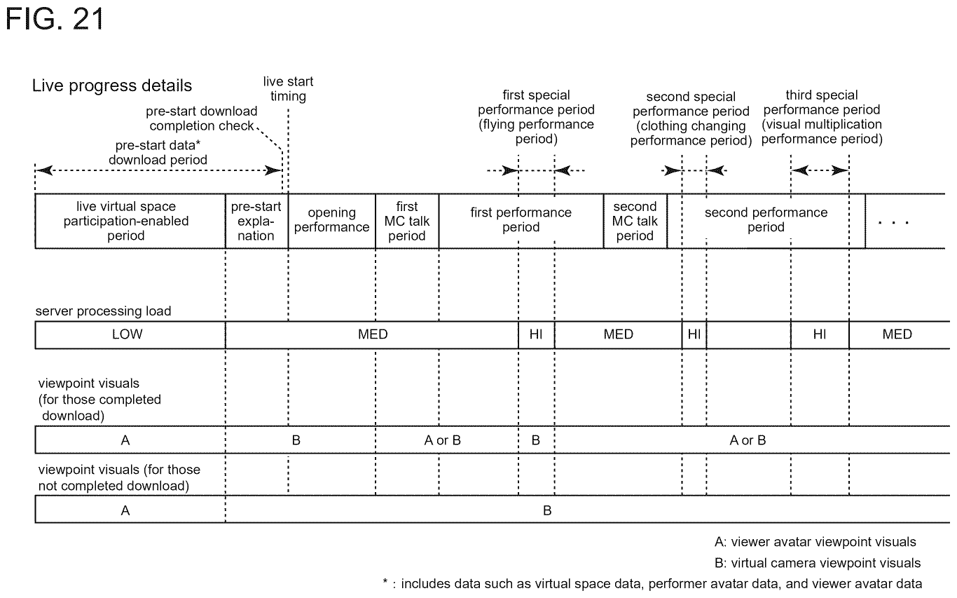

Next, a virtual space content streaming system according to Embodiment 2 will be described now with reference to FIGS. 21-28. The same components as those in Embodiment 1 are denoted by the same reference numerals and the description thereof will be omitted.

The configuration of the virtual space content streaming system according to Embodiment 2 is the same as that of Embodiment 1 shown in FIG. 1. However, the progress details of the virtual live are different, and the period during which viewpoint visuals of viewpoint from the virtual cameras C1-C4 and the aerial-moving virtual camera (hereinafter collectively referred to as “virtual-camera-viewpoint visuals”) are streamed and an object that generates the virtual-camera-viewpoint visuals is different from that of Embodiment 1, which is a characteristic feature of Embodiment 2.

FIG. 21 shows a diagram illustrating the progress details of the virtual live to be streamed in the virtual space content streaming system according to Embodiment 2. In the virtual live according to Embodiment 2, first, there are “live virtual space participation-enabled period” and “pre-start explanation” period as periods before the start of the virtual live. Viewer users can virtually participate in the virtual live venue, which is in the virtual space, of the virtual live, during the live virtual space participation-enabled period.

The period up to the timing for checking completion of the pre-start download, which is set just before the end of the “pre-start explanation” period, is a pre-start data download (DL) period, during which virtual space data (basic data) of the virtual live venue, avatar data of performer avatar 1, and avatar data of viewer users who have virtually participated are downloaded as pre-start data from the streaming server computer 100 to the viewer device 300 of the viewer user who has virtually participated during the live virtual space participation-enabled period.

At the pre-start data download completion check timing, which is at an end of the pre-start data download period, it is checked whether or not the pre-start data download is completed in each viewer device 300.

During the “pre-start explanation” period, explanations about the virtual live are provided via video visuals or the like. Therefore, by making the “pre-start explanation” period available for downloading the pre-start data, each viewer device 300 is able to download from the streaming server computer 100 even avatar data of viewer avatars who have virtually participated in the live virtual space just before the end of the live virtual space participation-enabled period.

As shown in FIG. 21, the virtual live according to Embodiment 2 progresses in the order of “opening performance”, followed by “first MC talk”, followed by “first performance”, followed by “second MC talk”, followed by “second performance”, and so on. The “opening performance” is a performance in which the performer avatar 1 appears on the virtual stage G. In the “first MC talk”, the performer avatar 1 who has appeared on the virtual stage G greets the audience through a talk, while also introducing the first performance, which will be performed first. The “first performance” includes singing and dancing by the performer avatar 1 (performer), and includes in the midway of the first performance a flying performance in which visuals of the performer avatar 1 who is virtually flying in the virtual live venue are taken virtually from an aerial-moving virtual camera. In the “second MC talk”, the performer avatar 1 (performer) mainly introduces the second performance through a talk. The “second performance” includes singing and dancing by the performer avatar 1 (performer), and includes in the midway of the second performance the following: a costume changing performance using visuals of the performer avatar 1 changing costumes, virtually taken from the virtual camera C1; and an illusionary clone performance using visuals, virtually taken from the virtual camera C1, of a situation where the performer avatar 1 is cloned into a plurality of avatars.

The processing load on the streaming server computer 100 during each period when the performance, program, etc., are executed is “LOW”, which is the lowest, during the live virtual space participation-enabled period. Meanwhile, it is “HI”, which is the highest, during the period when a special performance, such as “flying performance”, “costume changing performance”, and “illusionary clone performance”, is executed. The processing load on the streaming server computer 100 is “MEDIUM” during the period of “pre-start explanation”, “opening performance”, “first MC talk”, and the period before “flying performance” in “first performance”. It is also “MEDIUM” during the period after “flying performance” in the “first performance”, and the period of “second MC talk”, and before “costume changing performance” in the “second performance” period. It is also “MEDIUM” during the period after the “costume changing performance” and before “illusionary clone performance” in the “second performance”, and the period after the “illusionary clone performance” in the “second performance”. It is also “MEDIUM” during the period after the “illusionary clone performance” in the “second performance” in the “second performance”.

Next, the viewpoint visuals that can be viewed on the viewer device 300 during each period in the virtual live according to Embodiment 2 will be described now. During the live virtual space participation-enabled period from the time of virtual participation until the start of the “pre-start explanation”, only the viewer-avatar-viewpoint visuals can be displayed on the viewer device 300.

Then, when the “pre-start explanation” starts, only the virtual-camera-viewpoint visuals, specifically, the viewpoint visuals of the virtual camera C1, can be displayed. Accordingly, only the virtual-camera-viewpoint visuals can be displayed during the “pre-start explanation” even though it is before start of a virtual live. This intends to prevent viewer users from not viewing the pre-start explanation that takes place on the virtual stage G as a result of the viewer viewing viewer-avatar-viewpoint visuals by displaying the viewer-avatar-viewpoint visuals on the viewer device 300. The pre-start explanation includes explanations, such as points to note, regarding the virtual live.

As described below, the virtual-camera-viewpoint visuals of the “pre-start explanation” are generated in the streaming server computer 100 to be streamed to the respective viewer devices 300, and therefore can be displayed even on a viewer device 300 that have not yet completed downloading the pre-start data.

For viewer devices 300 that have completed the download of pre-start data at the above-described pre-start data download completion check timing, viewer-avatar-viewpoint visuals can be displayed in addition to virtual-camera-viewpoint visuals during the “first MS talk” period, and the period before the “flying performance” period in the “first performance” period, and the period after the “flying performance” period.

Meanwhile, for viewer devices 300 that have not completed downloading the pre-start data at the above-described pre-start data download completion check timing, the viewer-avatar-viewpoint visuals cannot be accurately generated, and therefore only the virtual-camera-viewpoint visuals can be displayed during the entire period of the virtual live by streaming the virtual-camera-viewpoint visuals generated in the streaming server computer 100, and it is not possible to display the viewer-avatar-viewpoint visuals.

In addition, among visuals of the “flying performance”, “costume changing performance”, and “illusionary clone performance”, during the period of which the processing load is “HI” on the streaming server computer 100, virtual-camera-viewpoint visuals of viewpoint from the virtual camera C1 for the “costume changing performance” and “illusionary clone performance” can be generated on the respective viewer devices 300 rather than on the streaming server computer 100, as in generating the virtual-camera-viewpoint visuals during the second performance period excluding the periods of “costume changing performance” and “illusionary clone performance”. Thereby, it is possible to reduce the processing load on the streaming server computer 100 for generating the virtual-camera-viewpoint visuals of the virtual camera C1 for the “costume changing performance” and “illusionary clone performance”.

Since the processing load for the “flying performance” period is high on the streaming server computer 100, the virtual-camera-viewpoint visuals may be generated on the viewer device 300, as in the “costume changing performance” and “illusionary clone performance”. In this case, detailed trajectory data of moving trajectories of an aerial-moving virtual camera moving in the virtual live venue needs to be streamed in advance to each viewer device 300 to generate the visuals. Accordingly, in Embodiment 2, visuals of the “flying performance” are generated and streamed on the streaming server computer 100 side, but the present invention is not limited to this. Such visuals may also be generated at each viewer device 300 in order to reduce the processing load on the streaming server computer 100.

Here, a participant user table used in the streaming server computer 100 according to Embodiment 2 will be briefly described now with reference to FIG. 23.

The participant user table is a data table used to allow identification of, for example, a participation situation of the viewer user in a virtual live event, and a download situation of pre-start data, for each virtual live event registered in the event data shown in FIG. 7. As shown in FIG. 23, the participant user table can store, in correspondence with the participant ID (viewer user ID), data such as participation identification data (participation identification flag) for identifying the participation situation of the participant (viewer user), a participating area of the participant (viewer user), and pre-start data download identification data (pre-start data download identification flag) for identifying the download situation of the pre-start data.

In the participant ID field, all viewer user IDs of prospective participants described in a file of each participant group stored in the event data in correspondence with the virtual live are registered to be used.

The participation identification data (participation identification flag) is registered as “0”, which indicates a non-participation state, when the participant ID (viewer user ID) is registered, and is updated to “1”, which indicates participation, when the participation of the participant (viewer user) is allowed through authentication. Therefore, by using the participation identification data (participation identification flag), it is possible to identify, among the participation-prospective viewer users, those who are participating and those who could not participate for some reason.

The participating area data is data for identifying whether the participating area of the participant (viewer user) is the third region or the fourth region and is registered when the participation of each participant (viewer user) is allowed by authentication.

The pre-start data download identification data (pre-start data download identification flag) is updated from “0”, which indicates “not completed”, to “1”, which indicates “completed”, based on a check as to whether the download of the pre-start data is completed at the pre-start data download completion check timing described above. Therefore, by using the pre-start data download identification data (pre-start data download identification flag), it is possible to easily identify all participants (viewer users) who have not yet completed downloading the pre-start data among the participants (viewer users) who are virtually participating.

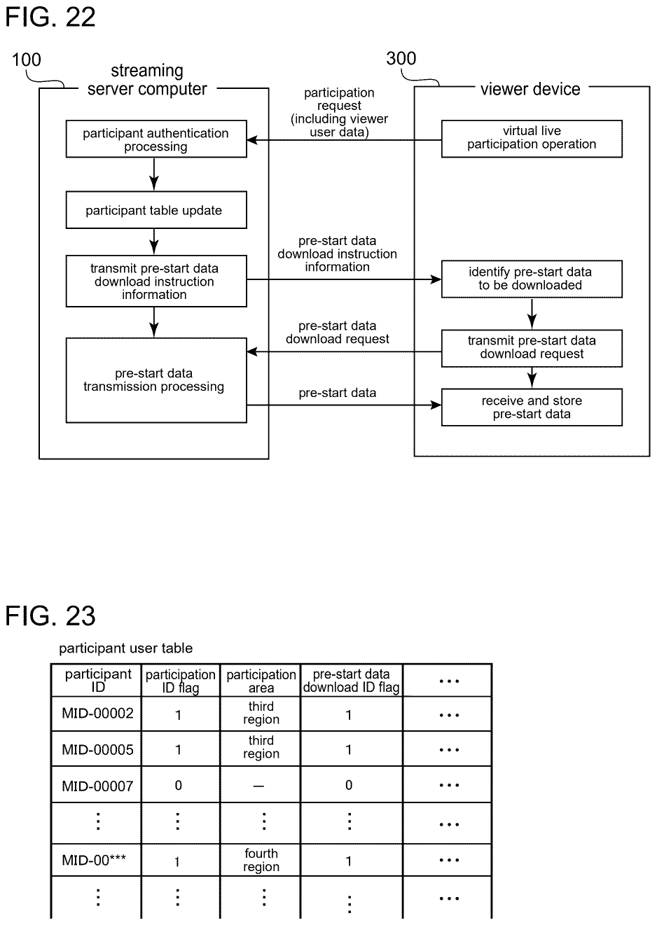

Next, a flow of downloading pre-start data when a viewer user virtually participates in a virtual live venue according to Embodiment 2 will be described with reference to FIG. 22.

First, the viewer user performs an operation to participate in a virtual live in which the viewer user plans to virtually participate, for example, by selecting a participation menu or operating a specific key, on a keyboard, to which the participation operation is assigned, in a viewer-intended program (viewer app) running on the viewer device 300.

By executing the participation operation, a participation request including the viewer user ID and authentication data for authenticating the viewer user is transmitted from the viewer device 300 to the streaming server computer 100.

The streaming server computer 100 that has received the participation request executes participant authentication processing on a condition that it is in a live virtual space participation-enabled period. In the participant authentication processing, it is determined whether the viewer user is a prospective participant of the corresponding virtual live based on whether the viewer user ID included in the received participation request is registered as a participant ID in the participant user database corresponding to the participating virtual live. In addition, the viewer user is authenticated by comparing the authentication data included in the participation request with the authentication data described in the authentication information file identified by the authentication information file data stored in correspondence with the viewer user ID in the viewer user data shown in FIG. 9.

If the viewer user is a prospective participant and has been authenticated using the authentication data, the participant identification data (participation identification flag) in the participant user table is updated to “1”, which indicates “participation”.

The streaming server computer 100 then transmits (responds to) pre-start data download instruction information to the viewer device 300 that has transmitted the participation request, in order to cause the viewer device 300 to download pre-start data corresponding to the participating virtual live. The viewer device 300 can confirm that participation has been allowed by receiving the pre-start data download instruction information.

In response to receiving the pre-start data download instruction information, the viewer device 300 identifies the pre-start data to be downloaded, and transmits to the streaming server computer 100 a pre-start data download request requesting the download of the identified pre-start data.

In response to receiving the pre-start data download request, the streaming server computer 100 executes pre-start data transmission processing.

In the pre-start data transmission processing, the requested pre-start data is transmitted to the viewer device 300 that has transmitted the pre-start data download request. As mentioned above, the pre-start data includes, for example, virtual space data (basic data) of the virtual live venue, avatar data of performer avatar 1, and avatar data of viewer users who are already virtually participating.

In the pre-start data transmission processing, avatar data of the viewer user who has transmitted the pre-start data download request is additionally streamed as pre-start data to viewer devices 300 other than the viewer device 300 that has transmitted the pre-start data download request and that of a viewer user whose participation has already been confirmed by the participant data table. As a result, avatar data of all viewer users virtually participating in the virtual live is streamed in advance to and stored in the viewer device 300 of each viewer user virtually participating in the virtual live, together with the virtual space data (basic data) and the avatar data of the performer avatar.

Then, at the pre-start data download completion check timing described above (see FIG. 21), the pre-start data stored in the viewer device 300 is checked to find out whether or not all of the pre-start data has been downloaded, and if the pre-start data download has been completed, the pre-start data download identification data (pre-start data download identification flag) in the participant user table is updated from “0”, which indicates “not completed”, to “1”, which indicates “completed”.

For participants (viewer users) whose pre-start data download identification data (pre-start data download identification flag) remains “0”, which indicates “not completed”, as a result of the pre-start data download being not completed, only the virtual-camera-viewpoint visuals can be displayed as described above.

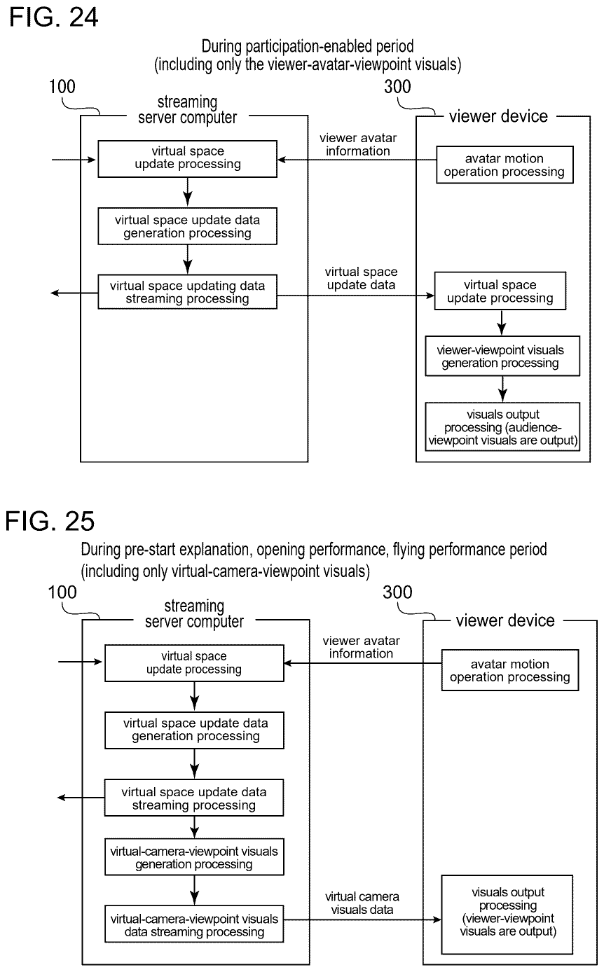

Next, a situation will be described-referencing FIGS. 24-27-in which the object, from which various viewpoint visuals are generated for display on the viewer device 300, undergoes a change.

First, during the live virtual space participation-enabled period when only the viewer-avatar-viewpoint visuals can be displayed on the viewer device 300, the virtual space data that has been stored in the viewer device 300 as a result of receiving the pre-start data is successively updated based on the virtual space update data which is transmitted from the streaming server computer 100 and which includes performer-avatar-intended motion data for generating motions of the performer avatar 1 who performs motions in conjunction with the motions of the performer user, as shown in FIG. 24. Then, viewer-viewpoint visuals generation processing is executed in the viewer device 300 based on the updated virtual space data to generate viewer-avatar-viewpoint visuals, which is then output (displayed) by the visuals output processing.

Although the performer device 200 is omitted in FIG. 24, the virtual space update data is also transmitted to the performer device 200 in Embodiment 1 as shown in FIG. 10.

During the periods of “pre-start explanation”, “opening performance”, and “flying performance”, in which only virtual-camera-viewpoint visuals can be displayed on the viewer device 300, virtual space update data is transmitted only to the performer device 200 in the virtual space update data streaming processing in the streaming server computer 100, as shown in FIG. 25. Then, following the virtual space update data streaming processing, virtual-camera-viewpoint visuals generation processing is executed in which virtual-camera-viewpoint visuals are generated, and virtual-camera-viewpoint visuals data streaming processing is executed in which the visuals data of the virtual-camera-viewpoint visuals generated in the virtual-camera-viewpoint visuals generation processing is streamed to all viewer devices 300 participating in the virtual live.

The virtual-camera-viewpoint visuals data streamed from the streaming server computer 100 in the virtual-camera-viewpoint visuals data streaming processing is displayed as a result of the visuals output processing being executed in the viewer device 300 that has received the virtual-camera-viewpoint visuals data.

That is, as shown in FIG. 27, for the periods of “pre-start explanation”, “opening performance”, and “flying performance” when only the virtual-camera-viewpoint visuals can be displayed, the virtual-camera-viewpoint visuals are generated in the streaming server computer 100.

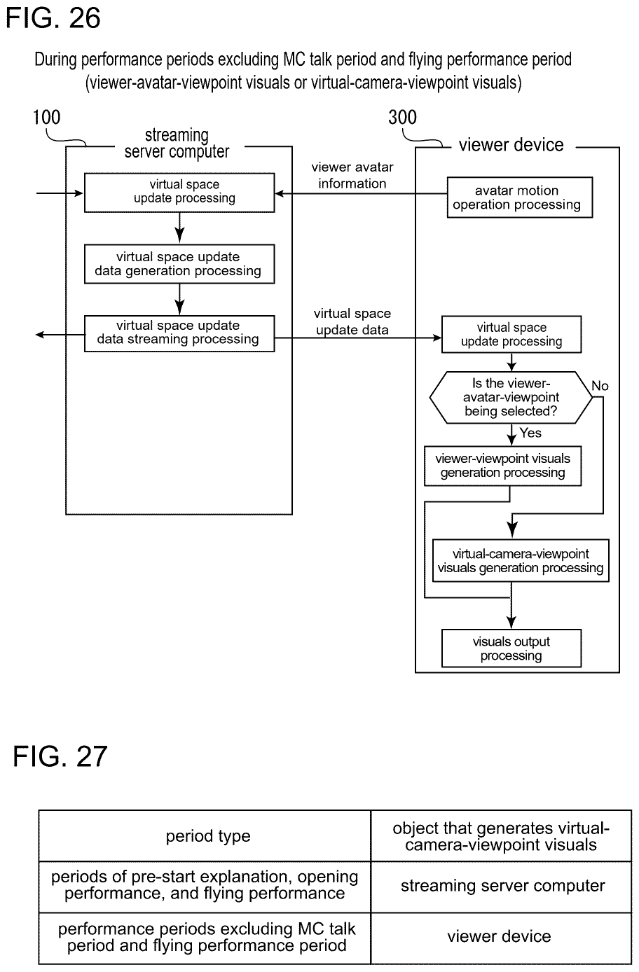

During the performance periods excluding the MC talk period and the flying performance period, which are periods when either the viewer-avatar-viewpoint visuals or the virtual-camera-viewpoint visuals can be selected to be displayed on the viewer device 300, the virtual space update processing is executed in the viewer device 300 by the virtual space update data being streamed to the viewer device 300 of each viewer user participating in the virtual live as a result of the virtual space update data streaming processing being executed in the streaming server computer 100, as shown in FIG. 26.

Then, in the viewer device 300, it is determined whether or not viewer-avatar-viewpoint visuals have been selected as the visuals to be displayed. If viewer-avatar-viewpoint visuals are selected, viewer-avatar-viewpoint visuals generation processing is executed to generate viewer-avatar-viewpoint visuals, and the generated viewer-avatar-viewpoint visuals are displayed by visuals output processing, similarly to the flow shown in FIG. 24.

Meanwhile, when the viewer-avatar-viewpoint visuals are not selected as the visuals to be displayed, i.e., when the virtual-camera-viewpoint visuals are selected as the visuals to be displayed, virtual-camera-viewpoint visuals generation processing is executed in the viewer device 300 to generate virtual-camera-viewpoint visuals and display the generated virtual-camera-viewpoint visuals in the visuals output processing.

Which viewpoint of the virtual cameras C1, C3, or C4 the virtual-camera-viewpoint visuals generated in the virtual-camera-viewpoint visuals generation should be may be selected by the viewer user, or may be instructed by the streaming server computer 100 to all viewer devices 300.

That is, as shown in FIG. 27, during performance periods excluding the MC talk period and the flying performance period, which are periods when either the virtual-camera-viewpoint visuals or the viewer-avatar-viewpoint visuals can be displayed on the viewer device 300, the virtual-camera-viewpoint visuals are generated on the viewer device 300. Accordingly, during the period in which either the virtual-camera-viewpoint visuals or the viewer-avatar-viewpoint visuals can be selected to be displayed on the viewer device 300, switching between the virtual-camera-viewpoint visuals and the viewer-avatar-viewpoint visuals is carried out at the choice of the viewer user. Therefore, compared to when the virtual-camera-viewpoint visuals data is displayed by streaming from the streaming server computer 100, switching between the visuals can be carried out without causing problems such as the visuals being interrupted, and while preventing an increase in the processing load on the streaming server computer 100 associated with switching between the visuals.

Meanwhile, during the periods of “pre-start explanation”, “opening performance”, and “flying performance”, in which only the virtual-camera-viewpoint visuals can be displayed on the viewer device 300, the virtual-camera-viewpoint visuals are generated only in the streaming server computer 100 to be streamed to the respective viewer devices 300. Accordingly, during the period when only the virtual-camera-viewpoint visuals can be displayed on the viewer device 300, the virtual-camera-viewpoint visuals are generated only on the streaming server computer 100. Thereby, it is possible to prevent an unnecessary increase in the processing load of the entire system as a result of the processing of generating the virtual-camera-viewpoint visuals being executed redundantly on the viewer device 300.

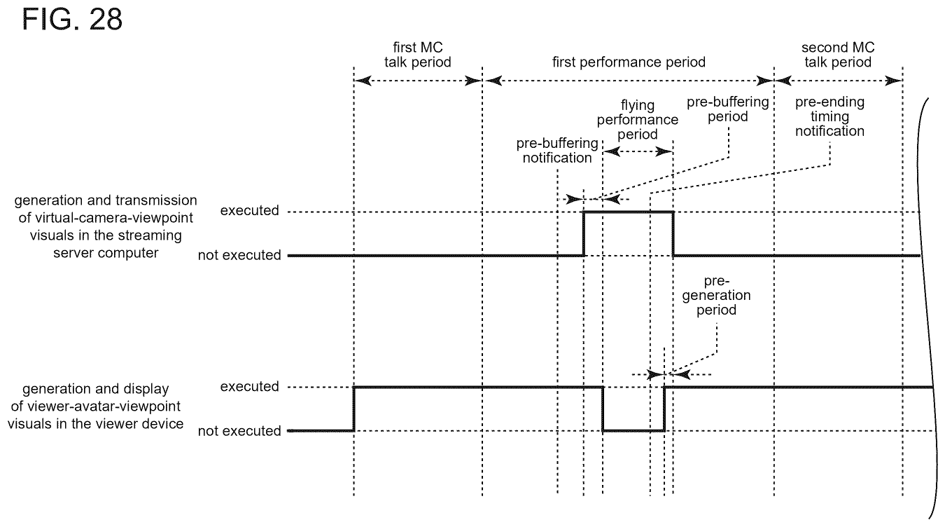

Here, the situation when the viewpoint is switched on the viewer device 300 will be described with reference to FIG. 28, taking as an example a period of “flying performance” during which only the virtual-camera-viewpoint visuals can be displayed.

For example, as shown in FIG. 28, on a viewer device 300 on which viewer-avatar-viewpoint visuals have been displayed during the “first MC talk” period and the first performance period before the “flying performance” period, if the streaming server computer 100 starts streaming the virtual-camera-viewpoint visuals (viewpoint visuals of viewpoint from an aerial-moving virtual camera) from the start of the “flying performance” period in which only the virtual-camera-viewpoint visuals (viewpoint visuals of viewpoint from the aerial-moving virtual camera) can be displayed, the virtual-camera-viewpoint visuals (viewpoint visuals of viewpoint from the aerial-moving virtual camera) will not be displayed on the viewer device 300 during the period from the start of the streaming until the virtual-camera-viewpoint visuals are displayed. This could result in a problem in which the viewer is unable to view the first part of the visuals of the “flying performance”.

For this reason, as shown in FIG. 28, at the start of a “flying performance” in which the viewpoint visuals are forcibly changed from the viewer-avatar-viewpoint visuals to the virtual-camera-viewpoint visuals (viewpoint visuals of viewpoint from the aerial-moving virtual camera), the streaming server computer 100 according to Embodiment 2 transmits a pre-buffering (pre-BF) notification to the viewer device 300 at a specific timing prior to the start of the “flying performance”, thereby notifying the viewer device 300 of the streaming start (buffering start) timing for starting pre-start streaming of the virtual-camera-viewpoint visuals (viewpoint visuals of viewpoint from the aerial-moving virtual camera) before the start of the flying performance period.

In response to receiving the pre-BF notification, the viewer device 300 identifies the timing at which streaming of the virtual-camera-viewpoint visuals (viewpoint visuals of viewpoint from the aerial-moving virtual camera) begins from the streaming server computer 100, and begins, from this timing, buffering the received virtual-camera-viewpoint visuals (viewpoint visuals of viewpoint from the aerial-moving virtual camera).

The timing at which streaming of the virtual-camera-viewpoint visuals (viewpoint visuals of viewpoint from the aerial-moving virtual camera) begins, that is, the timing at which buffering begins, can be determined appropriately taking into account differences in the visuals storing features of the viewer devices 300. For example, it can be set to a period corresponding to several tens of frames of visuals.

Accordingly, the streaming server computer 100 according to Embodiment 2 begins generating and streaming virtual-camera-viewpoint visuals of the flying performance (viewpoint visuals of viewpoint from the aerial-moving virtual camera) before the start of the flying performance period. Meanwhile, the viewer device 300 buffers the streamed virtual-camera-viewpoint visuals. Therefore, when the flying performance period begins, the visuals can be instantly changed from the viewer-avatar-viewpoint visuals that have been displayed before the start of the flying performance period to the virtual-camera-viewpoint visuals, and therefore it is possible to prevent the problem that the viewer is unable to view the initial visuals of the “flying performance”.

When the “flying performance” period ends, the viewpoint visuals switches from the virtual-camera-viewpoint visuals of the flying performance (viewpoint visuals of viewpoint from the aerial-moving virtual camera) to the viewer-avatar-viewpoint visuals as a result of the “flying performance” period having ended because the viewer-avatar-viewpoint visuals have been selected before the start of the “flying performance”. However, in this case as well, if the viewer-avatar-viewpoint visuals are generated and displayed from the end of the “flying performance” period, there is a risk that the viewer-avatar-viewpoint visuals are not displayed on the viewer device 300 during a period until the viewer-avatar-viewpoint visuals are generated and displayed, similarly to the time when the “flying performance” is started.

For this reason, the streaming server computer 100 according to Embodiment 2 transmits a pre-ending timing (TM) notification to the viewer device 300, thereby notifying in advance the viewer device 300 of the “flying-performance”-period-ending timing when the streaming of the virtual-camera-viewpoint visuals (viewpoint visuals of viewpoint from the aerial-moving virtual camera) ends, also at the time when the “flying performance” period ends, as shown in FIG. 28.

In response to receiving the pre-ending-timing (TM) notification, the viewer device 300 identifies in advance the timing at which the streaming of the virtual-camera-viewpoint visuals (viewpoint visuals of viewpoint from the aerial-moving virtual camera) from the streaming server computer 100 will be stopped, and starts the viewer-viewpoint visuals generation processing at a predetermined timing prior to said timing, thereby pre-generating the viewer-avatar-viewpoint visuals.

The streaming server computer 100 streams the virtual space update data from the time of the transmission of the pre-ending-timing (TM) notification, thereby the viewer device 300 executes the virtual space processing for updating the virtual space data using the received virtual space update data, and therefore it is possible to generate viewer-avatar-viewpoint visuals that reflect the situation of the virtual live venue at that time at said predetermined timing.

Accordingly, the streaming server computer 100 according to Embodiment 2 transmits a pre-ending-timing (TM) notification to the viewer device 300 before the end of the flying performance period, allowing the viewer device 300 to generate the viewer-avatar-viewpoint visuals in advance before the end of the flying performance period, and therefore it is possible to prevent a problem that the viewer-avatar-viewpoint visuals are not displayed on the viewer device 300.

In FIG. 28, “flying performance” is used as an example, but similar control is also performed during the “pre-start explanation” and “opening performance” periods when the viewpoint visuals are forcibly changed from the viewer-avatar-viewpoint visuals to the virtual-camera-viewpoint visuals.

As described above, in the virtual space content streaming system according to Embodiment 2, there are a plurality of viewer users, and each viewer user is assigned a viewer device 300. When the viewer device 300 displays the viewer-avatar-viewpoint visuals of viewpoint from viewpoint of the virtual live venue (virtual space) corresponding to the viewpoint of the viewer avatar, the viewer-avatar-viewpoint visuals are generated based on the virtual space update data (virtual space data) transmitted from the streaming server computer 100. Since the generation of the viewer-avatar-viewpoint visuals, requiring a large processing load, is performed in the viewer device 300, it is possible to increase the number of viewer users participating in the virtual live.

The virtual space content according to Embodiment 2 is content in which a performer user can participate in a virtual live venue as a performer avatar 1, and in which the performer avatar 1 performs musical motions (performances), such as singing and dancing, in the virtual live venue, and therefore it is possible to make the virtual space content more interesting.

The virtual space update data (virtual space data) according to Embodiment 2 includes performer-avatar-intended motion data for generating the motions of the performer avatar 1, and therefore the motions of the performer avatar 1 can be accurately reflected in the viewer-avatar-viewpoint visuals generated in the viewer device 300 as well.

Common-viewpoint visuals, such as the visuals of the “pre-start explanation”, “opening performance”, and “flying performance”, that are commonly displayed on each viewer device 300 in Embodiment 2 are generated in the streaming server computer 100 to be streamed to each viewer device 300, and therefore it is possible to prevent unnecessary increase in the processing load of the entire system due to duplicate processing being executed in the respective viewer devices 300.

In the viewer device 300 according to Embodiment 2, the virtual-camera-viewpoint visuals are generated and displayed in the viewer device 300 during the “MC talk period” and the performance period (specific period) excluding the “flying performance” period, during which either the viewer-avatar-viewpoint visuals or the virtual-camera-viewpoint visuals can be selected to be displayed, and therefore it is possible to prevent problems, such as the visuals being interrupted, when the viewer-viewpoint visuals are switched.

During periods of “costume changing performance” and “illusionary clone performance” periods when the processing load on the streaming server computer 100 in Embodiment 2 is high, each viewer device 300 also generates and displays virtual-camera-viewpoint visuals (common viewpoint visuals), and therefore it is possible to prevent the processing load on the streaming server computer 100 from becoming extremely high temporarily.

The streaming server computer 100 according to Embodiment 2 transmits in advance pre-start data including basic data of the virtual live venue (virtual space) and basic data of the performer avatar 1 and viewer avatars that virtually participate in the virtual live venue to the respective viewer devices 300 before the virtual live starts, and therefore it is possible to prevent the problem that the viewer-avatar-viewpoint visuals are not displayed properly at the start of the virtual live.

The streaming server computer 100 according to Embodiment 2 transmits virtual-camera-viewpoint visuals (common viewpoint visuals) to viewer devices 300 whose receipt completion of pre-start data has not been confirmed. Accordingly, it is possible to prevent the processing load on the streaming server computer 100 from increasing excessively due to the transmission of, for example, basic data, after the start of the virtual live, while also preventing viewer users from being unable to view the virtual live.

### Variant Examples of Embodiment 2

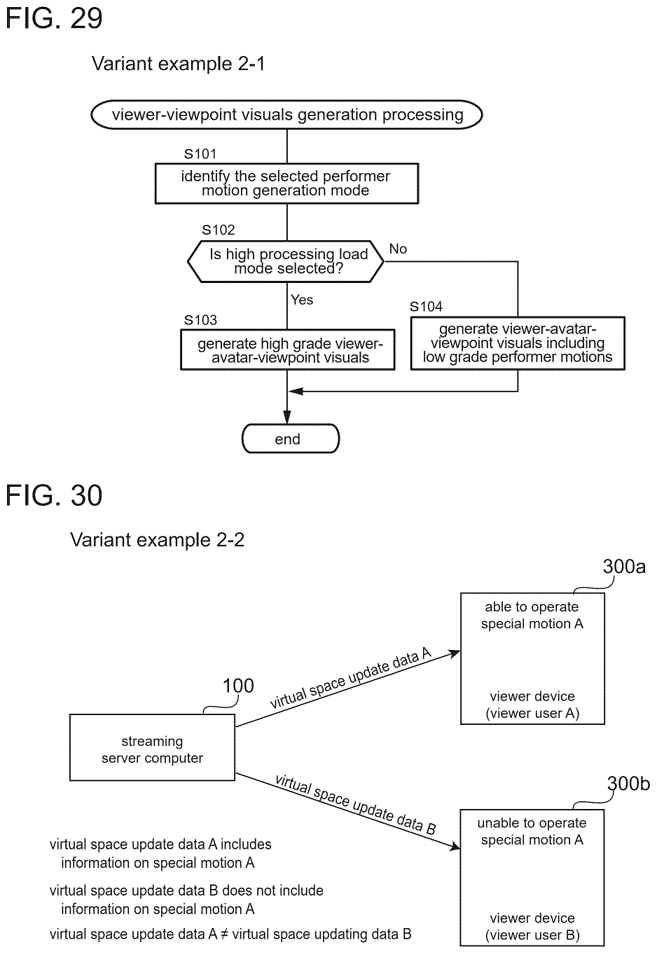

FIG. 29 shows a flowchart of viewer-viewpoint visuals generation processing in Variant example 2-1 of Embodiment 2.

In Embodiment 2 described above, a form is shown in which the viewer-avatar-viewpoint visuals including motions of the performer avatar 1 are always generated uniformly, but the present invention is not limited to this. The viewer-avatar-viewpoint visuals may be generated in a number of ways in which processing loads in visuals generation are different, according to the selection of the viewer user on the viewer device 300.

That is, as exemplified in Embodiment 1, the viewer device 300 used by the viewer user may be a desktop personal computer with high processing capabilities, or a smartphone device or tablet device with relatively lower processing capabilities than a personal computer, and therefore it is expected that devices with different processing capabilities are used. If viewer-avatar-viewpoint visuals are always generated uniformly on devices with such different processing capabilities, viewer-avatar-viewpoint visuals are not generated properly on devices with low processing capabilities, and there is a risk of a mismatch between the viewer-avatar-viewpoint visuals and the audio, or the viewer-avatar-viewpoint visuals becoming discontinuous, unnatural visuals. Therefore, for example, when generating viewer-avatar-viewpoint visuals including performer motions, it may be preferable if the viewer can select, as appropriate, depending on the processing capabilities of the device using, whether to generate viewer-avatar-viewpoint visuals including high-definition performer motions, which requires a high processing load for generating visuals, or to generate viewer-avatar-viewpoint visuals including low-definition performer motions, which requires a low processing load for generating visuals.

In particular, the viewer-viewpoint visuals generation processing executed in the viewer device 300 may be as shown in the flow chart of FIG. 29, and in such viewer-viewpoint visuals generation processing, first, a performer motion generation mode selected by the viewer user on the viewer device 300 is identified (step S101). Then, it is determined whether or not the identified performer motion generation mode is a high processing load mode (step S102), and if the high processing load mode is selected (Y in step S102), viewer-avatar-viewpoint visuals including high-definition performer motions are generated (step S103). Meanwhile, if the high processing load mode is not selected (N in step S102), viewer-avatar-viewpoint visuals including low-definition performer motions are generated (step S104).

FIG. 29 shows an example in which there are two modes, a high processing load mode and a low processing load mode, but the present invention is not limited to this. The number of processing load modes may be three or more.

In Embodiment 2 described above (as well as Embodiment 1), an example is given of a form in which all motions, including the moving of the viewer avatar corresponding to the viewer user, are reflected in each viewer avatar by streaming virtual space update data, but the present invention is not limited to this. For example, in a case where an operation of performing a special motion that is not normally possible to perform but is possible when a special fee is paid, for example, a motion that allows the viewer avatar to appeal to the performer avatar 1, is allowed on the viewer device 300 as a motion of the viewer avatar, the special motion is a motion directed to the performer user and not intended to be viewed by other viewer users. Accordingly, it may be preferable to prevent the virtual space update data including such a special motion from being streamed to the viewer devices 300 of other viewer users, and therefore it is possible to prevent an excessive increase in the processing load of the streaming server computer 100 caused by making the special motions executable.

Accordingly, in the case where virtual space update data including the special motion is not streamed to the viewer devices 300 of other viewer users, and when viewer user A performs an operation corresponding to a special motion, causing the viewer avatar of viewer user A to perform the special motion, as shown in Variant example 2-2 of FIG. 30, virtual space update data A corresponding to the viewer avatar of viewer user A performing the special motion is transmitted from the streaming server computer 100 to the viewer device 300 of viewer user A, but virtual space update data B corresponding to a situation where the viewer avatar of viewer user A is not performing the special motion is streamed to a viewer device 300 of viewer user B, who is different from viewer user A.

Therefore, different virtual space update data is streamed from the streaming server computer 100 to the viewer device 300 of viewer user A and the viewer device 300 of viewer user B, thereby increasing the flexibility of the virtual space update data and making it possible to generate different viewer-avatar-viewpoint visuals in the viewer device 300 of viewer user A and the viewer device 300 of viewer user B.

In addition, the viewer device 300 of viewer user A can generate and display visuals of the viewer avatar of viewer user A that performs a special motion different from the motions that the viewer avatar of viewer user B is capable of, based on virtual space update data A that is different from virtual space update data B streamed to the viewer device 300 of viewer user B, thereby making the viewer user A in the virtual live in which the virtual space content is created more interesting.

In Embodiment 2 described above (as well as Embodiment 1), an example in which the viewer avatars of viewer users virtually participating in the fourth region are normal avatars in which the avatar appearance differs for each viewer user is given, but the present invention is not limited to this. For example, in order to reduce the processing load when generating various viewpoint visuals in a virtual live, the viewer avatars of viewer users virtually participating in the fourth region may be simplified avatars in which the avatar appearance is simplified.

FIG. 30 shows an example of executing a special motion that becomes possible when a special fee is paid. However, for example, in the case of using a simplified avatar as described above, normal motions, such as waving, clapping, and changing the orientation of the viewer avatar, other than a move of the simplified avatar may be prevented from being included in the virtual space update data streamed to other viewer users, just like special motions, thereby further reducing the processing load on the streaming server computer 100.

### Embodiment 3

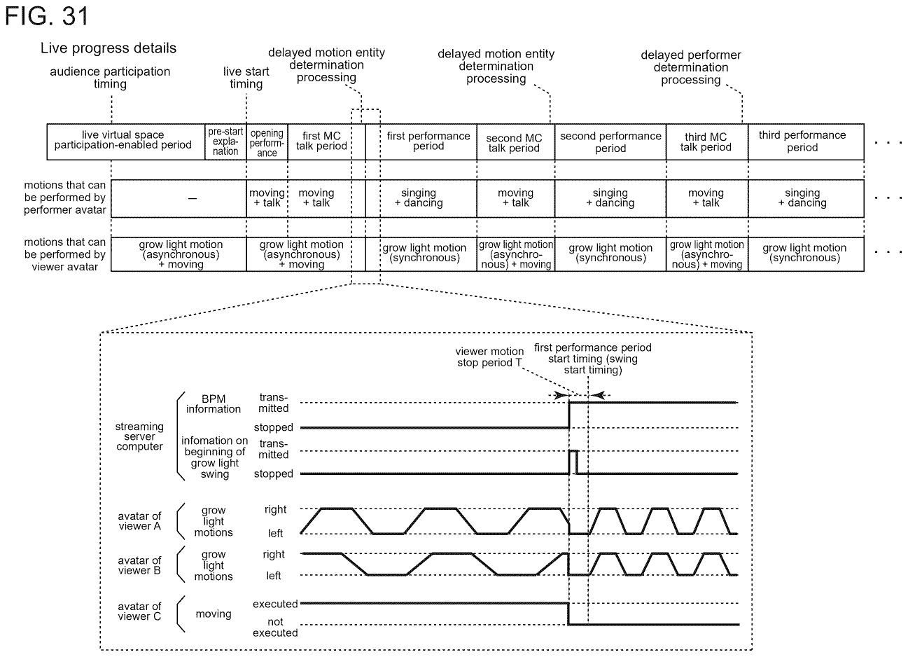

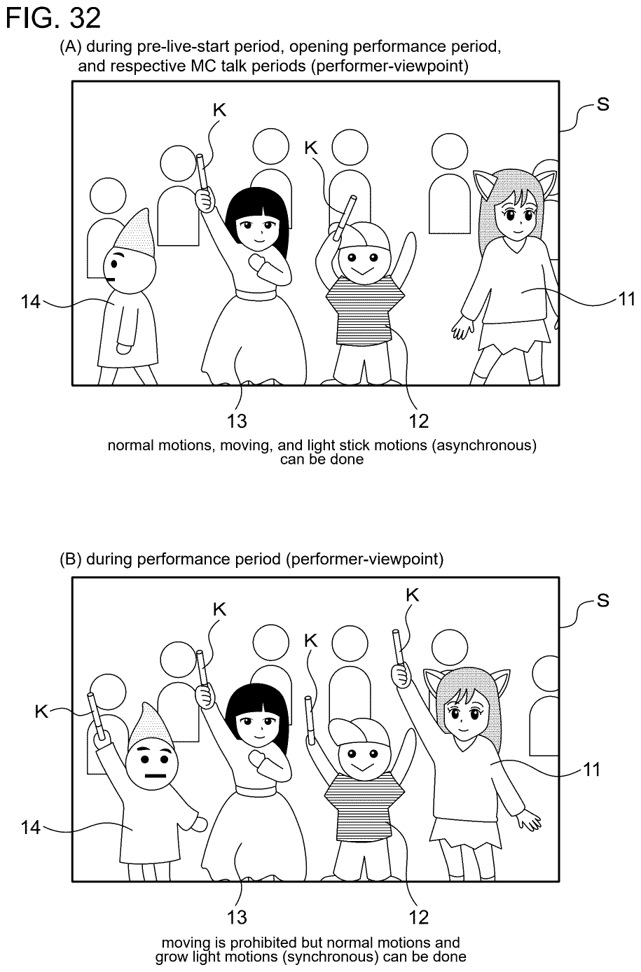

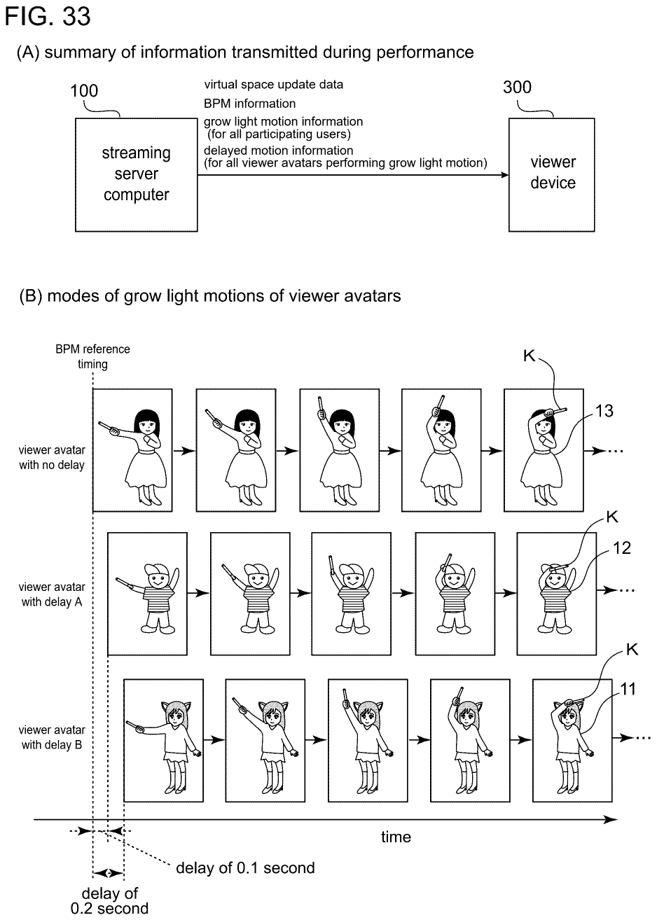

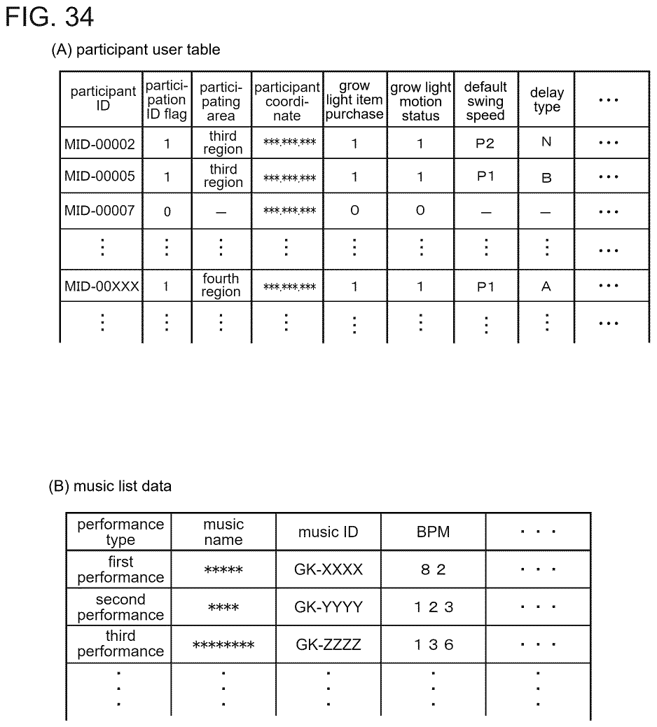

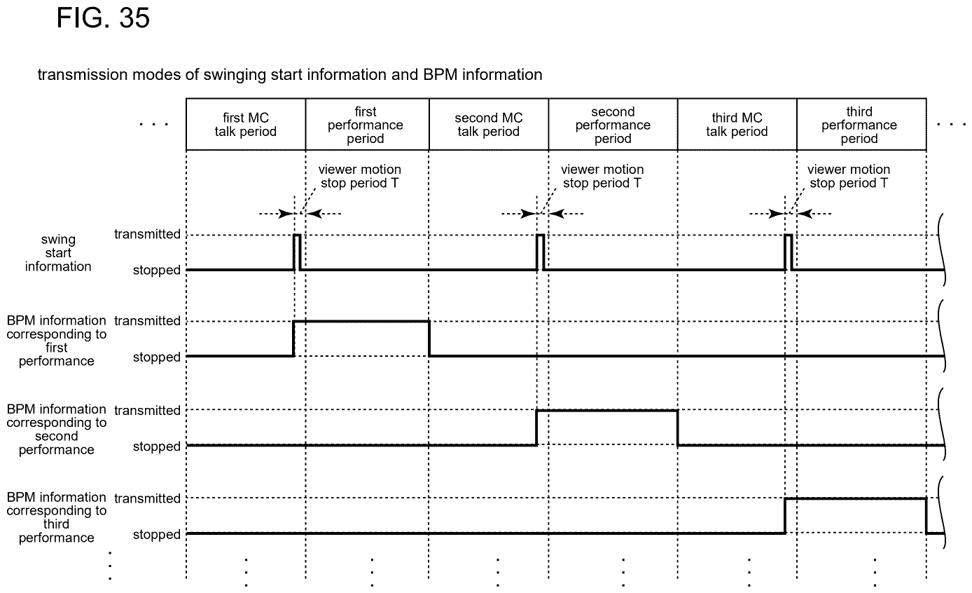

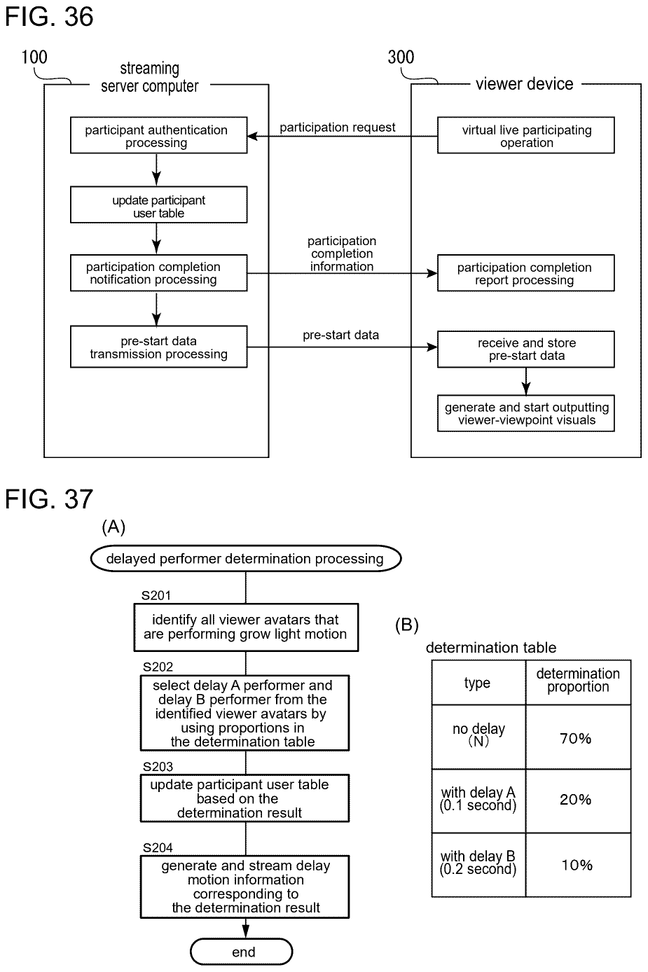

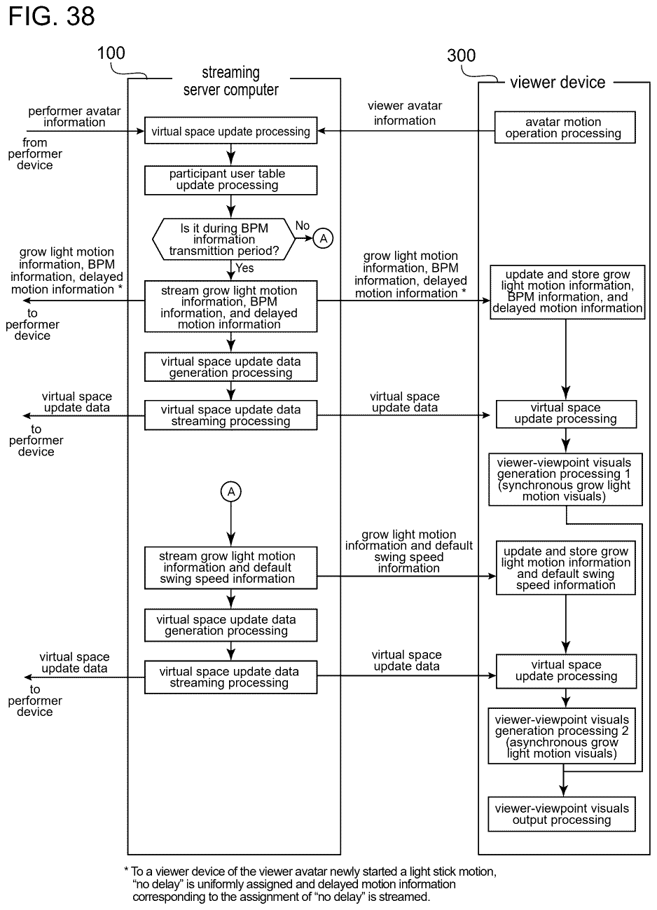

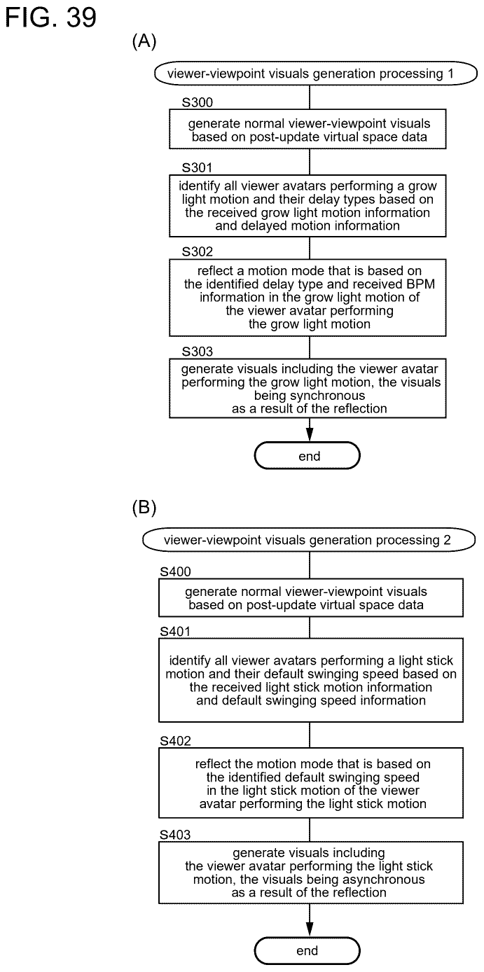

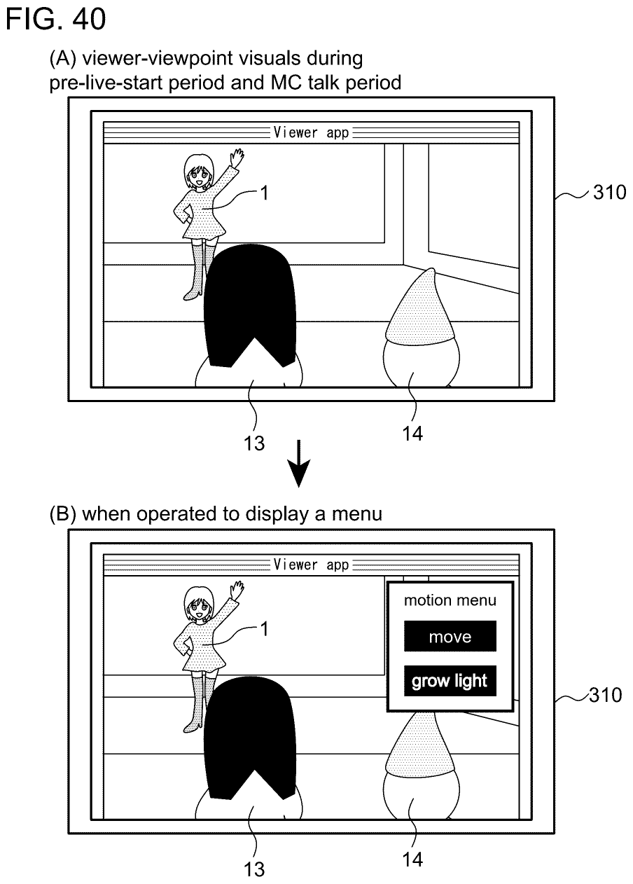

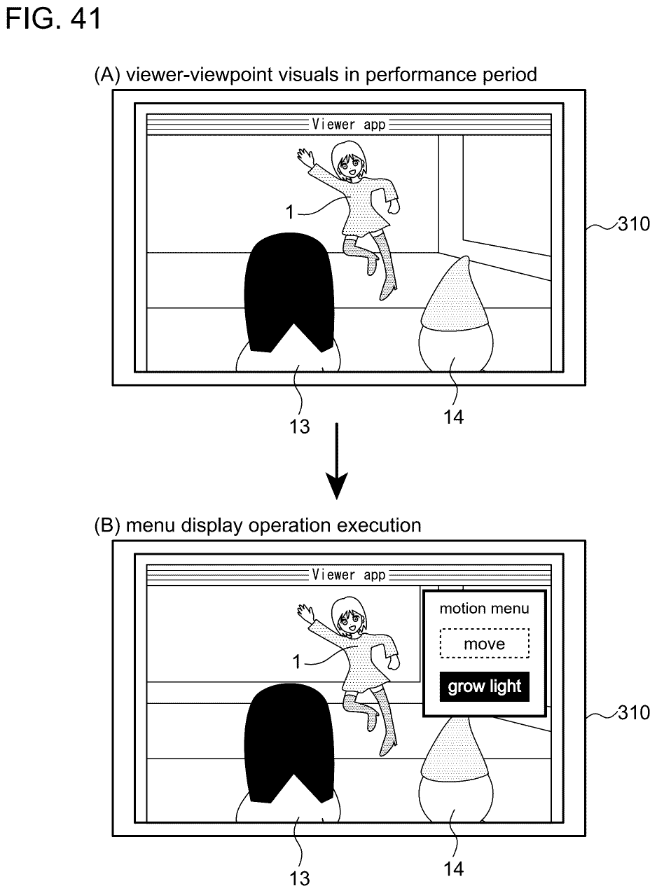

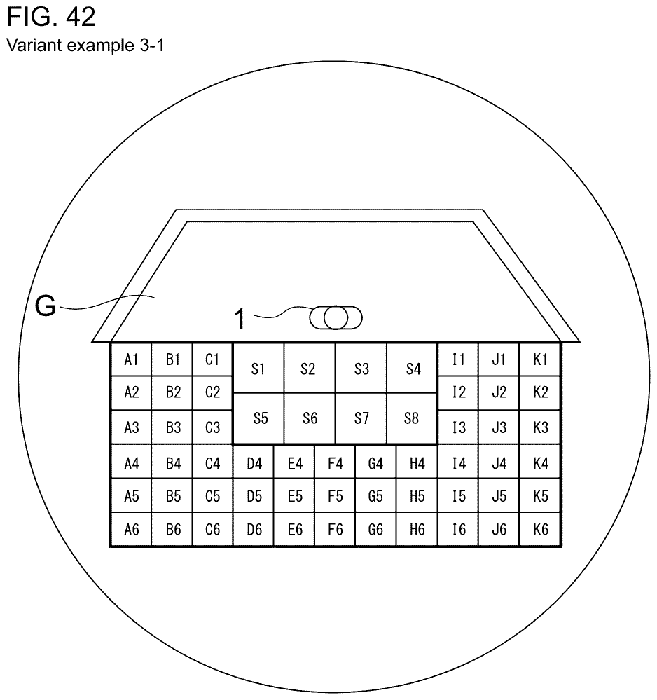

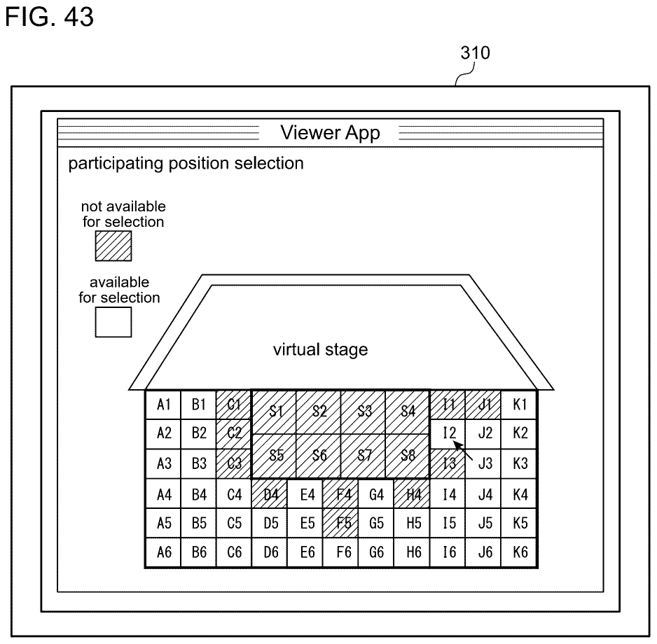

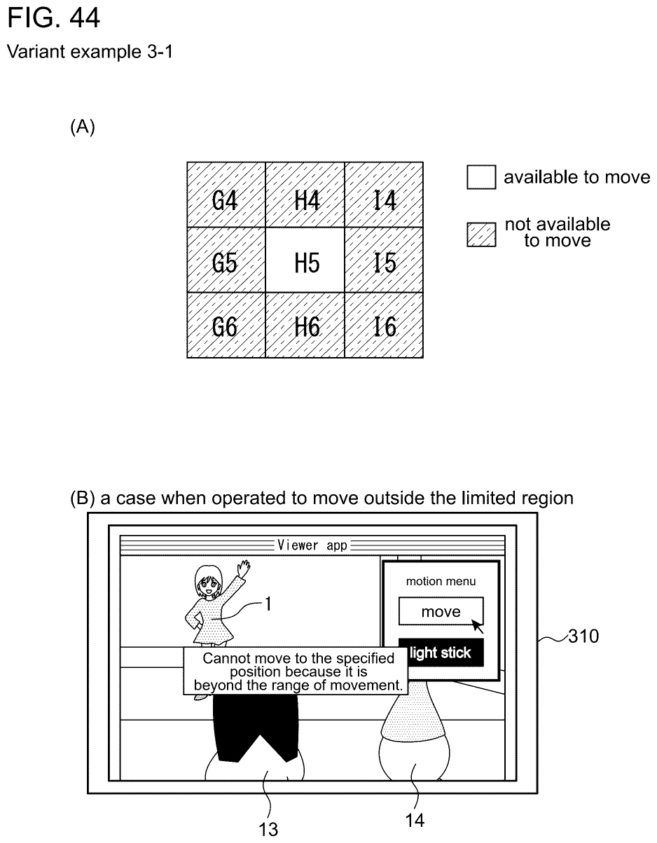

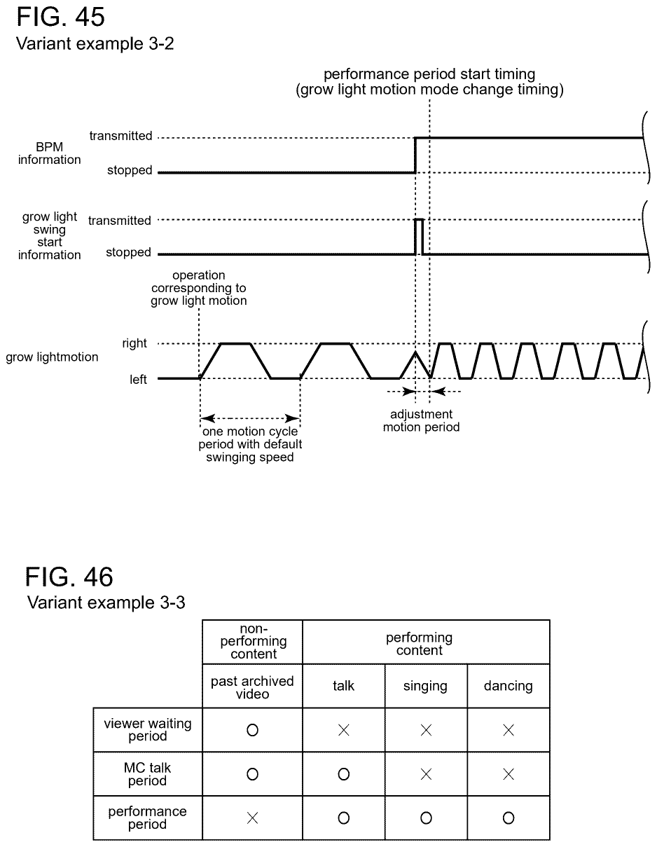

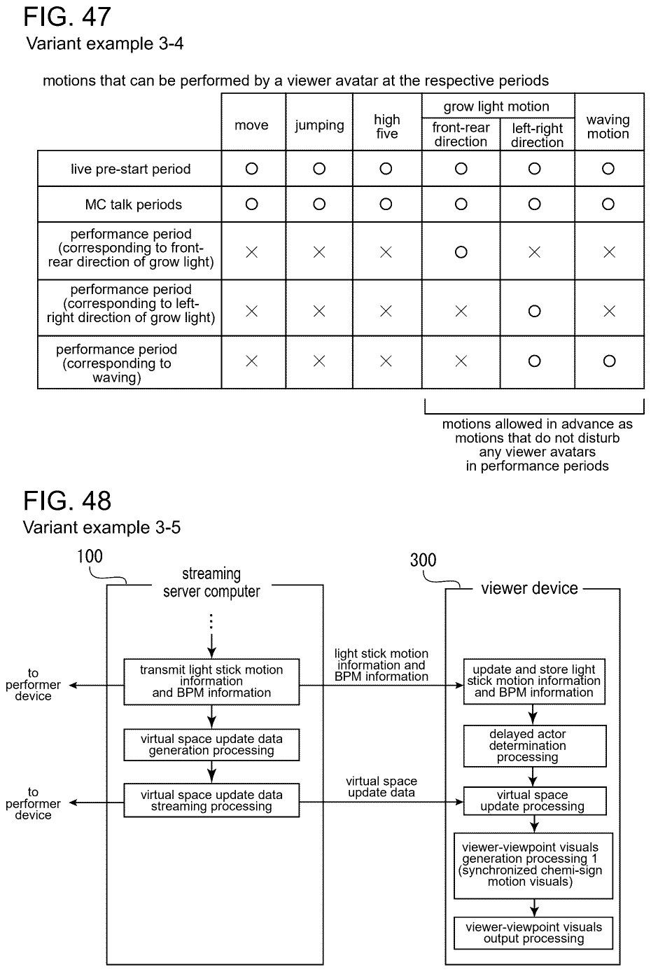

Next, a virtual space content streaming system according to Embodiment 3 will be described below with reference to FIGS. 31-41. The same components as those in Embodiments 1 and 2 are denoted by the same reference numerals and the description thereof will be omitted.

The configuration of the virtual space content streaming system according to Embodiment 3 is the same as that of Embodiments 1 and 2 shown in FIG. 1, but the progress details of the virtual live is different from that of Embodiments 1 and 2, and a grow light motion (see FIG. 33) can be executed in which a rod-shaped grow light K (hereinafter abbreviated as “grow light K”) that emits light by mixing the filled chemicals is swung left and right. The grow light motion is a content-compatible motion that is not executable as a motion of a viewer avatar in Embodiments 1 and 2. The characteristic part of Embodiment 3 is that the control related to the grow light motions is different from that of Embodiments 1 and 2.

FIG. 31 shows a diagram illustrating the progress details of a virtual live streamed in the virtual space content streaming system according to Embodiment 3. In the virtual live according to Embodiment 3, first, there are a “live virtual space participation-enabled period” and a “pre-start explanation” period as periods before the start of the virtual live, and viewer users can virtually participate in the virtual space in which the virtual live is held during the live virtual space participation-enabled period.

The period, which is provided at the live virtual space participation-enabled period and just before the end of the “pre-start explanation” period, until the end of the pre-start data download timing (not shown) is the pre-start data download period, as in Embodiment 2. Data, such as virtual space data (basic data) of the virtual live venue, avatar data of the performer avatar 1, and avatar data of other viewer users who have virtually participated, are downloaded as pre-start data from the streaming server computer 100 to the viewer device 300 of the viewer user who has virtually participated during the live virtual space participation-enabled period.

During the “pre-start explanation” period, similarly to Embodiment 2, explanations about the virtual live that is scheduled to start or the like are presented through, for example, video visuals.

As shown in FIG. 31, the virtual live according to Embodiment 3 progresses as follows: “opening performance” is followed by “first MC talk”, followed by “first performance”, followed by “second MC talk”, followed by “second performance”, followed by “third MC talk”, followed by “third performance”, and so on. Periods of “opening performance”, “first MC talk” and “second (third) MC talk” are similar to those in Embodiment 2. Periods of “first performance”, “second performance”, “third performance”, and so on, include singing and dancing by the performer avatar 1 (performer).

Just before the end of each period of the “first MC talk”, “second MC talk”, and “third MC talk”, there is a timing for executing delayed motion determination processing (see FIG. 37) for determining a participant (viewer user) who performs a delayed motion in performing the grow light motion. Therefore, a different participant (viewer user) is determined as the participant (viewer user) who performs the delayed motion in each of the “first performance”, “second performance”, “third performance”, and so on.

As shown in FIG. 31, the motions that the performer avatar 1 can perform during the respective periods when, for example, the performance renditions and performances are performed in the virtual live according to Embodiment 3, include motions of moving on the virtual stage G and motions related to talking during the opening performance in which the performer avatar 1 appears, in addition to the normal motions of moving parts of the avatar, such as the hands, feet, and head. In FIG. 31, normal motions that the performer avatar 1 and the viewer avatars are capable of are omitted due to space limitations.

During the MC talk periods of the “first MC talk”, “second MC talk”, “third MC talk”, and so on, motions of moving on the virtual stage G and motions related to talking can be performed in addition to normal motions, as in the “opening performance”. During the performance periods of the “first performance”, “second performance”, “third performance”, and so on, singing motions and dancing motions can be performed in addition to normal motions. The dance motions may include motions of moving on the virtual stage G.

The motions that can be performed by the viewer avatar of a participant (viewer user) who virtually participates in the virtual live venue the respective periods of the virtual live in Embodiment 3 include normal motions of moving parts, such as the hands, feet, and head, of the avatar, as well as asynchronous grow light motions in which the timing and speed of the individual participants (viewer users) swinging the grow light K are asynchronous, as performed by viewer avatar 12 and viewer avatar 13 in FIG. 32, and motions of moving around the virtual live venue, as performed by viewer avatar 11 and viewer avatar 14 in (A) in FIG. 32, during the period before the start of the live (live virtual space participation-enabled period and pre-start explanation period), the opening performance period, and the respective MC talk periods. In FIG. 32, the viewer avatars participating in the fourth region are displayed in a simplified manner for convenience, but they are avatars that are similar to viewer avatars 11-14 and are capable of performing motions similar to ones viewer avatars 11-14 perform.

The asynchronous grow light motion is a motion of swinging the grow light K left and right at a speed (pitch) from speed 1 to speed 5, the speed being individually selected as a default by the viewer user at each viewer device 300, as described below.

In addition to normal motions, the motions that can be performed by the viewer avatars of participants (viewer users) virtually participating during the respective performance periods of “first performance”, “second performance”, “third performance”, and so on include synchronous grow light motions, such as the motions of viewer avatars 11-14 as shown in (B) in FIG. 32, in which the timing and speed at which the viewer avatars of the individual participants (viewer users) swing the grow light K are synchronized based on a wide range of information (see FIG. 33) transmitted from the streaming server computer 100. That is, in Embodiment 3, it is possible to have a negative impact on the virtual live as a result of a move of a viewer avatar being prohibited during the respective performance periods when the performer avatar is performing a performance but the viewer avatars moving during the performance periods. For example, it is possible to prevent interfering with the viewing of other viewer avatars, or prevent causing a decrease in the concentration of the performer with such move, as a result of, for example, collisions with other viewer avatars.

The grow light motion is not a motion that can be performed by the viewer avatars of all participants (viewer users) who virtually participate in the virtual live, but is only a motion that can be performed by viewer avatars of participants (viewer users) who have purchased a virtual item of a grow light K in advance. Accordingly, even if a viewer avatar is virtually participating in the virtual live, the viewer avatar that does not possess a grow light K cannot perform the grow light motion, and therefore there will be viewer avatars that have not performed a grow light motion during the respective performance periods.

The situation in which a move, which is a motion of the viewer avatar, is prohibited on a personal computer that the viewer user is using as the viewer device 300 will be described using FIGS. 40 and 41. When the viewer user performs an operation to display a motion menu during the pre-live-start period or each MC talk period during which the performer avatar 1 is not performing, avatar motion operation processing is executed in the viewer device 300, and the motion menu including items of “move” and “grow light” are displayed with the items being in an active (enabled) state, as shown in (B) in FIG. 40, thereby notifying the viewer that both the motions of “move” and “grow light” can be performed, and the viewer user can have the viewer avatar perform either the “move” or “grow light” motion by selecting and inputting the motion.

In FIGS. 40 and 41, in order to simplify the explanation, items of, for example, normal motions, other than the “move” and “grow light” motions, have been omitted, and it goes without saying that items other than the “move” and “grow light” items may be included.

Meanwhile, if the viewer user performs an operation to display the motion menu during the performance period when the performer avatar 1 is performing, the avatar motion operation processing displays only the “grow light” motion menu item in an active (enabled) state as a result of such motion being prohibited as described above, and the “move” motion menu item in an inactive (disabled) state, as shown in FIG. 41. Thus, the viewer user can cause the viewer avatar to perform the “grow light” motion by selecting and inputting, but not the “move” motion.

The motion restriction of the viewer avatar by controlling the display of the motion menu items may be performed by executing avatar motion operation processing on the viewer device 300 side, and determining whether or not it is during the performance period based on BPM information and swing start information. Alternatively, the streaming server computer 100 may generate motion restriction information successively for each motion of the viewer avatar, capable of identifying whether it is possible or impossible to perform at each point in time during the virtual live, and stream this information to each viewer device 300, and therefore the viewer device 300 applies the motion restriction based on the motion restriction information. Alternatively, instead of transmitting such motion restriction information, the viewer device 300 may temporarily accept an operation corresponding to a motion, and the streaming server computer 100 may then determine whether the accepted motion is enabled or disabled.

Next, information transmitted from the streaming server computer 100 to the respective viewer devices 300 in order to perform synchronous grow light motions as described above is shown in FIG. 31 and (A) in FIG. 33. In particular, the streaming server computer 100 transmits beats per minute (BPM) information, grow light motion information, and delayed motion information, as shown in (A) in FIG. 33, along with the virtual space update data described in Embodiment 1.

In addition to the BPM information, grow light motion information, and delayed motion information, swing start information which allows identifying the timing at which each viewer avatar performing the grow light motion starts swinging the grow light K at the start of each performance is transmitted from the streaming server computer 100 to the respective viewer devices 300 at a timing before a predetermined period (the period at which the motion of the viewer avatar is stopped) from the start of each performance, as shown in FIGS. 31 and 35. Each viewer avatar performing the grow light motion based on the timing identified by the swing start information (in Embodiment 3, this is approximately the same timing as the start timing of the performance) starts swinging the grow light K, thereby the grow light motions of the respective viewer avatars are synchronized.

The swing start information in Embodiment 3 is information that specifies the timing a predetermined period after the timing of receiving the swing start information, in other words, information that allows identifying the length of the predetermined period. Each viewer device 300 that receives the swing start information starts a timer count from the reception timing and can identify the timing when the grow light K is started swinging (start timing of performance), which is the timing after the predetermined period, based on the timing when the timer finishes.

In Embodiment 3, as shown in FIG. 31, during the period before the swing start information is transmitted a predetermined period before the start of the performance, the move of the viewer avatar performed by the viewer C avatar and the asynchronous grow light motion performed by the viewer A avatar or the viewer B avatar at the default swing speed are possible. However, during the predetermined period from the timing of transmission of the swing start information to the start timing of the performance, which is the timing at which the synchronous grow light motion begins, which is the timing specified by the swing start information, all motions of the viewer avatars are stopped (prohibited). This enables each viewer avatar to properly begin the synchronous grow light motion, and avoids the viewer feeling uncomfortable when suddenly transitioning from an asynchronous grow light motion to a synchronous grow light motion with a different swing speed, etc. In Embodiment 3, the beats per minute (BPM) information described below is streamed in advance from the timing of transmitting the swing start information, which is a predetermined period before the start timing of the performance, in order to allow starting the grow light motions synchronous with the music properly from the beginning. This also prevents the BPM information from being erroneously reflected in asynchronous grow light motions.

The beats per minute (BPM) information indicates the number of beats in a music per minute, with a higher BPM value for music with a faster tempo and a lower BPM value for music with a slower tempo. The beats per minute (BPM) information is described as data that allows identifying the interval between beats and the timing of the beats corresponding to the BPM values. By identifying the timing of the beats from the BPM information as the BPM-referenced timing (see FIG. 33) and operating so that one cycle of swinging the grow light K left and right is completed during the period of each beat, the speed of the grow light motion can be matched to the speed (tempo) of the music being performed in each performance, and the speed of the grow light motion of each viewer avatar can be adjusted to the same speed.

In Embodiment 3, as described above, the BPM information is streamed in advance from the transmission timing, with the swing start information of a predetermined period before the start of the performance. However, the BPM information streamed during the predetermined period is not reflected in the asynchronous grow light motion of the viewer avatar, and the viewer device 300 can identify the manner of the synchronous grow light motion in advance, prior to the start of the performance, from the beats and the periods between beats identified by the BPM information transmitted in advance. Accordingly, by the viewer device 300 being used to identify the manner of the synchronous grow light motion in advance, the synchronous grow light motion can be executed accurately from the start of the performance.

The grow light motion information is information for identifying a viewer avatar that is performing a grow light motion among viewer avatars virtually participating in the virtual live. That is, as described above, viewer avatars who have not purchased grow light K in advance are not capable of performing the grow light motion, and there are also viewer avatars who have purchased grow light K in advance but are not performing the grow light motion. Accordingly, for all viewer avatars virtually participating in the virtual live, data describing whether or not a viewer avatar is performing the grow light motion is transmitted to each viewer device 300 as grow light motion information. Thereby, when viewer-avatar-viewpoint visuals and virtual-camera-viewpoint visuals are generated in each viewer device 300, whether or not the grow light motion is being performed is identified for each viewer avatar based on the grow light motion information to be reflected in the motion of the viewer avatar.

The delayed motion information is information that allows identifying viewer avatars performing motions with delay A or delay B shown in (B) in FIG. 33 among viewer avatars performing the grow light motion, and is data describing whether all viewer avatars (viewer users) performing the grow light motion belong to a no delay group, a delay A group, or a delay B group.

That is, for a viewer avatar (viewer user) that is identified by the delayed motion information as belonging to the “no delay” group, the viewer avatar begins one cycle of grow light motion (cycle of a motion swinging the grow light K left and right one time) without any delay (deviation) from the BPM-referenced timing corresponding to the beat timing identified by the BPM information, as in the grow light motion performed by the viewer avatar 13 in (B) in FIG. 33.

In addition, for viewer avatars (viewer users) that are identified by the delayed motion information as belonging to the “delay A” group, the viewer avatars begin one cycle of grow light motion (a cycle of motion of swinging left and right) at a timing, which is delayed by 0.1 second from the BPM-referenced timing that corresponds to the beat timing identified by the BPM information, as in the grow light motion performed by the viewer avatar 12 in (B) in FIG. 33.

In addition, for viewer avatars (viewer users) identified by the delayed motion information as belonging to the “delay B” group, the viewer avatars begin one cycle of grow light motion (a cycle of motion of swinging left and right) at a timing delayed by 0.2 second from the BPM-referenced timing corresponding to the beat timing identified by the BPM information, as in the grow light motion performed by viewer avatar 11 in (B) in FIG. 33.

The reason for transmitting such delayed motion information to have the viewer avatar 12 and the viewer avatar 11 perform grow light motions that are delayed (shifted) by 0.1 second or 0.2 second from the BPM-referenced timing is that, for example, if all the grow light motions performed by the viewer avatars perfectly match (synchronize) based on the swing start information and the BPM information, the grow light motions would become unrealistic, which could significantly reduce the realism of the virtual live. Therefore, in order to increase the realism of the grow light motions performed by the viewer avatars, the timing of the grow light motions for some viewer avatars is deliberately shifted by a range of 0.2 second, which is a specified range of seconds that does not go out of sync.

In Embodiment 3, an example in which the deviation is generated is given in which the timing of deviation is delayed from the BPM-referenced timing because the delay timing is easy to be identified by the BPM information in the viewer device 300. However, the present invention is not limited to this. For example, the timing of the “delay B” group may be set to 0.1 second before the BPM-referenced timing rather than delayed timing, thereby making the difference from the BPM-referenced timing smaller.

In Embodiment 3, an example in which the maximum deviation is 0.2 second, which is within a predetermined range that does not result in loss of synchronization, is given, but the present invention is not limited to this. The maximum deviation may be any appropriate period that does not cause the viewer to feel out of sync, and are not limited to a fixed number of seconds. That is, the maximum deviation may be a variable number of seconds, and therefore if the music has a fast tempo, the maximum deviation has a smaller number of seconds, and if the music has a slower tempo, the maximum deviation has a larger number of seconds. In such cases, the number of seconds may correspond to a value obtained by multiplying the inverse of the tempo (BPM) of the music by a predetermined percentage (e.g., 10%).

In Embodiment 3, an example is given of a form in which the grow light motion information and the delayed motion information are treated as separate information (data), but the present invention is not limited to this. Such information may be treated as a single piece of data.

In Embodiment 3, two values, 0.1 second and 0.2 second, are used for the timing of deviation, thereby making it possible to further improve the realism of the grow light motion, but the present invention is not limited to this. The timing of deviation may be simplified to just one, or conversely, may be increased to three or more to further improve the realism.

In Embodiment 3, the number of timing deviations is the same for each performance, but the present invention is not limited to this. For example, the number of timing deviations may be reduced or “none” for a music with a very fast tempo, and the number of timing deviations may be increased for a music with a slow tempo. Accordingly, the number of timing deviations may be changed depending on the performance.

Next, the participant user table used in the streaming server computer 100 according to Embodiment 3 is shown in (A) in FIG. 34. The participant user table according to Embodiment 3, like the participant user table according to Embodiment 2, is a table that can store, in association with a participant ID (viewer user ID), the following: participation identification data (participation identification flag) which allows identifying the participation situation of the participant (viewer user); a participating area of the participant (viewer user); participant coordinates which allow identifying the position in the virtual live venue where the viewer avatar of the participant (viewer user) is located at that time; grow light item purchase data which allows identifying whether or not a grow light K, which is a virtual item, has been purchased or not; grow light motion status data which allows identifying whether or not the grow light motion is in progress; default speed data which allows identifying the type of default speed of the grow light motion; and delay type data which allows identifying which of the above-described groups “no delay”, “delay A”, or “delay B” the participant belongs to, and so on.

In the participant ID field, all viewer user IDs of prospective participants described in the file of each participant group stored in association with the virtual live are registered in the event data. In addition, the participation identification data (participation identification flag) is registered as “0”, which corresponds to a non-participating state, when a participant ID (viewer user ID) is registered, and is updated to “1”, which indicates participation, when the participation of each participant (viewer user) is allowed through authentication. Therefore, in the example shown in (A) in FIG. 34, it can be determined that a viewer user “MID-00007”, whose participation identification data (participation identification flag) is “0”, is not participating in the virtual live for some reason.

The participating area data is data which allows identifying whether the participating area of each participant (viewer user) is the third region or the fourth region, and is registered when the participation of the participant (viewer user) is allowed by authentication. The participant coordinate data is data that is updated successively in the virtual space update processing, and is coordinate data of the location where the viewer avatar of each participant (viewer user) is located within the virtual live venue. Therefore, the position within the virtual live venue where each viewer avatar is currently located can be easily identified by the coordinate data.

The grow light item purchase data is updated from “0” indicating non-purchase to “1” indicating that the item has been purchased, when the item is purchased. Therefore, as described above, only the viewer avatars of viewer users whose grow light item purchase data is “1” can perform a grow light motion, and as operations corresponding to the execution of the grow light motions are performed, the enablement or disability of the operation is determined in the streaming server computer 100 based on the grow light item purchase data.

The grow light motion status data is data that allows identifying whether or not the viewer avatar of each participant (viewer user) is performing a grow light motion, and when an operation corresponding to the execution of a grow light motion is executed on the viewer device 300 and the operation is determined as valid, the data is updated from “0”, indicating non-execution, to “1”, and when an operation corresponding to non-execution (end) of the grow light motion is executed on the viewer device 300, the data is updated from “1”, indicating execution, to “0”, indicating non-execution.

The default swing speed data is data that allows identifying the speed at which the grow light K is swung when performing an asynchronous grow light motion, and is data that corresponds to the speed selected by the viewer user when, for example, performing an operation of executing the grow light motion during a period such as before the start of the first performance. In particular, in Embodiment 3, the viewer user can select, as a default speed, from five levels of speeds ranging from Speed 1 (P1), which is a low speed, to Speed 5 (P5), which is a high speed, and information on the default speed selected by the viewer user on the viewer device 300 is notified to the streaming server computer 100 and registered in the streaming server computer 100.

Therefore, the speed at which the viewer avatar swings the grow light K during a period when asynchronous grow light motion is possible is based on the default speed data associated with the viewer user ID of the viewer user corresponding to the viewer avatar.

The delay type data is data that allows identifying which group the viewer avatar of each viewer user belongs to among “no delay”, “delay A”, or “delay B” group described above. “N” is registered when the viewer avatar belongs to “no delay” group; “A” is registered when the viewer avatar belongs to “delay A” group; and “B” is registered when the viewer avatar belongs to “delay B”.

Here, the flow of determining which group a viewer avatar is to belong among the “no delay”, “delay A”, or “delay B” group will be described with reference to FIGS. 31 and 37.

Such allotment to the groups “no delay”, “delay A”, and “delay B” is performed by the streaming server computer 100 executing delayed motion entity determination processing shown in (A) in FIG. 37.

The delayed motion entity determination processing is executed in the streaming server computer 100 not just once, but is executed at a plurality of timings immediately before the start of each performance, as shown in FIG. 31. Therefore, in Embodiment 3, the viewer avatars belonging to “no delay”, “delay A”, and “delay B” change for each performance.

As described above, in the delayed motion entity determination processing that is executed immediately before the start of each performance, first, as shown in (A) in FIG. 37, all viewer avatars that are performing the grow light motion are identified (step S201). In particular, it is possible to identify all participant IDs (viewer user IDs) for which “1” is registered as the grow light motion status data at that time in the participant user table shown in (A) in FIG. 34.

Then, viewer avatars performing a grow light motion with “delay A” and viewer avatars performing a grow light motion with “delay B” are selected among the identified viewer avatars performing grow light motions based on the determination proportions in the determination table shown in (B) in FIG. 37 (step S202).

An example of the determination proportion in Embodiment 3 is given as shown in (B) in FIG. 37, in which viewer avatars performing the grow light motion with “delay A” account for 20% of all viewer avatars performing the grow light motion, and viewer avatars performing the grow light motion with “delay B” account for 10% of all viewer avatars performing the grow light motion. Accordingly, it is preferable to make the deviation state more realistic by decreasing the determination proportion as the deviation becomes larger, but the determination proportions may be determined as appropriate. However, it is preferable that the total proportion of “delay A” and “delay B” does not exceed 50%.

In Embodiment 3, an example is given of a form in which there is one set of determination proportions, but the present invention is not limited to this. For example, it is possible to provide a plurality of determination tables with different determination proportions, and change the determination proportion by changing the determination table to be used depending on the music in the performance.

The specific method of selection is not limited, but an example is given of a form in which a determination number 1 is calculated by multiplying the total number M of viewer avatars performing the grow light motion identified by 10%, which is the determination proportion corresponding to “delay B”, and a determination number 2 is calculated by multiplying the total number M of viewer avatars performing the grow light motion identified in step S201 by 10%, which is the determination proportion corresponding to “delay B”, in step S201. Then, in step S201, a draw is held to select a viewer avatar among the identified viewer avatars performing the grow light motion until the determination number 1 is reached and to determine a viewer avatar that performs a grow light motion with “delay B”, a draw is held to select a viewer avatar among the undetermined viewer avatars until the determination number 2 is reached and to determine a viewer avatar that performs the grow light motion with “delay A”, and the remaining viewer avatars are determined as viewer avatars that performs the grow light motion with “no delay”.

Then, the delayed motion type data in the participant user table is updated based on the above-described determination result (step S203).

Then, new delayed motion information is generated based on the updated delayed motion type data and streamed to each viewer device 300 (step S204).

Next, the music list data used in the streaming server computer 100 according to Embodiment 3 is shown in (B) in FIG. 34. The music list data is stored in the streaming server computer 100 as data of one file.

As shown in (B) in FIG. 34, the music list data stores information such as “music name”, “music ID”, and “BPM” in association with the performance type, and it is possible to identify which music is to be used in each performance based on the information on the performance type.

That is, in the example shown in (B) in FIG. 34, it is possible to determine that a music with music ID “GK-XXXX” is performed in the first performance, a music with music ID “GK-YYYY” is performed in the second performance, and a music with music ID “GK-ZZZZ” is performed in the third performance.

In addition, from the BPM data, it can be seen that a music performed in the first performance has a relatively slow tempo of 82 beats per minute, a music performed in the second performance has a relatively fast tempo of 123 beats per minute, and a music performed in the third performance has an even faster tempo of 136 beats per minute. In (B) in FIG. 34, the BPM data is expressed as integer values, but the present invention is not limited to this. The values may be numerical values including decimal points.

Therefore, as shown in FIG. 35, in the first performance, BPM information corresponding to 82 beats per minute, which is the BPM of the music ID “GK-XXXX”, is streamed to each viewer device 300 as first-performance-adaptive BPM information. In the second performance, BPM information corresponding to 123 beats per minute, which is the BPM of the music ID “GK-YYYY”, is streamed to each viewer device 300 as second-performance-adaptive BPM information. In the third performance, BPM information corresponding to 136 beats per minute, which is the BPM of the music ID “GK-ZZZZ”, is streamed to each viewer device 300 as third-performance-adaptive BPM information. That is, for each performance, different BPM information corresponding to the music being played is streamed.

As shown in FIG. 35, the first-performance-adaptive BPM information, the second-performance-adaptive BPM information, and the third-performance-adaptive BPM information all begin to be streamed from the timing of transmission of the swing start information a predetermined period before the start timing of the first performance, the second performance, and the third performance, respectively. However, said predetermined period is regarded as a viewer avatar motion stop period T during which the motion of the viewer avatar is stopped, and is therefore not reflected in the grow light motion, which is the motion of the viewer avatar.

Here, a flow when a viewer user virtually participates in a virtual live venue in Embodiment 3 will be described with reference to FIG. 36.

First, the viewer user performs an operation to participate in the virtual live in which the viewer user plans to virtually participate, for example, by selecting a participation menu or operating a specific key on the keyboard to which the participation operation is assigned, in a viewer-intended program (viewer app) running on the viewer device 300.

By performing the participation operation, a participation request including the viewer user ID and authentication data for authenticating the viewer user is transmitted from the viewer device 300 to the streaming server computer 100.

The streaming server computer 100 that has received the participation request executes participant authentication processing on the condition that it is during a live virtual space participation-enabled period. In the participant authentication processing, it is determined whether the viewer user is a prospective participant of the virtual live based on whether the viewer user ID included in the received participation request is registered as a participant ID in a participant user database corresponding to the participating virtual live. In addition, the viewer user is authenticated by comparing the authentication data included in the participation request with the authentication data described in the authentication information file identified by the authentication information file data stored in correspondence with the viewer user ID in the viewer user data shown in FIG. 9.

If the viewer user is a prospective participant and authentication using the authentication data is completed, the participation identification data (participation identification flag) in the participant user table is updated to “1” corresponding to “participation”, and then the streaming server computer 100 returns participation completion information to the viewer device 300 that has transmitted the participation request. In response to receiving the participation completion information returned in this manner, a message indicating that virtual participation has been completed is displayed on the viewer device 300, thereby notifying the viewer device 300 that virtual participation has been completed. This allows viewer users to, for example, purchase virtual items (including grow light K) that are available for purchase at the virtual live in which they have completed their virtual participation.

Following the participation completion notification processing, the streaming server computer 100 executes pre-start data transmission processing to transmit the pre-start data to the viewer device 300 of the viewer user who has newly virtually participated. The viewer device 300 that has received the pre-start data transmitted in this manner stores the received pre-start data, and then generates viewer-viewpoint visuals based on the stored pre-start data and begins displaying (outputting) the viewer-viewpoint visuals. This allows viewer users to view visuals of the virtual live venue from the viewpoint of their own viewer avatar that has virtually participated.

Next, the flow of information between the streaming server computer 100 and the viewer device 300 after virtual participation will be described with reference to FIG. 38.

In FIG. 38, the flow up to the virtual space update processing in the streaming server computer 100 is the same as in Embodiment 1, and therefore a description thereof will be omitted here. However, operations in avatar motion operation processing in the viewer device 300 include operations related to grow light motions.

In the streaming server computer 100, participant user table update processing is executed after the virtual space update processing, thereby there are cases where the participant user table, specifically, for example, participant coordinate data, grow light motion status data, default swing speed data, etc., are updated.

Then, in the streaming server computer 100, it is determined whether or not it is during the period in which BPM information is being transmitted. As will be described later, the BPM information is also streamed (transmitted) before the start of each performance period (see FIG. 35).

During the period in which BPM information is being transmitted, grow light motion information, BPM information, and delayed motion information are streamed (transmitted) to the performer device 200 and each viewer device 300. The grow light motion information, BPM information, and delayed motion information thus streamed are updated and stored in the performer device 200 and each viewer device 300.

In Embodiment 3, it is possible to operate the viewer device 300 to have the viewer avatar perform a new grow light motion even during each performance period. However, during each performance period, as shown in FIG. 31, the delay operator determination processing is not executed, and therefore “no delay” is uniquely assigned to viewer users who perform new grow light motions during the performance period. Together with grow light motion information reflecting the information of the viewer user who has performed the new grow light motion, delayed motion information that allows identifying that the viewer user belongs to the “no delay” group is transmitted to the performer device 200 and each viewer device 300. However, since the processing load on the streaming server computer 100 is relatively high during each performance period as shown in FIG. 31, in order to prevent a further increase in the processing load on the streaming server computer 100 due to the increase in processing load associated with performing the above-described processing, it is possible to disable operations on the viewer device 300 that would cause the viewer avatar to perform new grow light motions.

Next, in the streaming server computer 100, as in Embodiment 1, a virtual space update data generation processing and virtual space update data streaming processing are executed, thereby the virtual space update data is streamed (transmitted) to the performer device 200 and each viewer device 300.

In response to receiving the virtual space update data thus streamed (transmitted), virtual space update processing is executed in each viewer device 300, and the update of the received virtual space update data are reflected in the virtual space data stored in each viewer device 300, and then viewer-viewpoint visuals generation processing 1 shown in (A) in FIG. 39 is executed.

(A) in FIG. 39 shows a flowchart showing the process of viewer-viewpoint visuals generation processing 1 executed in the viewer device 300 according to Embodiment 3. In this viewer-viewpoint visuals generation processing 1, first, processing of generating a normal viewer-viewpoint visuals based on the updated virtual space data is performed (step S300).

Next, based on the grow light motion information and delayed motion information received from the streaming server computer 100 and updated and stored, all viewer avatars performing grow light motions and their delay types are identified (step S301).

Then, a motion mode based on the delay type identified in step S301 and the received BPM information is reflected in the grow light motion of each viewer avatar currently performing the grow light motion (step S302).

Accordingly, by reflecting the information in step S302, viewer-avatar-viewpoint visuals including visuals of a viewer avatar performing a synchronous grow light motion based on the BPM information is generated (step S303).

The viewer-avatar-viewpoint visuals, in which the grow light motions of the respective viewer avatars are synchronized, generated in the viewer-viewpoint visuals generation processing 1 are output (displayed) on the respective viewer devices 300 by viewer-viewpoint visuals output processing.

Even if it is during a streaming period of BPM information, if it is during a viewer avatar motion stop period, it is during a period before the swing start timing in the first place and the viewer avatar is not performing a grow light motion, which is the reflection target of the BPM information, since the motion of the viewer avatars is stopped. Therefore, the viewer-avatar-viewpoint visuals including the viewer avatar that has stopped the motion are generated and displayed as the viewer-viewpoint visuals.

Meanwhile, if it is not during the transmission period of BPM information, the grow light motion information and the default swing speed information are streamed (transmitted) to the performer device 200 and each viewer device 300. The grow light motion information and default swing speed information thus streamed are updated and stored in the performer device 200 and each viewer device 300.

The default swing speed information is information based on the default swing speed data in the participant user table and includes data that allows identifying the default speed for each viewer avatar performing the grow light motion. Therefore, in each viewer device 300 that has received the default swing speed information, the speed (Speed 1 to Speed 5) at which each viewer avatar swings the grow light K in the grow light motion can be identified for all viewer avatars performing the grow light motion.

The default swing speed may be changed by a viewer user during, for example, each MC talk period. Such changes are updated on the viewer devices of other viewer users by being successively streamed the default swing speed information.

Next, in the streaming server computer 100, as in Embodiment 1, virtual space update data generation processing and virtual space update data streaming processing are executed, thereby the virtual space update data is streamed (transmitted) to the performer device 200 and each viewer device 300.

In response to receiving the virtual space update data thus streamed (transmitted), virtual space update processing is executed in each viewer device 300, and the update of the received virtual space update data are reflected in the virtual space data stored in each viewer device 300, and then viewer-viewpoint visuals generation processing 2 shown in (B) in FIG. 39 is executed.

FIG. 39(B) shows a flowchart illustrating the process of viewer-viewpoint visuals generation processing 2 executed in the viewer device 300 according to Embodiment 3. In this viewer-viewpoint visuals generation processing 2, first, processing of generating a normal viewer-viewpoint visuals based on the updated virtual space data is executed (step S400).

Next, based on the grow light motion information and default swing speed information received from the streaming server computer 100 and updated and stored, all viewer avatars performing grow light motions and their default swing speeds are identified (step S401).

Then, a motion mode based on the default swing speed identified in step S401 is reflected in the grow light motion of each viewer avatar performing the grow light motion (step S402).

With such reflection in step S402, viewer-avatar-viewpoint visuals are generated that includes visuals of a viewer avatar that is performing an asynchronous grow light motion in which the grow light K is swung at a swing speed uniquely selected by each viewer user and identified by the default swing speed information (step S403).

The viewer-avatar-viewpoint visuals generated by the viewer-viewpoint visuals generation processing 2, in which the grow light motions of the viewer avatars are asynchronous, are output (displayed) on each viewer device 300 by the viewer-viewpoint visuals output processing.

As described above, in the virtual space content streaming system according to Embodiment 3, a viewer avatar is capable of performing a grow light motion, which is a content-related motion, and when a plurality of viewer avatars perform grow light motions, the grow light motions of the respective viewer avatars are synchronized. This is done by the streaming server computer 100, which serves as a content-related motion adjustment means for synchronizing the timing of the grow light motions of the respective viewer avatars, executing processing for streaming grow light motion information, BPM information, and delayed motion information, and the viewer device 300 receiving, updating and storing the grow light motion information, BPM information, and delayed motion information, and executing the viewer-viewpoint visuals generation processing 1 based on the stored information. Thus, it is possible to make each viewer user participating in the virtual space more interesting.

In the virtual space content streaming system according to Embodiment 3, it is possible to adjust the timing of motions of a part of a plurality of viewer avatars performing grow light motions from synchronized synchronous timing to a motion mode of “delay A” or “delay B”, which are asynchronous timings that are different within a range of 0.2 second, thereby improving the realism of the grow light motion in the virtual live space and making the viewer users more interesting.

In the virtual space content streaming system according to Embodiment 3, as in Embodiment 1, viewer device 300 can generate and display viewer-avatar-viewpoint visuals including visuals of viewer avatars performing synchronous grow light motions, thereby allowing more viewer users to participate in the virtual live, and even in such a case when more viewer users participate, it is possible to make each viewer user participating in the virtual live space more interesting.

In the virtual space content streaming system according to Embodiment 3, the virtual space content includes performance content, such as singing and dancing of a music, which serves as virtual space content, performed by the performer avatar that can virtually participate in the virtual live space. The BPM information, which is information for synchronizing the grow light motion, is information corresponding to the tempo of the music, which is performance content. Therefore, the grow light motions can be synchronous to the music performed by the performer avatar, thereby making the virtual space content more interesting.

In the virtual space content streaming system according to Embodiment 3, the information from the streaming server computer 100 includes, BPM information, which serves as motion synchronization information, corresponding to the tempo of the music, and swing start information, which serves as start information that allows identifying the start time of the grow light motion, and therefore the grow light motion can be made to match the tempo of the music.

In the virtual space content streaming system according to Embodiment 3, as shown in FIG. 35, when a music of the first performance, which creates first performance content, is progressing, first-performance-adaptive BPM information corresponding to the tempo (BPM) of the music of the first performance is streamed from the streaming server computer 100, and when a music of the second performance, which creates second performance content, is progressing, second-performance-adaptive BPM information corresponding to the tempo (BPM) of the music of the second performance is streamed from the streaming server computer 100. Therefore, it is possible to perform grow light motions with different swing speeds corresponding to differences in the tempo of the music, which is the performance content.

In the virtual space content streaming system according to Embodiment 3, BPM information and swing start information are streamed in advance from the streaming server computer 100 a predetermined period before the start of a music during each performance period, and therefore it is possible to prevent the grow light motion from becoming out of sync at the start of the music.

In the virtual space content streaming system according to Embodiment 3, the viewer device 300 does not reflect the BPM information transmitted before the music starts in the grow light motions of the viewer avatar, and therefore it is possible to prevent a decrease in interest in the virtual space content due to unnatural grow light motions before the music starts.

In the virtual space content streaming system according to Embodiment 3, of the viewer avatars performing the grow light motion, 20% of the viewer avatars can be determined to be in the “delay A” group in which the start timing of the grow light motion is first asynchronous timing, which is delayed by 0.1 second from the BPM-referenced timing, and 10% of the viewer avatars can be determined to be in the “delay B” group in which the start timing of the grow light motion is second asynchronous timing, which is delayed by 0.2 second from the BPM-referenced timing. Accordingly, by having a plurality of delay modes, the realism of the grow light motion can be further improved.

The virtual space content streaming system according to Embodiment 3 includes performance content in which a music accompanied by singing and dancing, which is main content (first content) of the virtual live in which the virtual space content is created, is performed, and MC (talk) content, which is non-performance content different from the performance content. The viewer avatar can perform a grow light motion corresponding to a music performed in performance content during each performance period when the performance content is streamed. Meanwhile, the viewer avatar can perform a moving motion that does not correspond to the talk in the MC talk period during the MC talk period when MC (talk) is streamed. Accordingly, the motion of the viewer avatar is adjusted to the grow light motion synchronized with the music when the performance content is streamed, while a moving motion that does not correspond to the talk is allowed when the talk content is streamed in each MC talk period. Thereby, it is possible to make each viewer user participating in the virtual live space more interesting.

In the virtual space content streaming system according to Embodiment 3, the main content (first content) is performance content performed by the performer avatar 1 who can virtually participate in the virtual live space, and includes singing and dancing of a music performed by the performer avatar 1. Therefore, the grow light motion of the viewer avatar is adjusted to a motion corresponding to the music and dancing, which are performance content, thereby further enhancing the interest of the virtual space content.

In the virtual space content streaming system according to Embodiment 3, the content streamed during each MC talk period when MC (talk) is streamed does not include performance content in which a music is performed by the performer avatar 1. Accordingly, it is possible to appropriately prevent a moving motion that does not correspond to the performance content from being executed during the performance period when the performance content is being streamed.

In the virtual space content streaming system according to Embodiment 3, the performance content includes a music with a music ID “GK-XXXX” (first period content) which is streamed during a first performance period, which is a first period, and a music with a music ID “GK-YYYY” (second period content) which is streamed during a second performance period, which is a second period different from the first period. As for the BPM information that serves as the motion information for synchronizing the grow light motion of the viewer avatar, first-performance-adaptive BPM information is transmitted during the first period, and second-performance-adaptive BPM information, which allows identifying a tempo different from that of the first-performance-adaptive BPM information, is transmitted during the second period. Therefore, the grow light motion can be adjusted to correspond to the difference in tempo of the music, which is performance content, streamed during different periods.

The virtual space content in the virtual space content streaming system according to Embodiment 3 includes performance content (first content) which becomes main content when the performer avatar 1 virtually participating in the virtual live space performs a music; and non-performance content (second content) which does not become the main content since the performer avatar 1 does not perform a music but an MC (talk) takes place. The system has a motion restriction function which restricts a move, which is a predetermined motion, among motions of the viewer avatar, during each performance period when the performance content is streamed, but does not restrict a move during the MC talk periods when non-performance content (MC) is streamed. Accordingly, a move of the viewer avatar is restricted during the period when the performance content is streamed, and therefore it is possible to prevent a decrease in interest in the performance content due to such move. Meanwhile, during each MC talk period when MC (talk), which is non-performance content, is being streamed, a move is not restricted, and therefore excessive restrictions on the motions of viewer avatars can be prevented.

In the virtual space content streaming system according to Embodiment 3, it is possible to perform an operation of selecting a “grow light” item, which is an operation corresponding to a grow light motion, which is a specific motion of the viewer avatar, as shown in FIGS. 40 and 41, during each performance period when performance content is being streamed and during each MC talk period when performance content is not being streamed also. When such an operation is performed, synchronous grow light motions are allowed without restriction (prohibition) during each performance period, and asynchronous grow light motions are allowed without restriction (prohibition) during each MC talk period. Accordingly, a viewer user can have the viewer avatar perform a grow light motion by performing an operation, which is a specific motion, of selecting a menu item of “grow light” item during both each performance period, which is a period when performance content is being streamed, and each MC talk period, which is a period when non-performance content is being streamed.

In the virtual space content streaming system according to Embodiment 3, all motions of the viewer avatar, including a move, are restricted (prohibited) similarly to the performance period also during a predetermined period before the start of each performance period during which performance content is streamed, that is, a predetermined period from when the swing start information is transmitted to the start of each performance period, by treating such period as a performance period. Accordingly, such a motion, such as a move, of the viewer avatar is restricted (prohibited) even during the predetermined period before the start of the performance period, and therefore such a motion, such as a move, is performed up until the start of the performance period, thereby more accurately preventing a decrease in interest in the performance content.

In Embodiment 3 described above, an example is given of a form in which all motions of the viewer avatar other than a move are restricted (prohibited) during a predetermined period before the start of the performance period, but such a motion to be restricted (prohibited) may be only a move.

In the virtual space content streaming system according to Embodiment 3, the grow light motion corresponding to tempo of a music, which creates performance content, is allowed during each performance period when performance content is streamed, thereby increasing the interest of viewer users participating in the virtual live space.

### Variant Example of Embodiment 3

In Embodiment 3 described above, as in Embodiments 1 and 2, an example is given of a form in which a viewer avatar can move freely within the third or fourth region virtually participating. However, doing so may give rise to problems such as errors in the virtual space data due to, for example, different viewer avatars participating in the fourth region colliding virtually with each other or overlapping in the same virtual position.

In order to solve such problems, Variant example 3-1 shown in FIGS. 42-44 may be adopted, for example. In particular, the third region or the fourth region is divided into smaller regions as shown in FIG. 42, and an operation of the viewer user of which region the viewer user virtually participates in the virtual live is accepted, as shown in FIG. 42, at the time of pre-start participation acceptance of the virtual live (when virtual participation is reserved) or virtual participation of the virtual live. When a viewer user virtually participates by using a viewer avatar, participation is allowed only in a region selected in advance, and moving is restricted (prohibited) to only within the selected region. This prevents viewer avatars from colliding with each other virtually or overlapping in the same virtual position, which could cause problems such as errors in the virtual space data. In addition, it is possible to prevent the move of the viewer avatar from being overly restricted.

In particular, as for the moving restriction (prohibition), for example, in the case of a viewer user who has selected a region “H5” in FIG. 43 as the virtual participation position, when the viewer user performs an operation to move to a region surrounding “H5”, such as “G4-G6”, “H4”, “H6”, or “I4-I6”, as shown in FIG. 44, such a move is determined as a move to a move prohibited region in the viewer device 300. Thereby, such a move is restricted (prohibited) by displaying on the viewer device 300 a message indicating “Cannot move to the specified position because it is beyond the range of movement.”, for example, as shown in (B) in FIG. 44. Meanwhile, a move within the “H5” region is allowed without such warning being displayed. Thereby, the viewer user can move the viewer avatar within the “H5” region virtually participated.

The range where moving outside is prohibited is not limited to the range of virtual participation described above. For example, in a situation where a group of multiple people is virtually participating in a virtual live and the positions of the virtual participants are adjacent to each other, a range in which another viewer avatar participating in this group is virtually participating may be deemed to be a movable range based on information indicating that they are in a group.

In addition, although the above-described Variant example 3-1 has been described as a variant example of Embodiment 3, Variant example 3-1 can be applied to not only Embodiment 3 but also to Embodiments 1 and 2.

In Embodiment 3 described above, an example is given of a form in which motions of the viewer avatar are prohibited during a predetermined period from the transmission of the swing start information to the start of the performance, the period serving as a viewer avatar motion stop period T, but the present invention is not limited to this. For example, as shown in Variant example 3-2 shown in FIG. 45, there may be an adjustment motion period during a predetermined period from the transmission of the swing start information to the start of the performance, during which adjustment motion period, an adjustment motion is performed to transition the motion state of a viewer avatar performing an asynchronous grow light motion from the motion state at the time of transmission of the swing start information to the motion state at the time of the start of a synchronous grow light motion.

In addition, the adjustment motions can be generated by comparing a posture of the viewer avatar at the time of transmission of the swing start information with a posture at the start of the grow light motion, and generating the motion that compensate for the differences in posture using, for example, a known motion morphing program. In the above-described Variant example 3-2, the performance start timing at which a synchronous grow light motion is started is used as an example. However, the adjustment motion period may be implemented at the performance end timing at which the synchronous grow light motion ends. That is, an adjustment motion to compensate for differences in the posture between the posture of the viewer avatar when a synchronous grow light motion ends and the posture of the viewer avatar when an asynchronous grow light motion starts may be performed by having an adjustment motion period.

That is, as shown in Variant example 3-2, when starting or ending a synchronous grow light motion, an adjustment motion is generated to adjust the difference between the posture of the viewer avatar before the motion begins and the posture at the start of the synchronous grow light motion, and the difference between the posture at the end of the synchronous grow light motion and the posture of the viewer avatar after the motion ends. Thereby, it is possible to prevent the motion of the viewer avatar from becoming discontinuous and unnatural.

In Embodiment 3 described above, as shown in FIG. 31, the MC talk periods are not included in the performance period, but the present invention is not limited to this. As shown in Variant example 3-3 in FIG. 46, such an MC (talk) may also be included in the performance depending on the performer user, and in this case, even during the MC talk periods, motions, such as a move, may be prohibited as being in the performance period. In such a case when MC (talk) is included in a performance of the performer, MC (talk) periods are also included in the performance period. When MC-intended BPM information corresponding to the MC (talk) is transmitted as BPM information as in the case of a music, the grow light motion is adjusted to a motion having tempo corresponding to the MC (talk).

That is, since first content included in the virtual space content includes chat (talk) content performed by the performer avatar 1, the grow light motion of the viewer avatar can be adjusted to a motion corresponding to the chat (talk).

If MC (talk) is included in the performance of the performer as in Variant example 3-3 described above, motions, such as a move, of the viewer avatar are always prohibited. Therefore, for example, as shown in FIG. 46, during a waiting period from when the viewer virtually participates before the start of the live until the start of the virtual live, during a specific MC talk period among MC talk periods, or during a rest period for the performer to rest during the virtual live, it may be preferable to allow a motion, such as a move, during a period in which archived video content of past virtual lives, etc. is displayed on virtual displays 40, 41, and 42, deeming such a period as a period not included in a performance period. In this case, content of the performer of MC (talk) along with singing and dancing is included in the performance content, and content displayed on the virtual displays 40, 41, and 42, such as archived video content, is non-performance content.

In Embodiment 3 described above, a move is given as an example of a motion that is restricted (prohibited) for a viewer avatar during each performance period, but the present invention is not limited to this. In addition to the move, motions such as jumping (leap) and high-fiving other viewer avatars, which are motions that affect other viewer avatars, may also be restricted (prohibited) during each performance period, as shown in Variant example 3-4 of FIG. 47.

That is, motions of the viewer avatar that are restricted (prohibited) during each performance period, which is a period during which performance content is streamed, include motions and jumps that affect other viewer avatars virtually participating in the virtual live space, and therefore it is possible to prevent the performance content from being less interesting due to motions and jumps that affect other viewer avatars. The performer avatar may also be affected by such motions in addition to viewer avatars.

The motions of the viewer avatar that are restricted (prohibited) during the performances are not limited to those shown in FIG. 47, but may include any motion that is considered to give the viewer avatar an uncomfortable feeling during the performance periods.

Similarly, in Embodiment 3 described above, an example is given of a form in which the content-related motion that the viewer avatar can perform during each performance period is only one motion, which is the grow light motion of swinging the grow light K left and right, but the present invention is not limited to this. For example, the motions may include a plurality of motions, for example, as shown in FIG. 47, in addition to the grow light motion of swinging the grow light K left and right, a grow light motion of swinging the grow light K front and rear, and a waving motion in which the viewer avatar swings both hands raised above left and right, and therefore each of the three content-related motions can be performed in a performance corresponding to each content-related motion.

The content-related motions that can be performed during the performances are not limited to the three motions shown in FIG. 47, and any motion that is allowed in advance as a motion that does not cause discomfort to any of the viewer avatars during each performance period can be added to the content-related motion.

With regard to the grow light motion of swinging the grow light K front and rear and the waving motion, similar to the grow light motion of swinging the grow light K left and right, a plurality of viewer avatars performing such motions can perform synchronous motions at a tempo corresponding to the music being performed based on the BPM information and the swing start information.

That is, the grow light motion includes a plurality of grow light motions with different motion modes, such as a motion of swinging left and right and a motion of swinging front and rear, and the virtual space content streaming system of Variant example 3-4 is capable of synchronizing grow light motions of a plurality of viewer avatars of any grow light motion. Accordingly, the grow light motion includes those of a plurality of motion modes, and it is possible to synchronize such grow light motions of a plurality of motion modes. Therefore, it is possible to make each viewer user participating in the virtual live space more interesting.

In a case where a plurality of content-related motions can be performed, during periods before the start of a live other than the performance period or during MC talk periods, it may be possible to allow all types of content-related motions to be performed, as shown in FIG. 47, and it may also be possible to allow a plurality of content-related motions, rather than just one type, to be performed in one performance, such as allowing a grow light motion of swinging a grow light K left and right during a performance period corresponding to a waving motion.

In Embodiment 3 described above, an example is given of a form in which the delayed motion entity determination processing is executed in the streaming server computer 100, thereby causing the streaming server computer 100 to determine a viewer avatar that is performing a delayed motion in a synchronous grow light motion. However, the present invention is not limited to this. For example, as shown in Variant example 3-5 of FIG. 48, the viewer avatar that is performing a delayed motion is determined in the viewer device 300 by executing the delayed motion entity determination processing in the viewer device 300.

That is, in Variant example 3-5, the viewer device 300 is capable of generating viewer-avatar-viewpoint visuals in which the timing of grow light motions of the respective viewer avatars is synchronous, the streaming server computer 100 is capable of streaming grow light motion information to each viewer device 300 as related motion execution information which allows identifying the viewer avatar performing the grow light motion, and the viewer device 300 is capable of adjusting the grow light motion to “delay A” or “delay B”, which are asynchronous timings, for a part of viewer avatars performing the grow light motion, identified by the grow light motion information. Accordingly, the streaming server computer 100 does not need to stream delayed motion information, thereby reducing the processing load on the streaming server computer 100 for streaming such delayed motion information.

In Variant example 3-5, it may be preferable if the execution timing and processing details of the delayed motion entity determination processing executed by the viewer device 300 are the same as those when executed by the streaming server computer 100 shown in FIG. 37. In this case, it may be preferable if the determination table is received as pre-start data from the streaming server computer 100 and stored, and the viewer avatar performing the grow light motion at the time the processing is executed is identified by the grow light motion information streamed from the streaming server computer 100. It may be preferable if the determination result is reflected in a delayed motion entity table for storing and updating the determination result, not in a participant user table, by associating the determination result with the viewer user IDs of all participants included in the grow light motion information. It may be preferable if the viewer-viewpoint visuals generation processing 1 is executed based on the determination result identified by the delayed motion entity table.

In Variant example 3-5, the delayed motion entity determination processing is executed individually in each viewer device 300, and therefore the viewer-user-viewpoint visuals including a synchronous grow light motion generated in each viewer device 300 becomes visuals different for each viewer device 300, such as a case where a viewer avatar is determined in the viewer device 300 of viewer user A as a delayed motion entity of “delay A”, and a viewer avatar is determined in the viewer device 300 of viewer user B as the delayed motion entity of “delay B”.

In Embodiment 3, an example is given of a form in which the timing for starting the grow light motion based on the swing start information is the start timing (the start timing of the performance period) of a music, which creates performance content, but the present invention is not limited to this. It may be preferable if the timing for starting the grow light motion based on the swing start information is a timing different from the start timing of the performance period or the start timing of the music, for example, a timing when a certain period of time has passed since the start of the performance period, or a timing when singing is started after elapsing time for a part of music, such as an intro part, from the start of the music.

The present invention has been described above based on embodiments and variant examples, but the specific configuration is not limited to the above-described embodiments and variant examples. The present invention extends to modifications and additions that do not deviate from the gist of the present invention.

For example, as shown in Variant example 3-1, if the virtual participation position of the viewer avatar is caused to be selected in advance by each viewer user, it may be preferable if viewpoint visuals in a virtual flying motion, which is a special motion, are, depending on a position selected by each viewer user, viewpoint visuals corresponding to the position (region) selected by the viewer user. For example, for a viewer user who has selected regions A1-C6 on the right side as viewed from the virtual stage G in the fourth region, viewpoint visuals of viewpoint from the front-right position of the virtually flying performer avatar 1 are generated and displayed as viewpoint visuals during the flying performance period; for a viewer user who has selected regions D4-H6 on the center as viewed from the virtual stage G in the fourth region, viewpoint visuals of viewpoint from the front-center position of the virtually flying performer avatar 1 are generated and displayed as viewpoint visuals during the flying performance period; and for a viewer user who has selected regions I1-K6 on the left side as viewed from the virtual stage G in the fourth region, viewpoint visuals of viewpoint from the front-left position of the virtually flying performer avatar 1 are generated and displayed as viewpoint visuals during the flying performance period.

In the embodiments and variant examples described above, an example is given of a form in which viewer-avatar-viewpoint visuals are generated and displayed on the viewer device 300 side, but the present invention is not limited to this. For example, in the case of a live event with a small number of virtual participants, viewpoint visuals of viewpoint from viewer avatars may also be generated on the streaming server computer 100 side to be streamed. It may be preferable if the viewer user is able to select whether viewer-avatar-viewpoint visuals are generated on the viewer device 300 side or on the streaming server computer 100 side depending on the processing capability of the device owned and the available data communication environment; or the streaming server computer 100 identifies the processing capability of the viewer device 300 with which it is connected for communication, and based on the identified processing capability, determine whether the visuals are generated on the viewer device 300 side or on the streaming server computer 100 side.

In the embodiments and variant examples described above, an example is given of a form in which the streaming server computer 100 is installed in a studio operated by an event operating entity that hosts the virtual live, but the present invention is not limited to this. For such a streaming server computer 100, a server computer owned in a data center or the like by a company that rents out the server computer may be used; or as described above, a server computer provided by a cloud service may be used. The installation form of the server computer may be of any form that provides the functions of the streaming server computer 100.

In the embodiments and variant examples described above, an example is given of a form in which a performer user performs performance motions such as singing and dancing alone, but the present invention is not limited to this. The performer user may be constituted by a group of a plurality of people, and when a virtual live is performed by such a group of a plurality of people, a plurality of people may share one performer device 200, or a performer device 200 may be provided for each member of the group. When the performer user is constituted by a group consisting of a plurality of members, it may be preferable if the viewer user can select a member whose viewpoint is to be followed by, for example, executing viewpoint-following target designation processing in at least one of the streaming server computer 100 and the viewer device 300.

In the embodiments and variant examples described above, an example is given of a form in which a performer user performs a performance motion, such as singing and dancing, alone, but the present invention is not limited to this. A singer who sings and a motion entity who performs the dancing motions may be separate persons, in which case a performer device of the singer and a performer device of the motion entity may be separate devices, so that the singer sings in a location other than the studio where the motion entity performs the performance motions.

In the embodiments and the variant examples described above, the Internet is given as an example of a computer communication network connecting the streaming server computer 100, the administrator device 150, the performer device 200, and the viewer device 300, but the present invention is not limited to this. The communication network may be constituted by a local area network capable of communicating data only within a specific area, or may include a local area network or local data communication as part of the communication network.

In the embodiments and the variant examples described above, the viewer device 300 is a smartphone P or a computer (PC), but the present invention is not limited to this. The computer may be a portable laptop computer, a tablet device, an electronic book reader, a wearable computer, a game console, or various other information processing devices capable of outputting at least 2D visuals and audio.

In the embodiments and the variant examples described above, an example is given of a form in which a performer user performs a performance including singing in a studio, but the present invention is not limited to this. For example, it may be preferable if the performer user uses a performer device 200 installed in a location, such as a home, to appear in a virtual live from such a location.

In the embodiments and the variant examples described above, an example is given of a form in which a virtual live is given as an example of virtual space content, but the present invention is not limited to this. Such virtual space content may be any content that is beneficial to viewer users and that relates to a virtual space in which a performer avatar 1 and a viewer avatar virtually participate, such as a fan meeting where the performer user gathers with the fans, or a talk session.

In the embodiments and the variant examples described above, an example is given of a form in which viewpoint switching among four virtual cameras C1-C4, which are fixedly arranged (fixedly set) virtual cameras, and an aerial-moving virtual camera can be done in advance by settings and operations on the administrator device 150, but the present invention is not limited to this. For example, it may be preferable if the viewpoint switching is performed in real time by an event manager M on the administrator device 150 using, for example, a viewpoint switching controller, that constitutes the operation input device 161.

In the embodiments and the variant examples described above, an example is given of a form in which virtual cameras C1-C4 fixedly arranged (set) within a virtual space as virtual cameras are used, but the present invention is not limited to this. For example, in addition to or instead of virtual cameras C1-C4, it may be preferable if a movable virtual moving camera is placed within a virtual live venue, and the position and imaging direction, among others, of the virtual moving camera within the virtual space are controlled by an event manager M, a cameraman, etc., through operations on an administrator device 150 to produce viewpoint visuals of the virtual moving camera.

In the embodiments and the variant examples described above, an example is given of a form in which viewpoint visuals of the virtual camera C2 are displayed on the screen S so that facial expressions of the performer user can be detected to reflect in facial expressions of the performer avatar, but the present invention is not limited to this. For example, it may be preferable if the performer user performs performance by wearing a high-performance head-mounted display that has a sensor function for detecting facial expressions of the performer user, thereby enhancing the sense of immersion of the performer user in the virtual live. If the facial expressions of the performer avatar do not need to be reflected in the facial expressions of the performer user in detail, the performer user may wear a normal head-mounted display during the performance.

In Embodiment 3 described above, an example is given of a form in which there are, as timing of the grow light motion, timing of delay A, which is 0.1 second behind the BPM-referenced timing, and delay B, which is 0.2 second behind the BPM-referenced timing, but the present invention is not limited to this. It may be preferable if all viewer avatars performing the grow light motion perform the grow light motion in synchronization using only the same BPM-referenced timing, without having timing of delay A or delay B. That is, in the context of the present invention, synchronization does not only mean synchronization at a reference timing, but also includes motion modes in which timings of grow light motions of a part of viewer avatars differ within a predetermined range of 0.2 second that can be recognized as approximately the same timing, and therefore a synchronization timing includes not only the synchronization timing of BPM-referenced timing, but also timings of delay A and delay B, which are pseudo-synchronous timings.

In Embodiment 3 described above, as shown in FIGS. 31 and 35, an example is given of a form in which a period from when the swing start information is transmitted to the start timing of each performance period is the viewer avatar motion stop period T, but the present invention is not limited to this. It may be preferable if such a viewer avatar motion stop period T is not provided, and the viewer avatar is allowed to perform a grow light motion throughout the entire period of each MC talk period.

In the embodiments and the variant examples described above, the performer user sings or performs a singing motion (performance motion) in real time during the streaming of the virtual live, allowing the performer user to proceed with the live while checking the reactions, among others, of the viewer users who are virtually participating in the virtual live, but the present invention is not limited to this. It may be preferable if the virtual live is held by not performing the singing or the singing motion (performance motion) of the performer user in real time, but performed it in advance such that the singing audio and singing motions (performance motions) are recorded in the streaming server computer 100 as performer avatar information, and the recorded singing audio and singing motions (performance motions) are played back in accordance with the live progress.

Instead of the singing and the singing motion (performance) of a performer user, it may be preferable if the virtual live is held by recording on a streaming server computer the singing and the singing motion (performance motion) of a virtual performer created using computer graphics, etc., as performer avatar information, and playing back the recorded singing audio and singing motion (performance motion) in accordance with the live progress.

Accordingly, in cases where singing and singing motion (performance motion) are performed in advance to be recorded on the streaming server computer 100 to be played to stream a virtual live, the configuration of the virtual space content streaming system at the time of streaming is constituted by the streaming server computer 100, the administrator device 150, and the viewer device 300, and does not include a performer device 200, which is a performer user device that can be used by a performer user who performs operations to cause the performer avatar 1 to perform motions in the virtual space.

### REFERENCE SIGNS LIST

1: performer avatar
100: streaming server computer
150: administrator device
200: performer device
300: viewer device

1-14. (canceled)

15. A virtual space content streaming system for streaming virtual space content created in a virtual space, comprising:
a viewer user device configured to display visuals of the virtual space content and available to a viewer user who is allowed to operate a viewer avatar in the virtual space in which the virtual space content is created; and
a server computer connected to the viewer user device via a communication network and configured to execute at least processing related to the virtual space and processing related to the streaming of the virtual space content, wherein
the virtual space content streaming program is configured to allow connections from a plurality of the viewer user devices operated by a plurality of viewer users, respectively, and the viewer user device is assigned to each viewer user, and
when displaying viewer-avatar-viewpoint visuals which are viewpoint visuals of the virtual space corresponding to the viewer avatar, each viewer user device generates the viewer-avatar-viewpoint visuals based on virtual space data of the virtual space, transmitted from the server computer.

16. The virtual space content streaming system according to claim 15, wherein
in the virtual space content, a performer user is allowed to participate as a performer avatar in the virtual space.

17. The virtual space content streaming system according to claim 16, wherein
in the virtual space content, a performer avatar gives a performance in the virtual space.

18. The virtual space content streaming system according to claim 16, wherein
the virtual space data includes performer-avatar-intended motion data for generating a motion of the performer avatar.

19. The virtual space content streaming system according to claim 18, wherein
the viewer user device is configured to, when generating a motion of the performer avatar based on the performer-avatar-intended motion data, generate the motion of the performer avatar in a plurality of generation modes having different processing loads for the generation.

20. The virtual space content streaming system according to claim 16, wherein
the server computer is configured to generate common viewpoint visuals commonly displayed on each of the viewer user devices, rather than viewpoint visuals corresponding to each viewer avatar, and stream the common viewpoint visuals to the viewer user devices.

21. The virtual space content streaming system according to claim 20, wherein
the viewer user device generates and displays the common viewpoint visuals during a period when the viewer user device is allowed to select and display either the viewer avatar viewpoint visuals or the common viewpoint visuals.

22. The virtual space content streaming system according to claim 20, wherein
the viewer user device generates and displays the common viewpoint visuals during a period when the processing load on the server computer is high.

23. The virtual space content streaming system according to claim 16, wherein
the server computer is configured to generate common viewpoint visuals commonly displayed on each of the viewer user devices, rather than viewpoint visuals corresponding to each viewer avatar, and stream the common viewpoint visuals to the viewer user devices.

24. The virtual space content streaming system according to claim 23, wherein
the viewer user device generates and displays the common viewpoint visuals during a period when the viewer user device is allowed to select and display either the viewer avatar viewpoint visuals or the common viewpoint visuals.

25. The virtual space content streaming system according to claim 23, wherein
the viewer user device generates and displays the common viewpoint visuals during a period when the processing load on the server computer is high.

26. The virtual space content streaming system according to claim 15, wherein
the server computer transmits in advance pre-start data including basic data of the virtual space and basic data of avatars participating in the virtual space to each viewer user device before a start of the virtual space content.

27. The virtual space content streaming system according to claim 26, wherein
the server computer transmits to the viewer user device whose receipt completion of the pre-start data has not been confirmed common viewpoint visuals to be commonly displayed on each viewer user device without transmitting the virtual space data.

28. The virtual space content streaming system according to claim 16, wherein
the server computer transmits in advance pre-start data including basic data of the virtual space and basic data of avatars participating in the virtual space to each viewer user device before a start of the virtual space content.

29. The virtual space content streaming system according to claim 28, wherein
the server computer transmits to the viewer user device whose receipt completion of the pre-start data has not been confirmed common viewpoint visuals to be commonly displayed on each viewer user device without transmitting the virtual space data.

30. The virtual space content streaming system according to claim 15, wherein
the server computer includes a first viewer user device and a second viewer user device as the viewer user devices, and
the virtual space content streaming system is configured to transmit virtual space data different from that of the first viewer user device to the second viewer user device.

31. The virtual space content streaming system according to claim 30, wherein
the second viewer user device is configured to generate visuals of a second viewer avatar performing a motion different from a motion of a first viewer avatar of a first viewer user using the first viewer user device, based on virtual space data different from the virtual space data transmitted to the first viewer user device.

32. The virtual space content streaming system according to claim 16, wherein
the server computer includes a first viewer user device and a second viewer user device as the viewer user devices, and
the virtual space content streaming system is configured to transmit virtual space data different from that of the first viewer user device to the second viewer user device.

33. A virtual space content streaming program for streaming virtual space content created in a virtual space via a network using at least a server computer, wherein
a viewer avatar that perform a motion in the virtual space by operating on a viewer user device configured to be used by a viewer user and is connected to the server computer via the network is configured to participate in the virtual space in which the virtual space content is created,
the virtual space content streaming system is configured to allow connections from a plurality of the viewer user devices operated by a plurality of viewer users, respectively, and the viewer user device is assigned to each viewer user, and
the virtual space content streaming program comprises instructions for performing a step of generating, when displaying viewer-avatar-viewpoint visuals, which are viewpoint visuals of the virtual space corresponding to the viewer avatar, in each of the viewer user devices, the viewer-avatar-viewpoint visuals based on virtual space data of the virtual space transmitted from the server computer.

34. A virtual space content streaming method for streaming virtual space content created in a virtual space via a network using at least a server computer, wherein
a viewer avatar that perform a motion in the virtual space by operating on a viewer user device configured to be used by a viewer user and is connected to the server computer via the network is configured to participate in the virtual space in which the virtual space content is created,
the virtual space content streaming method is configured to allow connections from a plurality of the viewer user devices operated by a plurality of viewer users, respectively, and the viewer user device is assigned to each viewer user, and
the virtual space content streaming method includes a step of generating, when displaying viewer-avatar-viewpoint visuals, which are viewpoint visuals of the virtual space corresponding to the viewer avatar, in each of the viewer user devices, the viewer-avatar-viewpoint visuals based on virtual space data of the virtual space transmitted from the server computer.
